(19) United States
(12) Patent Application Publication
(10) Pub. No.: US 2007/0236553 A1
(43) Pub. Date: Oct. 11, 2007

(54) IMAGE FORMING APPARATUS AND METHOD FOR CONTROLLING THE SAME

(75) Inventors: Yuuzou KAWANO, Fukuoka (JP); Kouhei SUYAMA, Fukuoka (JP); Kazuo NISHIMURA, Fukuoka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/697,976

(22) Filed: Apr. 9, 2007

(30) Foreign Application Priority Data
Apr. 10, 2006 (JP) 2006-108052
Apr. 10, 2006 (JP) 2006-108053
Apr. 12, 2006 (JP) 2006-109645
Apr. 18, 2006 (JP) 2006-114624
Apr. 19, 2006 (JP) 2006-115855
May 9, 2006 (JP) 2006-130298

(51) Int. Cl. B41J 2/385

(52) U.S. Cl. 347/133

(57) ABSTRACT

To provide an image forming apparatus capable of preventing a fluctuation in image density immediately after the light quantities are corrected, and a method for controlling the same, when light quantity measurement is carried out at time t1, the controller CPU calculates the light quantity correction value ND. Herein, it is assumed that the light quantity correction value ND calculated previously, which is the light quantity correction value before light quantity measurement at time t1, is NDold, and the light quantity correction value ND calculated based on the light quantity measurement value at time t1 is NDnew. When the light quantity correction NDnew is calculated, the controller CPU varies the light quantity correction value ND from the light quantity correction value NDold a plurality of times by a predetermined variation value α in the direction approaching the light quantity correction value NDnew for each of the printing sheets.

### BACKGROUND OF THE INVENTION

1. Field of the Invention

The present invention relates to an image forming apparatus having a plurality of light-emitting elements, which forms an image by exposing an image carrier, and a method for controlling the same.

2. Description of the Related Art

Generally, an exposure apparatus including a light-emitting element array, in which LEDs and organic electroluminescence materials are used, as a component selectively lights respective light-emitting elements in the immediate vicinity of a photosensitive body being an image carrier of an image forming apparatus and irradiates exposure light onto the photosensitive body. Therefore, an image forming apparatus incorporating these components does not have a movable portion such as a rotary polygonal mirror as in an image forming apparatus employing a laser diode, wherein the image forming apparatus is excellent in reliability and silence. Since an optical system for guiding emission light from the laser diode to a photosensitive body and a large optical space becoming optical paths are not required, it is possible to downsize the image forming apparatus.

In particular, since, in an exposure apparatus incorporating organic electroluminescent elements as light-emitting elements, a drive circuit composed of switching elements consisting of thin-film transistors (hereinafter called TFT) and an organic electroluminescent element are integrally formed on a substrate such as glass, the structure and production process can be simplified, wherein it is possible to further downsize the same in comparison with an exposure apparatus incorporating LEDs as light-emitting elements, and production costs thereof can be reduced.

However, on the other hand, it has been known that the light-emitting brightness gradually decreases in line with drive in an organic electroluminescent element, that is, so-called light quantity deterioration occurs. For example, where it is assumed that the specification is 600 dpi (dot/inch) and 20 ppm (pages/minute) or so as performance of the image forming apparatus, light-emitting brightness of 10000 [cd/m²] or more is required, wherein the drive conditions of high voltage and large current become very severe, and influence due to light quantity deterioration is increased. Therefore, in order to maintain the exposure amount of the individual organic electroluminescent elements at the same level as initially, specified light quantity correction is required.

Also, it has been known that the light-emitting brightness of the organic electroluminescent element has temperature dependency. Therefore, light quantity correction is required to correct the exposure amount of the individual organic electroluminescent elements with regard to temperature compensation.

Further, since it is difficult to prevent unevenness in light emission brightness from occurring between individual organic electroluminescent elements, light quantity correction will be required to prevent unevenness in the exposure amount between the elements.

With respect to light quantity correction, in an image forming apparatus incorporating an exposure apparatus to which the conventional organic electroluminescent elements are applied, for example, such a structure disclosed in (Patent Document 1) has been known. The exposure apparatus according to (Patent Document 1) has such a structure that a light-receiving sensor is disposed on a glass substrate having organic electroluminescent elements formed thereon, and the exposure amounts of the respective organic electroluminescent elements are detected by the light-receiving sensor.

Further, according to (Patent Document 1), the light quantity correction operation can be carried out based on an instruction of a printer controller at any time of initialization operation immediately after the image forming apparatus is started, before starting to print, and between recording sheets.

Patent Document 1: Japanese Published Unexamined Patent Application No. 2004-082330

However, where the interval of timing for the above-described operation for correcting light quantities is imbalanced, and the temperature characteristics of the peripheries of the light-emitting elements greatly differ before and after the operation for correcting light quantities, there is a problem that the fluctuation in the image density becomes large before correction of the light quantity and immediately after that.

### SUMMARY OF THE INVENTION

The present invention was developed in view of the above-described situations, and it is therefore an object of the present invention to provide an image forming apparatus and a method for controlling the same, which is capable of controlling fluctuations in image density immediately after correcting the light quantity.

An image forming apparatus of the present invention having a plurality of light-emitting elements, which forms an image by exposing an image carrier, includes: a light quantity measurement portion for measuring the light quantity of light emitted by the light-emitting elements; and a control portion for controlling the image density by varying the exposure conditions a plurality of times based on the measurement results and the results measured before the measurement by means of the light quantity measurement portion.

With the construction, since the exposure conditions are determined based on the measurement results and the results of the prior measurement when controlling the image density by measuring the light quantity, it is possible to prevent the image density from fluctuating immediately after the light quantity is corrected.

### BRIEF DESCRIPTION OF THE DRAWINGS

FIG. 1 is a configuration view of an image forming apparatus according to Embodiment 1 of the present invention;

FIG. 2 is a schematic view showing the peripheries of a development station in an image forming apparatus according to Embodiment 1 of the present invention;

FIG. 3 is a schematic view of an exposure apparatus in an image forming apparatus according to Embodiment 1 of the present invention;

FIG. 4(a) is an upper plan view of a glass substrate pertaining to the exposure apparatus in an image forming apparatus according to Embodiment 1 of the present invention, and FIG. 4(b) is an enlarged view showing the major parts thereof;

FIG. 5 is a block diagram showing the configuration of a controller in an image forming apparatus according to Embodiment 1 of the present invention;

FIG. 6 is an explanatory view showing the contents of a light quantity correction data memory in an image forming apparatus according to Embodiment 1 of the present invention;

FIG. 7 is a block diagram showing the configuration of an engine control portion in an image forming apparatus according to Embodiment 1 of the present invention;

FIG. 8 is a circuit diagram of the exposure apparatus in an image forming apparatus according to Embodiment 1 of the present invention;

FIG. 9 is an explanatory view showing a current program period and lighting period of organic electroluminescent elements pertaining to the exposure apparatus in an image forming apparatus according to Embodiment 1 of the present invention;

FIG. 10 is an explanatory view showing organic electroluminescent elements and drive circuits of light quantity sensors corresponding thereto in Embodiment 1 of the present invention;

FIG. 11 is an explanatory view showing a connection between a sensor pixel circuit and a charge amplifier and an action between the light quantity sensors and the organic electroluminescent elements in Embodiment 1 of the present invention;

FIG. 12 is a timing chart showing operations of the sensor pixel circuit and the charge amplifier in Embodiment 1 of the present invention;

FIG. 13 is an explanatory view showing various examples of timing for which light quantity measurement is carried out for correction of light quantities in Embodiment 1 of the present invention;

FIG. 14 is a timing chart showing the outline of a method for adjusting light quantity correction values in an image forming apparatus according to Embodiment 1 of the present invention;

FIG. 15 is an explanatory view showing one example of the contents of a light quantity correction data memory in an image forming apparatus according to Embodiment 1 of the present invention;

FIG. 16 is a flowchart showing procedures of the method for adjusting light quantity correction values in an image forming apparatus according to Embodiment 1 of the present invention;

FIG. 17 is a timing chart showing an operation for measuring light quantities in an image forming apparatus according to Embodiment 2 of the present invention;

FIG. 18 is a timing chart showing an operation for measuring light quantities in an image forming apparatus according to a modified version 1 of Embodiment 2 of the present invention;

FIG. 19 is a timing chart showing an operation for measuring light quantities in an image forming apparatus according to a modified version 2 of Embodiment 2 of the present invention;

FIG. 20 is a timing chart showing an operation for measuring light quantities in an image forming apparatus according to a modified version 3 of Embodiment 2 of the present invention;

FIG. 21 is an explanatory view showing an operation when an engine is started in the procedure of lighting measurement according to a modified version 4 of Embodiment 2 of the present invention;

FIG. 22 is a timing chart showing an operation for measuring light quantities in an image forming apparatus according to a modified version 4 of Embodiment 2 of the present invention;

FIG. 23 is a timing chart showing the outline in a continuous printing operation of an image forming apparatus according to Embodiment 3 of the present invention;

FIG. 24 is an explanatory view showing a method for correcting light quantities in a continuous printing operation of an image forming apparatus according to Embodiment 3 of the present invention;

FIG. 25 is a timing chart showing an example of timing of light quantity measurement regarding all the elements in an image forming apparatus according to Embodiment 3 of the present invention;

FIG. 26 is an explanatory view showing the first example of the method for calculating light quantity correction values in a continuous printing operation of an image forming apparatus according to Embodiment 3 of the present invention;

FIG. 27 is an explanatory view showing the second example of the method for calculating light quantity correction values in a continuous printing operation of an image forming apparatus according to Embodiment 3 of the present invention;

FIG. 28 is a timing chart showing one example of an operation for measuring light quantities in an image forming apparatus according to Embodiment 4 of the present invention;

FIG. 29 is an explanatory view showing one example of a page on which a test pattern is printed by an image forming apparatus according to Embodiment 4 of the present invention;

FIG. 30 is an explanatory view showing a gradation correction pattern in an image forming apparatus according to Embodiment 4 of the present invention;

FIG. 31 is an explanatory view showing a resist correction pattern in an image forming apparatus according to Embodiment 4 of the present invention;

FIG. 32 is a graph describing the light quantities of light emitted by organic electroluminescent elements in an image forming apparatus according to Embodiment 5 of the present invention;

FIG. 33 is a timing chart showing one example of an operation for measuring light quantities in an image forming apparatus according to Embodiment 5 of the present invention;

FIG. 34 is a view showing the temperature characteristics of quantities of light emitted by the organic electroluminescent elements in an image forming apparatus according to Embodiment 6 of the present invention;

FIG. 35 is a view showing the characteristics of an exposure apparatus with regard to the main scanning direction in an image forming apparatus according to Embodiment 6 of the present invention;

FIG. 36 is an explanatory view showing the concept of the relationship in position between the exposure apparatus and its peripheries in an image forming apparatus according to Embodiment 6 of the present invention;

FIG. 37 is a schematic view showing a part of the exposure apparatus in an image forming apparatus according to Embodiment 6 of the present invention; and

FIG. 38 is an explanatory view showing a method for calculating light quantity correction values in an image forming apparatus according to Embodiment 6 of the present invention.

### DETAILED DESCRIPTION OF THE PREFERRED EMBODIMENTS

Hereinafter, a description is given of embodiments of the present invention with reference to the accompanying drawings.

### Embodiment 1

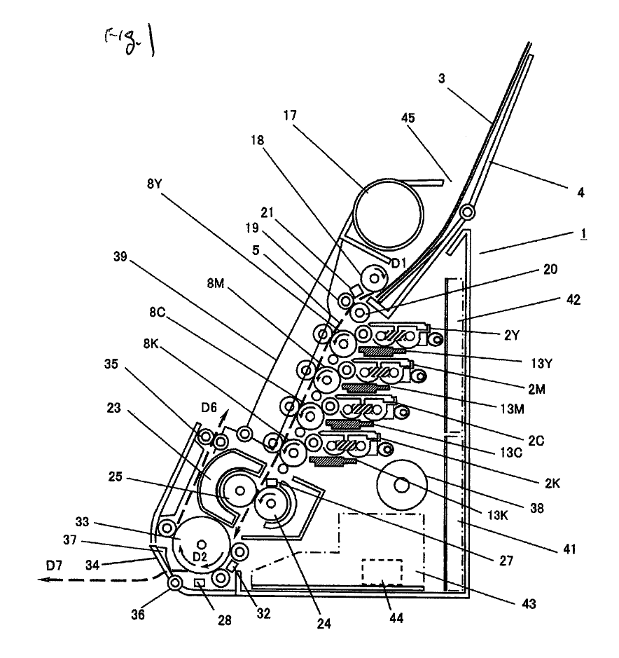

FIG. 1 is a schematic view of an image forming apparatus according to Embodiment 1 of the present invention. In FIG. 1, the image forming apparatus 1 has development stations covering four colors disposed like a staircase in the longitudinal direction therein, which are a yellow development station 2Y, a magenta development station 2M, cyan development station 2C, and black development station 2K, and further has a sheet feeding tray 4 disposed upward thereof, in which a recording sheet 3 being a recording medium is accommodated, wherein a recording sheet conveyance path 5 that becomes a conveyance line of the recording sheet 3 fed from the sheet feeding tray 4 are composed in the longitudinal direction from upward to downward at points corresponding to the respective development stations 2Y through 2K.

The development stations 2Y through 2K form toner images of yellow, magenta, cyan and black in the order from upstream side of the recording sheet conveyance path 5, wherein the yellow development station 2Y includes a photosensitive body 8Y, the magenta development station 2M includes a photosensitive body 8M, the cyan development station 2C includes a photosensitive body 8C, and the black development station 2K includes a photosensitive body 8K, and further the respective development stations 2Y through 2K include members for accomplishing a development process in a series of an electro-photographing system such as, for example, a development sleeve, an electrifier, etc., which will be described later.

In addition, exposure apparatuses 13Y, 13M, 13C and 13M to form electrostatic latent images by exposing the surfaces of the photosensitive bodies 8Y through 8M are disposed downward of the respective development stations 2Y through 2K.

Although the colors of development agents filled in the development stations 2Y through 2K are different from each other, the configurations thereof are the same regardless of the development colors. Therefore, excepting the cases where it is necessary to particularly clarify the colors, the following description is based on the development station 2, photosensitive body 8, and exposure apparatus 13 without clarifying the colors.

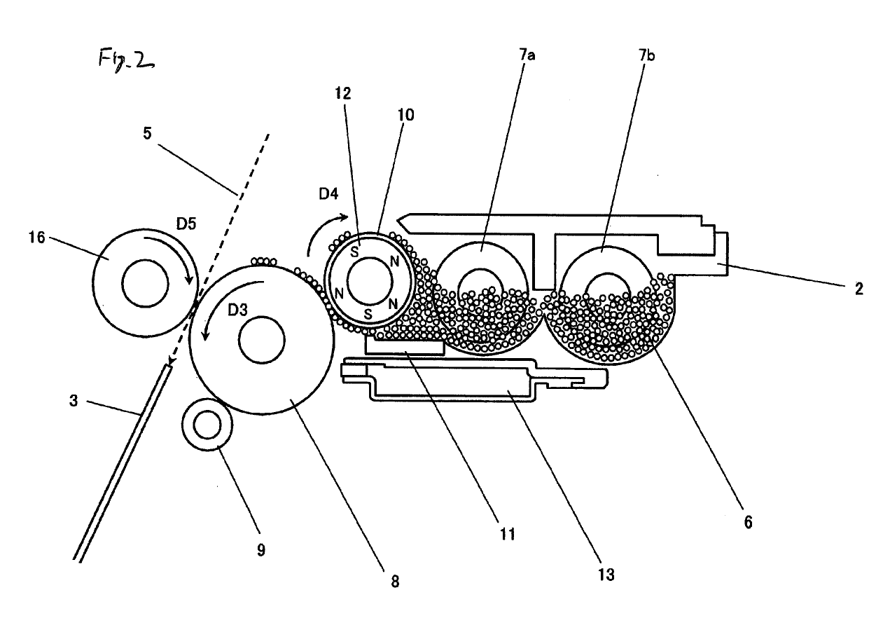

FIG. 2 is a schematic view showing the periphery of the development station 2 in the image forming apparatus 1 according to Embodiment 1 of the present invention. In FIG. 2, a development agent 6 which is a mixture of a carrier and toner is filled in the interior of the development station 2. Reference numerals 7a and 7b denote stirring paddles for stirring the development agent 6. Toner in the development agent 6 is electrified to a predetermined potential based on friction thereof with the carrier by rotations of the stirring paddles 7a and 7b, and at the same time, the toner and the carrier are circulated in the interior of the development station 2 and are sufficiently stirred and mixed. The photosensitive body 8 turns in the direction D3 by a drive source (not illustrated). Reference numeral 9 denotes an electrifier and electrifies the surface of the photosensitive body 8 to a predetermined potential. Reference numeral 10 denotes a development sleeve, 11 denotes a thinning blade. The development sleeve 10 is provided with a magnet roll 12 in which a plurality of magnetic poles are formed. The layer thickness of the development agent 6 supplied onto the surface of the development sleeve 10 is regulated by the thinning blade 11, and the development sleeve 10 is turned in the direction D4 by a drive source (not illustrated), wherein the development agent 6 is supplied onto the surface of the development sleeve 10 by the rotation of the sleeve 10 and action of the magnetic poles of the magnet roll 12, an electrostatic latent image formed on the photosensitive body 8 is developed by an exposure apparatus 13 described later, and the development agent 6 not transferred onto the photosensitive body 8 is collected into the interior of the development station 2.

In embodiment 1, as will be described later, it is constructed that the development station 2 is able to move in the horizontal direction at a predetermined timing on which the light emitting quantity of a light-emitting element (organic electroluminescent element) is corrected.

Reference numeral 13 denotes an exposure apparatus. The exposure apparatus 13 includes a light-emitting element row in which organic electroluminescent elements acting as a light source for exposure are disposed at a resolution of 600 dpi (dot/inch) in a row, and the organic electroluminescent elements are selectively turned on and off in response to image data with regard to the photosensitive body 8 that is electrified to a predetermined potential by the electrifier 9, whereby an electrostatic latent image of a maximum A4 size is formed. If a predetermined potential (development bias) is applied to the development sleeve 10, potential inclination is produced between the electrostatic latent image and the development sleeve 10. And, a coulomb force is operated on toner in the development agent 6 supplied to the surface of the development sleeve 10 and electrified to a predetermined potential, and only toner of the development agent 6 is adhered to the photosensitive body 8, wherein the electrostatic latent image is made into an actual image.

As described in detail later, the exposure apparatus 13 is provided with a light quantity sensor as means for measuring the light quantity of the organic electroluminescent element.

Reference numeral 16 denotes a transfer roller. The transfer roller 16 is provided at a position opposed to the recording sheet conveyance path 5 with respect to the photosensitive body 8, and is turned in the direction D5 by a drive source (not illustrated). A predetermined transfer bias is applied to the transfer roller 16, wherein a toner image formed on the photosensitive body 8 is transferred onto the recording sheet 3 conveyed through the recording sheet conveyance path 5.

Subsequently, a description is continued, returning to FIG. 1.

Reference numeral 17 denotes a toner bottle, in which toners of yellow, magenta, cyan and black are accommodated. Pipes for conveying toners (not illustrated) are arranged from the toner bottle 17 to the respective development stations 2Y through 2K, and supply toner to the respective development stations 2Y through 2K.

Reference numeral 18 denotes a sheet feeding roller, which is turned in the direction D1 by controlling an electromagnetic clutch (not illustrated), and the sheet feeding roller 18 feeds a recording sheet 3 charged in the sheet feeding tray 4 to the recording sheet conveyance path 5.

A pair of a resist roller 19 and a pinch roller 20, which act as the nip conveyance means at the suction side are provided in the recording sheet conveyance path 5 located between the sheet feeding roller 18 and the transfer portion of the yellow development station 2Y at the extreme upstream side. The pair of resist roller 19 and pinch roller 20 are temporarily stop a recording sheet 3 conveyed by the sheet feeding roller 18, and convey the same in the direction of the yellow development station 2Y at a predetermined timing. The leading end of the recording sheet 3 is regulated to be parallel to the axial direction of the pair of resist roller 19 and pinch roller 20 by the temporary stop, thereby preventing the recording sheet from slewing.

Reference numeral 21 denotes a recording sheet passage detection sensor. The recording sheet passage detection sensor is composed of a reflection type sensor (photo reflector), and detects the leading end and trailing end of the recording sheet 3 based on presence or absence of reflection light.

As the resist roller 19 starts rotating by controlling power transmission by an electromagnetic clutch (not illustrated), the recording sheet 3 is conveyed in the direction of the yellow development station 2Y along the recording sheet conveyance path 5. However, starting from the timing at which rotation of the resist roller 19 is started, writing timing of latent images, turning ON/OFF of the development bias, and turning ON/OFF of the transfer bias, which are carried out by the exposure apparatuses 13Y through 13K disposed in the vicinity of the respective development stations 2Y through 2K, are independently controlled.

Hereinafter, referring to FIG. 2, a description is continued.

Since the distance from the exposure apparatus 13 to a development region (the vicinity of the portion where the spacing between the photosensitive body 8 and the development sleeve 10 is narrowest) is a design matter, for example, the time at which a latent image formed on the photosensitive body 8 reaches the development region since the exposure apparatus 13 starts exposure is also a design matter.

In Embodiment 1, where, as will be described later, a plurality of pages are continuously printed starting from the timing of starting rotation of the resist roller 19, such control is carried out by which the organic electroluminescent elements that compose the exposure apparatus 13 are lit with the light quantity thereof set between recording sheets (that is, between sheets) conveyed in the recording sheet conveyance path 5, and the development bias is turned off with respect to the position of a latent image formed on the photosensitive body 8.

Hereinafter, returning to FIG. 1, a further description is given.

A fixer 23 acting as nip conveying means at the exhaust side is provided in the recording sheet conveyance path 5 located at a further downstream side of the extreme downstream black development station 2K. The fixer 23 is composed of a heating roller 24 and a pressing roller 25.

Reference numeral 27 denotes a temperature sensor for detecting the temperature of the heating roller 24. The temperature sensor 27 is a ceramic semiconductor obtained by sintering at a high temperature using a metal oxide as its main material, and can measure the temperature of an object, with which the temperature sensor is brought into contact, by utilizing a change in the load resistance in response to temperature. Output of the temperature sensor 24 is inputted into the engine control portion 42 described later, and the engine control portion 42 controls power supplied to a heating source (not illustrated) incorporated in the heating roller 24 based on the output of the temperature sensor 27. That is, the engine control portion 42 controls the surface temperature of the heating roller 24 so that it becomes approximately 170° C.

As a recording sheet 3 on which a toner image is formed is passed through the nip portion formed by the heating roller 24, whose temperature is controlled, and the pressing roller 25, the toner image on the recording sheet 3 is heated and pressed by the heating roller 24 and the pressing roller 25, wherein the toner image is fixed on the recording sheet 3.

Reference numeral 28 denotes a recording sheet trailing end detection sensor, which monitors ejection of the recording sheet 3. Reference numeral 32 denotes a toner image detection sensor. The toner image detection sensor 32 is a reflection type sensor unit in which a plurality of light-emitting elements (each emitting visible light) whose light emission spectra differs from each other and a single light-receiving element. The sensor 32 detects the image density, utilizing the absorption spectra that differs from each other in response to image colors at the skin of the recording sheet 3 and an image-formed portion thereof. In addition, since the toner image detection sensor 32 can detect not only the image density but also image-formed portions, in the image forming apparatus 1 according to Embodiment 1, the toner image detection sensor 32 is provided at two points in the width direction of the image forming apparatus 1, and image formation timing is controlled based on detection positions of an image position error amount detection pattern formed on the recording sheet 3.

Reference numeral 33 denotes a recording sheet conveyance drum. The recording sheet conveyance drum 33 is a metallic roller whose surface is coated with rubber approximately 200 μm thick. A recording sheet on which an image is fixed is conveyed in the direction D2 along the recording sheet conveyance drum 33. At this time, the recording sheet 3 is cooled down by the recording sheet conveyance drum 33, and at the same time, is conveyed while being bent in the reverse direction of the image-formed surface and conveyed. Therefore, it is possible to reduce curl to a large extent, which occurs where a high density image is formed on the entire surface of the recording sheet. After that, the recording sheet 3 is conveyed in the direction D6 by a kick-out roller 35 and is ejected to an ejection tray 39.

Reference numeral 34 denotes a facedown ejection portion. The facedown ejection portion 34 is constructed to be rotatable centering around a supporting member 36. If the facedown ejection portion 34 is made open, the recording sheet 3 is ejected in the direction D7. With the facedown ejection portion 34 closed, a rib 37 is formed along the conveyance path at the back so that conveyance of the recording sheet 3 is guided along with the recording sheet conveyance drum 33.

Reference numeral 38 is a drive source. In Embodiment 1, a stepping motor is employed. The drive source 38 drives the peripheries of the respective development stations 2Y through 2K including the sheet feeding roller 18, resist roller 19, pinch roller 20, photosensitive bodies 8Y through 8K and transfer roller 16 (Refer to FIG. 2), and drives the fixer 23, recording sheet conveyance drum 33, and kick-out roller 35.

Reference numeral 41 denotes a controller, which receives image data from a computer (not illustrated), etc., via an external network, develops printable image data and generates the same. As described in detail later, the controller CPU (not illustrated) incorporated in the controller 41 is light quantity correcting means that receives measurement data of light quantity of organic electroluminescent elements being light-emitting elements from the exposure apparatuses 13Y through 13K and generates light quantity correction data, and at the same time, is also light quantity setting means for setting the light quantity of the organic electroluminescent elements based on the light quantity correction data.

Reference numeral 42 denotes an engine control portion. The engine control portion 42 controls the hardware and the mechanism of the image forming apparatus 1, forms a color image on the recording sheet 3 based on image data and light quantity correction data, which are transmitted from the controller 41, and at the same time carries out entire control of the image forming apparatus 1, including temperature control of the heating roller 24 of the fixer 23 described above.

Reference numeral 43 denotes a power source portion. The power source portion 43 supplies power of predetermined voltage to the exposure apparatuses 13Y through 13K, drive source 38, controller 41 and engine control portion 42, and further supplies power to the heating roller 24 of the fixer 23. A so-called high voltage system such as electrification potential to electrify the surface of the photosensitive body 8, development bias applied to the development sleeve (Refer to FIG. 2) and transfer bias applied to the transfer roller 16 is included in the power source portion. The engine control portion 42 not only turns on and off the high voltage power source but also adjusts the output voltage value and output current value by controlling the power source portion 43.

A power source monitoring portion 44 is included in the power source portion 43, which is devised so as be able to monitor at least the power source voltage supplied to the engine control portion 42 and the output voltage of the power source portion 43. The monitoring signal is detected by the engine control portion 42, by which turning-off of the power source switch, a lowering in power source voltage, which may occur during electrical failure, and in particular, output abnormality of the high voltage power source are detected.

With respect to the image forming apparatus constructed as described above, a description is given of the operations thereof with reference to FIG. 1 and FIG. 2.

In the following description, FIG. 1 is used mainly for description of the configuration and normal operation of the image forming apparatus 1, wherein the description is given with colors distinguished as in the development stations 2Y through 2K, photosensitive bodies 8Y through 8K, and exposure apparatus 13Y through 13K. FIG. 2 is used mainly for description regarding monochrome such as exposure and development process, wherein the description is given with colors not distinguished as in the development station 2, photosensitivity body 8 and exposure apparatus 13 for simplification.

### (Initialization Operation)

First, a description is given of an initialization operation when the power source of the image forming apparatus 1 is turned on.

When the power source is turned on, the engine control CPU (not illustrated) incorporated in the engine control portion 42 executes error check of electrical resources, which constitute the image forming apparatus 1, that is, writable and readable registers and memories. As the error check is completed, the engine control CPU (not illustrated) starts rotation of the drive source 38. As described above, the peripheries of the respective development stations 2Y through 2K including the sheet feeding roller 18, resist roller 19, pinch roller 20, photosensitive bodies 8Y through 8K and transfer roller 16, and the fixer 23, recording sheet conveyance drum 33, and kick-out roller 35 are driven by the drive source 38. However, immediately after the power source is turned on, the electromagnetic clutch (not illustrated) for transmitting a drive force to the sheet feeding roller 18 and the resist roller 19 related to conveyance of the recording sheet 3 is immediately turned off and is controlled so that the recording sheet 3 is not conveyed.

Hereinafter, a description is given mainly based on FIG. 2.

The stirring paddles 7a and 7b and development sleeve 10 of the development station 2 begin rotating in line with rotation of the drive source 38 (Refer to FIG. 1), wherein the development agent 6 composed of toner and carrier, which is filled in the development station 2, is circulated in the development station 2, and toner is given a negative charge based on friction between the toner and the carrier.

The engine control CPU (not illustrated) turns on the electrifier 9 by controlling the power source portion 43 (Refer to FIG. 1) after a predetermined period of time elapses since it starts rotation of the drive source 38 (Refer to FIG. 1). The surface of the photosensitive body 8 is electrified to a potential of, for example, −650V by the electrifier 9. Since the photosensitive body 8 turns in the direction D3, the engine control CPU (not illustrated) applies a development bias of, for example, −250V to the development sleeve 10 by controlling the power source portion 43 (Refer to FIG. 1) after the electrified area reaches a development region, that is, the closest approach position where the photosensitive body 8 and the development sleeve 10 reach each other. At this time, since the surface potential of the photosensitive body 8 is −650V, and the development bias applied to the development sleeve 10 is −250V, the electric line of force is oriented from the development sleeve 10 to the photosensitive body 8, and a coulomb force operating on toner having a negative charge is oriented from the photosensitive body 8 to the development sleeve 10. Accordingly, there is no case where toner is adhered to the photosensitive body 8.

As has been already described, the power source portion 43 (Refer to FIG. 1) is provided with a function of monitoring an output abnormality (for example, leak) of the high-voltage power source, and the engine control CPU (not illustrated) can check an abnormality when high voltage is applied to the electrifier 9 and the development sleeve 10.

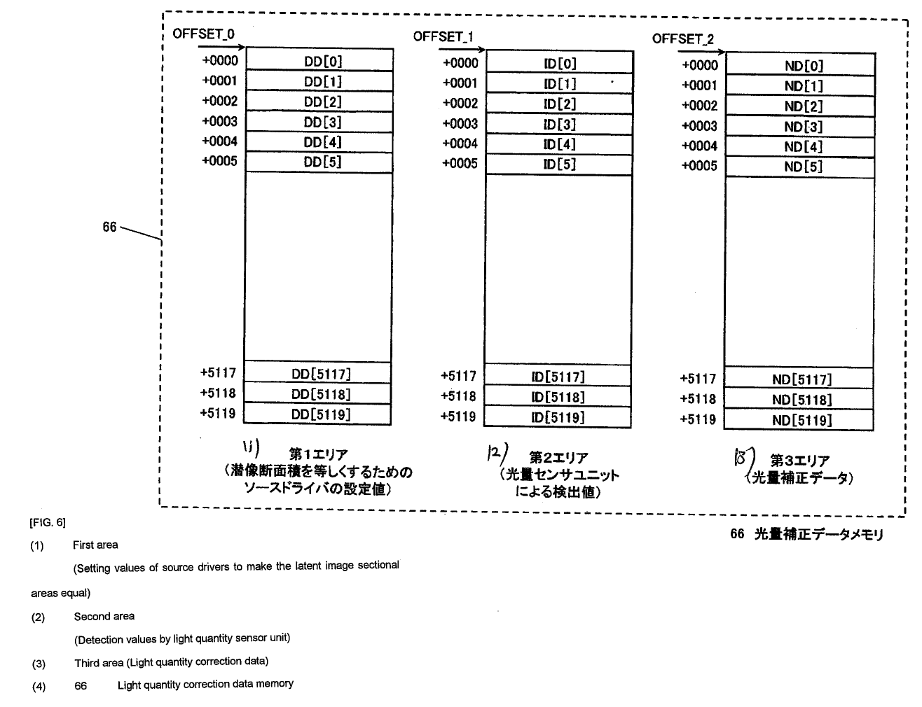

At the end of the series of initialization operations or at other predetermined timings as will be described later, an engine control CPU 91 (Refer to FIG. 7) executes correction of light quantity of the exposure apparatus 13. The engine control CPU 91 incorporated in the engine control portion 42 (Refer to FIG. 1) outputs a preparation request of dummy image information for correcting the light quantity to a controller 41 (Refer to FIG. 1). The controller 41 (Refer to FIG. 1) generates dummy image information for correcting the light quantity based on the preparation request, and based thereon, the organic electroluminescent elements that constitute the exposure apparatus 13 are actually controlled for lighting at the time of initialization operation.

As will be described later, the image forming apparatus 1 according to the present invention includes the exposure apparatus 13 in which a light-emitting element row having a plurality of light-emitting elements (organic electroluminescent elements) formed in a row is provided and forms an image by exposing the photosensitive body 8 being an image carrier by means of the exposure apparatus 13, wherein the image forming apparatus 1 includes means (the controller CPU incorporated in the above-described controller 41) for setting the light quantity of the light-emitting elements (organic electroluminescent elements) and means (the light quantity sensor incorporated in the above-described exposure apparatus 13) for measuring the light quantity of the light-emitting elements (organic electroluminescent elements).

Further, the image forming apparatus 1 according to the present invention includes: an exposure apparatus 13 in which a light-emitting element row having a plurality of light-emitting elements (organic electroluminescent elements) formed in a row is provided; a photosensitive body 8 on which a latent image is formed by the exposure apparatus 13; and means (the development sleeve 10 that composes the development station 2) for developing the latent image formed on the photosensitive body 8 and making the same into an actually visible image. And, as will be described in detail later, the image forming apparatus 1 also includes: means (the controller CPU incorporated in the controller 41) for setting the light quantity of the light-emitting elements (organic electroluminescent elements) and means (the light quantity sensor incorporated in the above-described exposure apparatus 13) for measuring the light quantity of the light-emitting elements (organic electroluminescent elements).

The organic electroluminescent elements, which act as an exposure light source and compose the exposure apparatus 13, are caused to be lit at a predetermined timing described later, and the light quantity is measured, wherein even if the light quantity, that is, the exposure light quantity to the photosensitive body 8 is corrected, no toner is adhered to the photosensitive body 8, and there is no case where the toner is wasted. Further, there is no case where toner is adhered to the transfer roller 16 brought into contact with the photosensitive body 8 and rotating along therewith, and the toner adhered to the transfer roller 16 is further adhered to the rear side of the recording sheet 3 in image formation that is carried out, following the initialization operation, wherein the recording sheet 3 is not contaminated.

In the light quantity correction, it is preferable that the development bias applied to the development sleeve 10 is turned off with respect to the region of the photosensitive body 8 exposed when a region, of the photosensitive body 8, exposed by lighting the organic electroluminescent elements approaches the development sleeve 10, and passes through a so-called development region, that is, in the period of measurement for measuring the light quantity of the organic electroluminescent elements. Therefore, it becomes possible to effectively prevent toner from being adhered to the photosensitive body 8.

### <Image Formation>

Next, subsequently referring to FIG. 1 and FIG. 2 together, a description is given of operations for image formation in the image forming apparatus 1.

As image information is transmitted externally to the controller 41, the controller 41 develops the image information in an image memory (not illustrated) as, for example, binary image data that can be used for printing. As development of the image data is completed, the controller CPU (not illustrated) incorporated in the controller 41 issues a start request to the engine control portion 42. The start request is received by the engine control CPU (not illustrated) incorporated in the engine control portion 42. The engine control CPU (not illustrated) that has received the start request immediately drives the drive source 38 and starts preparation of image formation.

As the preparation of image formation has been completed through the above-described process, the engine control CPU (not illustrated) incorporated in the engine control portion 42 causes the sheet feeding roller 18 to rotate by controlling the electromagnetic clutch (not illustrated) and starts conveyance of the recording sheet 3. The sheet feeding roller 18 is, for example, a semi-circular roller in which the entire periphery is partially notched.

The sheet feeding roller 18 conveys the recording sheet 3 in the direction of the resist roller 19, and at the same time, stops its rotation after it turns one time. When the leading end of the conveyed recording sheet 3 is detected by the recording sheet passage detection sensor 21, the engine control CPU (not illustrated) controls the electromagnetic clutch (not illustrated) with a predetermined delay term provided, and causes the resist roller 19 to turn. In line with rotation of the resist roller, the recording sheet 3 is supplied to the recording sheet conveyance path 5.

The engine control CPU (not illustrated) independently controls the writing timing of electrostatic latent images by means of the respective exposure apparatuses 13Y through 13K, respectively, starting from the rotation start timing of the resist roller 19. Since the writing timing of electrostatic latent images directly influences color shifts in the image forming apparatus 1, the writing timing is not issued directly by the engine control CPU (not illustrated). In detail, the engine control CPU (not illustrated) presets the writing timings of electrostatic latent images by respective exposure apparatuses 13 in a timer which is hardware (not illustrated), and simultaneously starts a timer operation corresponding to the respective exposure apparatuses 13Y through 13K, starting from the rotation of the above-described resist roller 19. As the preset time elapses, the timer outputs an image data transmission request to the controller 41.

The controller CPU (not illustrated) of the controller 41 that has received an image data transmission request independently transmits binary image data to the respective exposure apparatuses 13Y through 13K in synchronization with the timing signals (clock signal, line synchronization signal, etc.) generated by the timing generation portion (not illustrated) of the controller 41. Thus, the binary image data are transmitted to the exposure apparatuses 13Y through 13K, and turning-on and turning-off of the organic electroluminescent elements, which constitute the exposure apparatuses 13Y through 13K are controlled based on the binary image data, wherein the photosensitive bodies 8Y through 8K corresponding to respective colors are exposed.

A latent image formed by exposure is made into an actual visible image by toner included in the development agent 6 supplied onto the development sleeve 10 as shown in FIG. 2. The toner images of respective colors made into actually visible images are transferred one after another on the recording sheet 3 conveyed through the recording sheet conveyance path 5. The recording sheet 3 onto which four colors of toner images are transferred is conveyed to the fixer 23 and is nipped and conveyed by and between the heating roller 24 and the pressing roller 25, which constitute the fixer 23. The toner images are fixed on the recording sheet 3 with heat and pressure.

Where images to be formed are over a plurality of pages, after the engine control CPU (not illustrated) detects the trailing end of the recording sheet 3 of the first page by the recording sheet passage detection sensor 21, the engine control CPU (not illustrated) temporarily stops rotation of the resist roller 19 and starts conveyance of the next recording sheet 3 by rotating the sheet feeding roller 18 after a predetermined period of time elapses, and feeds the recording sheet 3 of the next page to the recording sheet conveyance path 5 by further starting rotation of the resist roller 19 again after a predetermined period of time further elapses. Thus, where images are formed over a plurality of pages based on the timing control of turning-on and turning-off of rotation of the resist roller 19, it is possible to set the time between recording sheets 3. The time between sheets differs depending on the specification of the image forming apparatus 1. However, there are many cases where the time is generally set to approximately 500 ms. As a matter of course, a normal image formation operation is not carried out for the period of time between sheets (that is, exposure operation is not carried out on the photosensitive body 8 by the exposure apparatus 3).

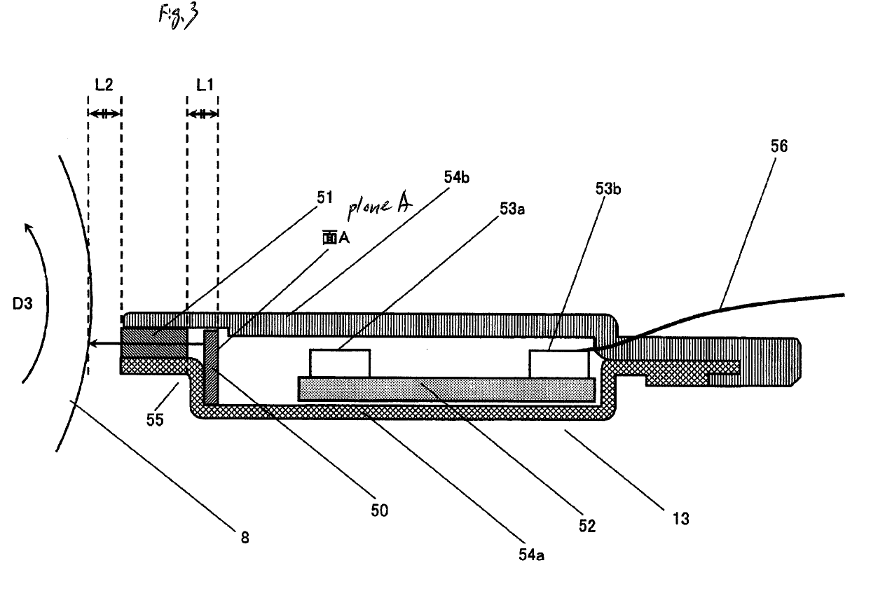

FIG. 3 is a schematic view of an exposure apparatus 13 in the image forming apparatus 1 according to the present invention. Hereinafter, a detailed description is given of the structure of the exposure apparatus 3, using FIG. 3. In FIG. 3, reference numeral 50 denotes a transparent and colorless glass substrate. In Embodiment 1, borosilicate glass that is advantageous in terms of cost is employed as the glass substrate 50. Glass or silica including a thermal conductivity-added factor such as MgO, Al₂O₃, CaO, ZnO, etc., may be employed where it is necessary to further efficiently radiate heat brought by a light-emitting element, and a control circuit, a drive circuit, etc., which are formed of a thin-film transistor on the glass substrate 50.

Organic electroluminescent elements acting as light-emitting elements are formed on the plane A of the glass substrate 50 at the resolution of 600 dpi (dot/inch) in the perpendicular direction of the drawing (in the main scanning direction). Reference numeral 51 denotes a lens array in which a bar lens (not illustrated) composed of plastic or glass is disposed in a row, and the lens array 51 guides emission light of the organic electroluminescent elements formed on the plane A of the glass substrate 50 to the surface of the photosensitive body 8 as an erect image of equal magnification. The positional relationship between the glass substrate 50, lens array 51 and photosensitive body 8 is adjusted so that one focus of the lens array 51 is located on the plane A of the glass substrate 50, and the other focus thereof is located on the surface of the photosensitive body 8. That is, where it is assumed that the distance from the plane A to the side of the lens array 51 nearer to the plane A is L1, and the distance from the other side of the lens array 51 to the surface of the photosensitive body 8 is L2, these components are set so as to ensure L1=L2.

Reference numeral 52 denotes a relay substrate having electronic circuits formed on, for example, glass epoxy substrate. Reference numeral 53a denotes a connector A, and 53b denotes a connector B. At least the connectors B 53a and B 53b are mounted in the relay substrate 52. The relay substrate 52 once relays, via the connector B 53b, image data, light quantity correction data and other control signals supplied externally to the exposure apparatus 13 by a cable 56 such as, for example, a flexible flat cable, and transmits these signals to the glass substrate 50.

Since it is difficult to directly mount connectors on the surface of the glass substrate 50 if the bonding strength and the reliability in various environments are taken into consideration, in Embodiment 1, FPC (Flexible Printed Circuit) is employed as means for connecting the connector A 53a of the relay substrate 52 to the glass substrate 50, wherein bonding of the glass substrate 50 and the FPC is carried out by, for example, ACF (Anisotropic Conductive Film), and the connector A 53a is directly connected to, for example, an ITO (Indium Tin Oxide: Tin-doped indium oxide) formed on the glass substrate 50 in advance.

On the other hand, the connector B 53b connects the exposure apparatus 13 to an external unit. Generally, although there are many cases where connection based on ACF brings about a problem in the bonding strength, it is possible to secure sufficient strength in the interface to which a user directly accesses, by providing the connector B 53b, by which the user connects the exposure apparatus 13, on the relay substrate 52.

Reference numeral 54a denotes a casing A, which is molded by bending or folding, for example, a metallic plate. An L-shaped portion 55 is formed at the side, of the casing A 54a, opposed to the photosensitive body 8, and the glass substrate 50 and the lens array 51 are disposed along the L-shaped portion 55. By employing such a structure in which the end face at the photosensitive body 8 side of the casing A 54a and the end face of the lens array 51 are made flush with each other, and furthermore, one end portion of the glass substrate 50 is supported by the casing A 54a, it becomes possible to accurately match the positional relationship established by the glass substrate 50 and the lens array 51 if the molding accuracy of the L-shaped portion 55 is secured. It is preferable that the casing A 54a is composed of metal because the dimensional accuracy is thus required for the casing A 54a. Also, if the casing A 54a is made of metal, it is possible to inhibit influence of noise upon electronic components such as a control circuit formed on the glass substrate 50 and IC chips mounted on the surface of the glass substrate 50.

Reference numeral 54b is a casing B obtained by molding resin. A notched portion (not illustrated) is provided in the vicinity of the connector B 53b of the casing B 54b, wherein a user can access the connector B 53b through the notched portion. Image data, light quantity correction data, control signals such as a clock signal and line synchronization signal, drive power of the control circuit, and drive power of organic electroluminescent elements being the light-emitting element are given from the controller 41 (Refer to FIG. 1) already described above to the exposure apparatus 13 via the cable 56 connected to the connector B 53b.

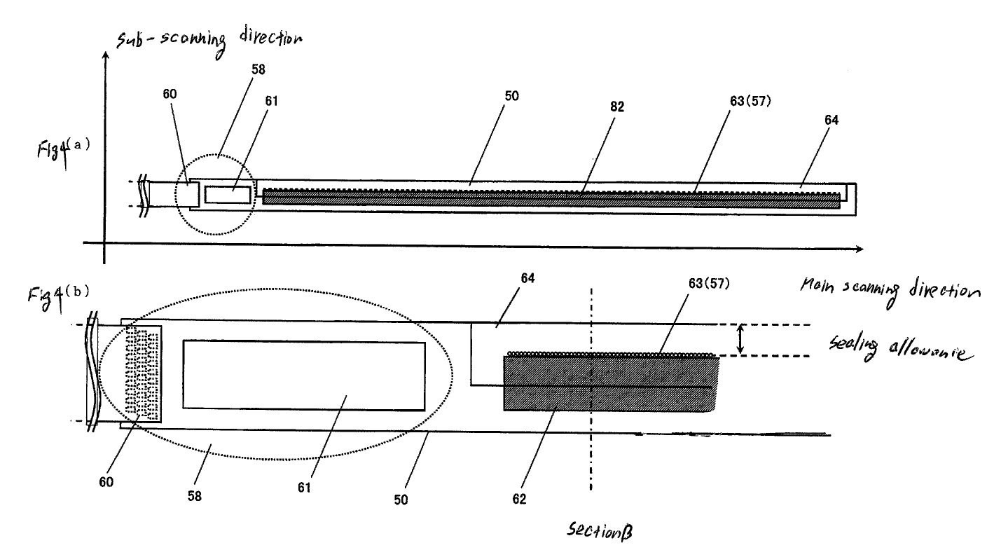

FIG. 4(a) is an upper plan view of the glass substrate 50 pertaining to the exposure apparatus 13 in the image forming apparatus 1 of Embodiment 1 according to the present invention, and FIG. 4(b) is an enlarged view showing the major parts thereof. Hereinafter, a detailed description is given of the configuration of the glass substrate 50 according to Embodiment 1, using FIG. 4 along with FIG. 3.

In FIG. 4, the glass substrate 50 is approximately 0.7 mm thick and is a rectangular substrate having at least a longer side and a shorter side, wherein a plurality of organic electroluminescent elements 63 that are light-emitting elements are formed to be row-shaped in the longitudinal direction (the main scanning direction). In Embodiment 1, organic electroluminescent elements 63 necessary for exposure of at least A4 size (210 mm) are disposed in the longitudinal direction of the glass substrate 50, and the glass substrate 50 in the longitudinal direction is 250 mm including space in which the drive control portion 58 described later is disposed. In addition, in Embodiment 1, a description is given, for simplification, based on the glass substrate 50 being rectangular. However, the glass substrate 50 may be subjected to deformation by providing a notched portion at a part of the glass substrate 50 for positioning when the glass substrate 50 is attached to the casing A 54a.

Reference numeral 58 denotes a drive control portion that receives binary image data, light quantity correction data, and control signals such as a clock signal and a line synchronization signal, which are supplied externally of the glass substrate 50, and controls drive of the organic electroluminescent elements 63 based on these signals. The drive control portion includes interface means for receiving these signals externally of the glass substrate 50 and an IC chip (source driver 61) for controlling drive of the organic electroluminescent elements 63 based on the control signals received by the interface means.

Reference numeral 60 denotes an FPC (Flexible Printed Circuit) acting as interface means for connecting the connector A 53a of the relay substrate 52 to the glass substrate 50, and is directly connected to a circuit pattern (not illustrated) secured on the glass substrate 50 without any connector interposed therebetween. As has already been described, binary image data, light quantity correction data and control signals such as a clock signal, a line synchronization signal, etc., drive power of the control circuits, and drive power of the organic electroluminescent elements 63 being the light-emitting elements, which are supplied externally to the exposure apparatus 13, are supplied to the glass substrate 50 via the FPC 60 after once passing through the relay substrate 52 shown in FIG. 3.

Reference numeral 63 denotes an organic electroluminescent element, and becomes the exposure light source in the exposure apparatus 13. In Embodiment 1, 5120 organic electroluminescent elements 63 are formed to be row-shaped at a resolution of 600 dpi in the main scanning direction, and individual organic electroluminescent elements are independently controlled for turning-on and turning-off by the TFT circuit described later.

Reference numeral 61 denotes a source driver supplied as an IC chip to control drive of the organic electroluminescent elements 63, and is mounted on the glass substrate by a flip chip. By taking into consideration that the source driver 61 is mounted on the glass surface, a bare chip article of the source driver 61 is employed. Power, control-related signals such as a clock signal, a line synchronization signal, and light quantity correction data of 8 bits are supplied externally of the exposure apparatus 13 to the source driver 61 via the FPC 60. The source driver 61 is means for setting drive current for the organic electroluminescent elements 63. In further detail, it is means for correcting the light quantity of the organic electroluminescent elements 63 and means for setting the light quantity. Based on the light quantity correction data generated by the controller CPU (not illustrated) incorporated in the controller 41 (Refer to FIG. 1), the source driver 61 sets a drive current to drive individual organic electroluminescent elements 63. A detailed description is given later of operations of the source driver 61 based on the light quantity correction data.

In the glass substrate 50, the bonded portion of the FPC 60 and the source driver 61 are connected to each other via a circuit pattern (not illustrated) of, for example, ITO having metal formed on the surface thereof, and light quantity correction data and control signals such as a clock signal, a line synchronization signal, etc., are inputted into the source driver 61 being the drive current setting means via the FPC 60. Thus, the FCP 60 that operates as the interface means and the source driver 61 that operates as the drive parameter setting means compose the drive control portion 58.

Reference numeral 62 denotes a TFT (Thin Film Transistor) circuit formed on the glass substrate 50. The TFT circuit 62 includes a gate controller (not illustrated) for controlling the timing of turning-on and turning-off of the organic electroluminescent elements 63 such as a shift register and a data latch portion, etc., and a drive circuit (not illustrated and hereinafter called a pixel circuit) for supplying a drive current to the individual organic electroluminescent elements 63, and at the same time, includes a switching circuit (selection signal generation circuit 140) for turning on and off a light quantity sensor 57 described later. The pixel circuits are provided one by one for the respective organic electroluminescent elements 63, and are arranged parallel to the light-emitting element row formed by the organic electroluminescent elements 63. A drive current value to drive individual organic electroluminescent elements 63 is set in the pixel circuits.

Power, control signals such as a clock signal, a line synchronization signal, etc., and binary image data are supplied externally of the exposure apparatus 13 to the gate controller (not illustrated), which constitutes the TFT circuit 62, via the FPC 60, and the gate controller (not illustrated) controls the timing to turn on and off the individual light-emitting elements based on the power and these signals. A detailed description is given later of operations of the gate controller and the pixel circuit (neither being illustrated), using the drawings. In addition, a description is given later of the configuration at the sensor side of the TFT circuit 62.

Reference numeral 64 denotes sealing glass. If influence due to moisture is given to the organic electroluminescent elements 63, the organic electroluminescent elements 63 are subjected to chronological shrinkage of the light-emitting region, and non-light-emitting region (dark spots) occurs in the light-emitting region, wherein the light-emitting characteristics thereof remarkably deteriorate. Therefore, sealing is required to shut out moisture. In Embodiment 1, a solid sealing method by which the sealing glass 64 is adhered to the glass substrate 50 by an adhesive agent is employed. Generally, it is necessary that a sealing region of approximately 2000 cm is secured in the sub-scanning direction from the light-emitting element row composed by the organic electroluminescent elements 63. Therefore, 2000 μm is secured as sealing allowance in Embodiment 1.

Reference numeral 57 denotes a light quantity sensor formed on the upper surface (in FIG. 4(b)) of the organic electroluminescent elements 63. The light quantity sensor 57 measures the light quantity of the individual organic electroluminescent elements 63. When measuring, it is necessary to measure the light quantity of the organic electroluminescent elements 63 by lighting the organic electroluminescent elements 63 one by one as a rule. However, since the light quantity sensor sufficiently spaced from the organic electroluminescent elements 63 is hardly influenced by light emission thereof (the emission light from the organic electroluminescent elements 63 attenuates), since the light quantity sensor 57 is composed of a plurality of light quantity sensors in Embodiment 1, it becomes possible to simultaneously measure the light quantity of a plurality of organic electroluminescent elements 63.

In Embodiment 1, the organic electroluminescent elements 63, TFT circuit 62, and light quantity sensors 57 are integrated and formed as a poly-silicon monolithic device. That is, since the light transmittance of low-temperature polysilicon, which constitutes the TFT circuit 62, is comparatively high, light quantity sensors 57 corresponding to the individual organic electroluminescent elements 63 can be located adjacent to the TFT circuit 62 and can be buried even if a so-called bottom emission configuration that picks up exposure light from the glass substrate 50 side is employed. In this case, the light quantity sensors are formed on the entire surface right below the light-emitting plane with respect to the individual organic electroluminescent elements 63, or may be formed so as to correspond to a part thereof.

Output of a plurality of light quantity sensors 57 is inputted into the source driver 61 already described, by wiring (not illustrated). The output, described later, of the light quantity sensors (that is, the light quantity sensor output) is subjected to voltage conversion by a charge accumulation method in the source driver 61, and is analog-digitally converted after it is amplified at a predetermined amplification ratio. The digitally converted data (hereinafter called light quantity measurement data) are outputted externally of the exposure apparatus 3 via the FPC 60, relay substrate 52 and cable 56 (For both, refer to FIG. 3). As will be described in detail later, the light quantity measurement data are received and processed by the controller CPU (not illustrated) incorporated in the controller 41 (Refer to FIG. 1) to generate light quantity correction data consisting of 8 bits.

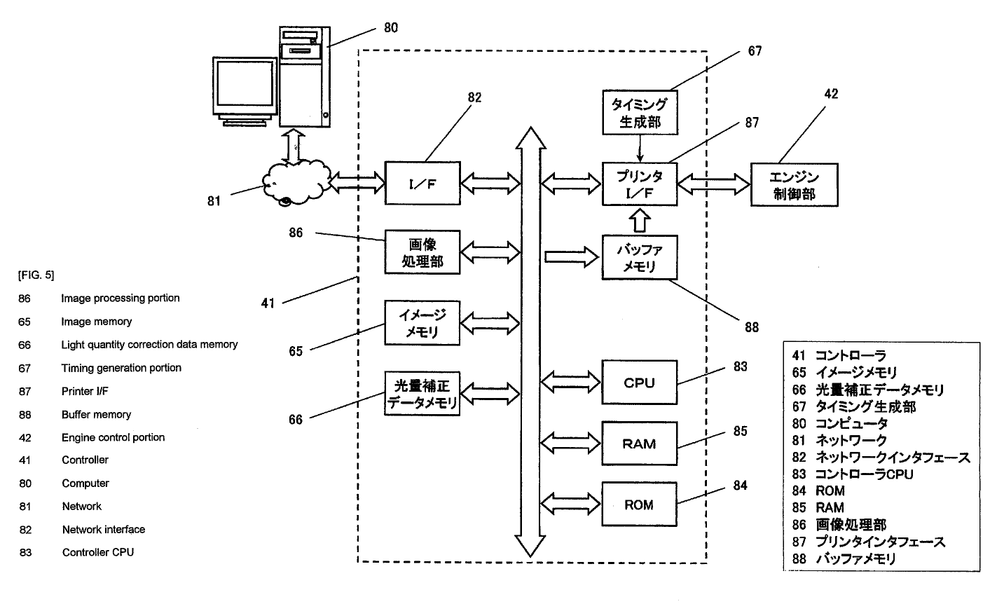

FIG. 5 is a block diagram showing the configuration of the controller 41 in the image forming apparatus 1 according to Embodiment 1 of the present invention. Hereinafter, operations of the controller 41 will be described using FIG. 5, and a further detailed description will be given of light quantity correction.

In FIG. 5, reference numeral 80 denotes a computer. The computer 80 is connected to a network 81, and transmits print job information such as image information, number of prints, and print mode (for example, color or monochrome print), etc., to the controller 41 via the network 81. Reference numeral 82 denotes a network interface. The controller 41 receives image information and print job information transmitted from the computer 80 via the network interface 82, develops the image information to printable binary image data, and simultaneously sends error information, which is detected at the image forming apparatus side, as so-called status information back to the computer 80 via the network 81.

Reference numeral 83 denotes a controller CPU that controls operations of the controller 41 based on programs stored in a ROM 84. Reference numeral 85 denotes a RAM that is used as a work area of the controller CPU 83, and temporarily stores image information and print job information, which are received via the network interface 82.

Reference numeral 86 denotes an image processing portion that carries out image processes (for example, an image development process, a color correction process, an edge correction process, a screen generation process, etc.) page by page based on the image information and print job information, which are transmitted from the computer 80, generates printable binary image data, and further stores the binary image data in the image memory 65 page by page.

Reference numeral 66 denotes a light quantity correction data memory composed of a rewritable non-volatile memory such as, for example, EEPROM.

FIG. 6 is an explanatory view showing the contents of the light quantity correction data memory in the image forming apparatus 1 according to Embodiment 1 of the present invention.

Hereinafter, using FIG. 6, a description is given of data structure and data content of the light quantity correction data memory.

As shown in FIG. 6, the light quantity correction data memory 66 has three areas from the first area through the third area. The respective areas have 5120 units of data of 8 bits, which are equivalent to the quantity of the organic electroluminescent elements 63 that compose the exposure apparatus 13 (Refer to FIG. 3), and occupies 15360 bytes in total.

First, a description is given of data DD[0] through DD[5119] stored in the first area, using FIG. 6 along with FIG. 3 and FIG. 4.

The exposure apparatus 13 already described (Refer to FIG. 3) includes a step of adjusting the light quantity of the individual organic electroluminescent elements 63, which compose the exposure apparatus 13, in the production process. In this step, the exposure apparatus 13 is attached to a predetermined fixture (not illustrated), and the organic electroluminescent elements 63 are individually controlled to be lit based on control signals supplied externally of the exposure apparatus 13.

Furthermore, a two-dimensional exposure amount distribution of the individual organic electroluminescent elements 63 on the image plane position of the photosensitive body 8 (Refer to FIG. 3) is measured by a CCD camera secured in the fixture (not illustrated). The fixture (not illustrated) calculates a potential distribution of a latent image formed on the photosensitive body 8 based on the distribution of exposure amount and further calculates the sectional areas of the latent images having high correlation with the adhesion amount of toner based on the actual development conditions (development bias value). In the fixture (not illustrated), by changing the drive current value to drive the organic electroluminescent elements 63, a drive current value at which all of the sectional areas of the latent images formed by the individual organic electroluminescent elements 63 become roughly equal to each other, that is, the setting value (setting data to the source driver 61 in view of control) to the pixel circuit is extracted {as has been already described, it is possible to set the current value for driving the organic electroluminescent elements 63 by programming an analog value in the pixel circuit that constitutes the TFT circuit 62 (Refer to FIG. 4) via the source driver 61 (Refer to FIG. 4)}.

Where the light-emitting regions of the organic electroluminescent elements 63 are equal to each other, and the light emitting quantity distributions in the light-emitting planes are equal to each other, and normal development conditions are assumed, the above-described sectional area of the latent image is almost proportional to the exposure amount. Further, [the light quantity (of emitting light) when the exposure time is fixed] and [the exposure amount] have the same meaning. Also, since generally the light emitting quantity of the organic electroluminescent elements 63 is proportional to the drive current value (that is, the setting value to the pixel circuit), it is possible to calculate and obtain the setting value to the pixel circuit (that is, (the setting data to the source driver 61 as described above), by which the areas of the latent images by the respective organic electroluminescent elements 63 are fixed, by once measuring the light emitting quantity of the individual organic electroluminescent elements 63 with the drive current setting made into the same in all the pixel circuits.

The setting data, thus obtained, to the source driver 61 are stored in the first area of the light quantity correction data memory 66. The quantity thereof is equal to the quantity of the organic electroluminescent elements 63 that constitutes the exposure apparatus 13 as described above. (That is, the quantity is 5120 data which are equal to the quantity of the pixel circuits). Thus, the first area of the light quantity correction data memory 66 stores [the setting value of the source driver 61 by which the sectional area of latent images formed by the individual organic electroluminescent elements 63 in the default status are made equal.

Next, a description is given of data ID[0] through ID[5119], which are stored in the second area, using FIG. 6 along with FIG. 3 and FIG. 4.

The fixture acquires the light quantity measurement data of 8 bits based on the output of the light quantity sensor 57 (Refer to FIG. 4) via the source driver 61 (Refer to FIG. 4) of the exposure apparatus 13 as soon as it acquires data stored in the first area. Accordingly, it is possible to acquire [the light quantity measurement data when the sectional areas of latent images formed by the individual organic electroluminescent elements 63 in the default status are made equal]. The second area stores the light quantity measurement data ID[n] of 8 bits.

It is necessary that the drive conditions of the organic electroluminescent elements 63 when acquiring the ID[n] by means of the fixture are equal to those when measuring the light quantity. As will be described later, in Embodiment 1, a lighting period of 300 ms in total is given by applying 350 μs of one-line period (raster period) of the image forming apparatus 1 a plurality of times.

Data stored in the first area and the second area are thus acquired in the production process of the exposure apparatus 13, and these data are written in the light quantity correction data memory by electric communications means (not illustrated).

Next, a description is given of data ND[0] through ND[5119] stored in the third area, using FIG. 6 along with FIG. 3, FIG. 4 and FIG. 5.

The image forming apparatus 1 according to Embodiment 1 of the present invention includes light quantity correcting means (light quantity correction portion) {controller CPU 83 (Refer to FIG. 5)} for roughly equally correcting respective light quantities of the organic electroluminescent elements 63 based on the measurement results by the light quantity sensor 57 operating as the light quantity measuring means, and the light quantity setting means (similarly, the controller CPU 83) sets the light quantities of the respective organic electroluminescent elements 63 for forming an image, based on the output of the light quantity correcting means. The light quantity setting values, that is, the light quantity correction data, of the respective organic electroluminescent elements 63 for forming an image by the controller CPU 83 that is the light quantity correcting means, are written in the third area.

In the image forming apparatus 1 according to Embodiment 1, it has already been described that the light quantities of the organic electroluminescent elements 63 which constitute the exposure apparatus 13 are measured at a predetermined timing described later when starting the initialization operation of the image forming apparatus 1, starting image formation therein, between sheets, and when completing the image formation. The controller CPU 83 generates light quantity correction data based on the light quantity measurement data measured at these points of time, [the set data of the source driver 61 to make equal the sectional areas of the latent images formed by the individual organic electroluminescent elements 63 in the default status] stored in the first area in the production process of the exposure apparatus 13, and [the light quantity measurement data when the sectional areas of the latent images formed by the individual organic electroluminescent elements 63 in the default status are made equal to each other] stored in the second area of the production process of the exposure apparatus 13 as well. That is, the controller CPU 83 functions as a light quantity correction portion for correcting the light quantity of the corresponding element with reference to the light quantities of the organic electroluminescent elements 63, which are detected by the light quantity sensors 57.

Hereinafter, although a description is given of the contents of calculation of the light quantity correction data by the controller CPU 83, the description is based on the assumption that the light quantity in measuring the light quantity is made equal to the light in forming an image in order to make the point of the present invention clear.

Where it is assumed that [the set data of the source driver 61 to make equal the sectional areas of the latent images formed by the individual organic electroluminescent elements 63 in the default status] stored in the first area is DD[n], [the light quantity measurement data when the sectional areas of the latent images formed by the individual organic electroluminescent elements 63 in the default status are made equal to each other] stored in the second area is ID[n], and the light quantity measurement data newly measured in the initialization operation, etc., is PD[n], new light quantity measurement data ND[n] written in the third area is generated by the controller CPU 83 based on (Expression 1). Also, although the light quantity measurement data ID[n] corresponds to the light quantity of the measured organic electroluminescent element, the light quantity correction data ND[n] corresponds to the current value flowing into individual elements established in the source driver 61.

ND[n]=DD[n]×ID[n]/PD[n] (where n means the number of individual organic electroluminescent elements in the main scanning direction). [Expression 1]

The light quantity correction data ND[n] thus generated are once written in the third area of the light quantity correction data memory 66 (Refer to FIG. 5). Hereinafter, prior to formation of a image, the light quantity correction data ND[n] are duplicated from the light quantity correction data memory 66 into a predetermined region of the image memory 65 (Refer to FIG. 5). When forming an image, the light quantity correction data ND[n] duplicated in the image memory 65 are temporarily stored in a buffer memory 88 (Refer to FIG. 5) described later, along with the binary image data, and are outputted to the engine control portion 42 (Refer to FIG. 5) via a printer interface 87 (Refer to FIG. 5).

The light quantity measurement data are subjected to potential conversion by a charge accumulation method in the source driver 61. The charge accumulation method is effective to increase the SN ratio. However, since the output (current value) of the light quantity sensor 57 (Refer to FIG. 4) is minute, some accumulation time is required for charge accumulation. This will be described later.

Subsequently, returning to FIG. 5, the description is continued.

Reference numeral 88 denotes a buffer memory. The binary image data stored in the image memory 65 and the above-described light quantity correction data are once stored in the buffer memory 88 when being transmitted to the engine control portion 42. The buffer memory 88 is composed of a so-called dual port RAM in order to absorb a difference between the data transmission rate from the image memory 65 to the buffer memory 88 and the data transmission rate from the buffer memory 88 to the engine control portion 42.

Reference numeral 87 denotes a printer interface. The page-by-page binary image data stored in the image memory 65 and the light quantity correction data are transmitted to the engine control portion 42 via the printer interface 87 in synchronization with a clock signal and a line synchronization signal, which are generated by the timing generation portion 67.

FIG. 7 is a block diagram showing the configuration of the engine control portion 42 of the image forming apparatus 1 according to Embodiment 1 of the present invention. Hereinafter, a detailed description is given of operations of the engine control portion 42, using FIG. 7 along with FIG. 1.

In FIG. 7, reference numeral 90 denotes a controller interface. The controller interface 90 receives the light quantity correction data and page-by-page binary image data transmitted from the controller 41.

Reference numeral 91 denotes an engine control CPU, which controls an operation for image formation in the image forming apparatus 1 based on programs stored in a ROM 92. Reference numeral 93 denotes a RAM that is used as a work area when the engine control CPU 91 operates. Reference numeral 94 denotes a so-called rewritable non-volatile memory such as an EEPROM. The non-volatile memory 94 stores, for example, information regarding the life of components such as rotation hours (time) of the photosensitive body 8 of the image forming apparatus 1 and operation hours (time) of the fixer 23 thereof, etc.

Reference numeral 95 denotes a serial interface. Information from sensor groups such as the recording sheet passage detection sensor 21 (Refer to FIG. 1) and the recording sheet trailing end detection sensor 28 (Refer to FIG. 1) and output from the power source monitoring portion 44 (Refer to FIG. 1) are converted to serial signals of a predetermined cycle by serial converting means (not illustrated) and are received by the serial interface 95. The serial signals received by the serial interface 95 are read by the engine control CPU 91 via a bus 99 after having been converted to parallel signals.

On the other hand, control signals for the actuator group 96 such as an electromagnetic clutch (not illustrated) to control start and stop of the sheet feeding roller 18 and the drive source 38 (for both, refer to FIG. 1) and to control transmission of a drive force for the sheet feeding roller 18 (Refer to FIG. 1) and control signals for a high voltage power source controlling portion 97 to manage the potential setting such as development bias, transfer bias, and electrification potential are sent to the serial interface 95 as parallel signals. The serial interface 95 converts the parallel signals to the serial signals and outputs the same to the actuator group 96 and the high voltage power source control portion 97. Thus, in Embodiment 1, sensor inputs for which high-speed detection is not required, and outputs of the actuator control signals are all carried out via the serial interface 95. On the other hand, for example, control signals to start and stop the resist roller 19, for which high-speed detection is required to some degree, are connected directly to the output terminals of the engine control CPU 91.

Reference numeral 98 denotes an operation panel connected to the serial interface 95. Instructions that a user carries out in the operation panel 98 are recognized by the engine control CPU 98 via the serial interface 95. Also, Embodiment 1 has an operation panel operating as instruction inputting means used for inputting instructions of a user. Based on inputs into the operation panel 98, the light quantities of the organic electroluminescent elements 63 that constitute the exposure apparatus 13 may be measured to correct the light quantity. It is, as a matter of course, possible for the instructions to be given externally of computer via the controller 41. As a detailed use case, a case may be assumed where image quality is at attempted to be secured by a user forcibly executing correction of the light quantity when the user finds unevenness in density on printed surfaces, for example, when a large amount of prints are carried out. When the image forming apparatus 1 is in a standby state, a user can give an instruction for forced light quantity correction at any time, and if image formation is temporarily held by shifting the image forming apparatus 1 to an off-line status even during forming images, it is possible for the user to give an instruction for correction of light quantity.

In any case, if a request for correction of light quantity is inputted from the operation panel 98 operating as instruction means, the engine control CPU 91 starts drive of components of the image forming apparatus 1 and outputs a request of preparation of dummy image information for correction of light quantity to the controller 41 as described in [Initialization operation]. Based on the request, the controller CPU 83 incorporated in the controller 41 prepares dummy image information for correction of light quantity, and based thereon, the organic electroluminescent elements 63 that constitute the exposure apparatus 13 is controlled for lighting. At this time, the light quantities of the individual organic electroluminescent elements 63 are detected by the light quantity sensors 57 secured in the exposure apparatus 13 described above, and the light quantities are corrected based on the detection results of the light quantities so that the light quantities of the individual organic electroluminescent elements 63 are made roughly equal to each other.

Next, a detailed description is given of operations for measuring the light quantities of the organic electroluminescent elements 63, using FIG. 7 along with FIG. 1, FIG. 5 and FIG. 6.

Correction of the light quantities is carried out at the time of initialization operation immediately after starting the image forming apparatus 1, before starting printing, between sheets, after starting printing, and at the timing instructed by a user as will be described later. However, a description is given, for simplification, of a case where measurement of light quantity is executed at the time of initialization operation of the image forming apparatus 1. In addition, the image forming apparatus 1 according to Embodiment 1 is constructed so as to enable formation of full-color images. As has already been described, the image forming apparatus 1 has exposure apparatuses 13Y through 13K (Refer to FIG. 1) corresponding to four colors. However, for simplification, a description will be described of operations corresponding only to one color, and it is described merely as an exposure apparatus 13. Further, in the situations described later, it is assumed that, for example, the drive source 38 (Refer to FIG. 1) and the development station 2 (Refer to FIG. 2) have already been started as already described in detail in the [Initialization operation].

Since the engine control portion 42 manages an image formation operation in the image forming apparatus 1, the sequence of correcting the light quantities is started by the engine control CPU 91 of the engine control portion 42. First, the engine control CPU 91 outputs a request for preparing dummy image information different from the regular binary image data pertaining to image formation.

The engine control portion 42 is connected to the controller 41 by a bi-directional serial interface (not illustrated), wherein it is possible to transmit and receive a request command and acknowledgement (response information) therebetween. The request of preparing dummy image information issued by the engine control CPU 91 is outputted from the controller interface 90 to the controller 41 via the bus 99 using the bi-directional serial interface (not illustrated).

Based on the request, the controller CPU 83 incorporated in the controller 41 directly prepares dummy image information, that is, binary image data used for measurement of the light quantities in the image memory 65. Further, the controller CPU 83 reads [the setting value of the source driver 61 by which the sectional area of latent images formed by the individual organic electroluminescent elements 63 in the default status are made equal] DD[n] (n: 0 through 5119), which is stored in the first area (Refer to FIG. 6) of the light quantity correction data memory 66, and writes the value in a predetermined region of the image memory 66. As these processes are completed, the controller CPU 83 outputs the response information to the engine control portion 42 via the printer interface 87.

Here, the engine control CPU 91 of the engine control portion 42 that has received the above-described response information immediately sets a writing timing to the exposure apparatus 13. That is, the engine control CPU 91 sets a writing timing of electrostatic latent images by the exposure apparatus 13 in a timer being hardware (not illustrated), and starts the operation of the timer upon receiving the response information (The function originally determines starting timing for each of the colors of a plurality of exposure apparatuses 13. Such strict setting of timing is not required for measurement of light quantities, wherein the timer may be set to 0). The timer outputs a request of transmitting image data to the controller 41 when a preset time elapses. The controller 41 that has received the request of transmitting image data transmits the binary image data to the exposure apparatus 13 in synchronization with the timing signal (clock signal, line synchronization signal, etc.) generated in the timing generation portion 67 via the controller interface 90. Simultaneously therewith, the setting value of the light quantities, which has already been written in the image memory 62, is transmitted to the exposure apparatus 13 in synchronization with the above-described timing signal.

Thus, the binary image data transmitted in synchronization with the timing are inputted into the TFT circuit 62 of the exposure apparatus 13, and simultaneously the setting value of light quantities are inputted into the source driver 61 of the exposure apparatus 13. In the exposure apparatus 13, lighting and light-out of the corresponding organic electroluminescent element 63 are controlled based on the inputted binary image data, that is, the ON/OFF information. And, at this time, the light quantities of the individual organic electroluminescent elements 63 are measured by the light quantity sensor 57.

As described above, the lighting of the organic electroluminescent elements 63 is controlled, and the light quantities thereof are measured by the light quantity sensor 57. Output (analog current value) of the light quantity sensor 57 is converted to voltage by a charge accumulation method in the source driver 61 and is amplified at a predetermined amplification ratio. After that, the output is subjected to analog-digital conversion, and is outputted from the source driver 61 as the light quantity measurement data (digital data) of 8 bits.

The light quantity measurement data outputted from the source driver 61 are transmitted from the engine control portion 42 to the controller 41 via the controller interface 90, and are received by the controller CPU 83 of the controller 41.

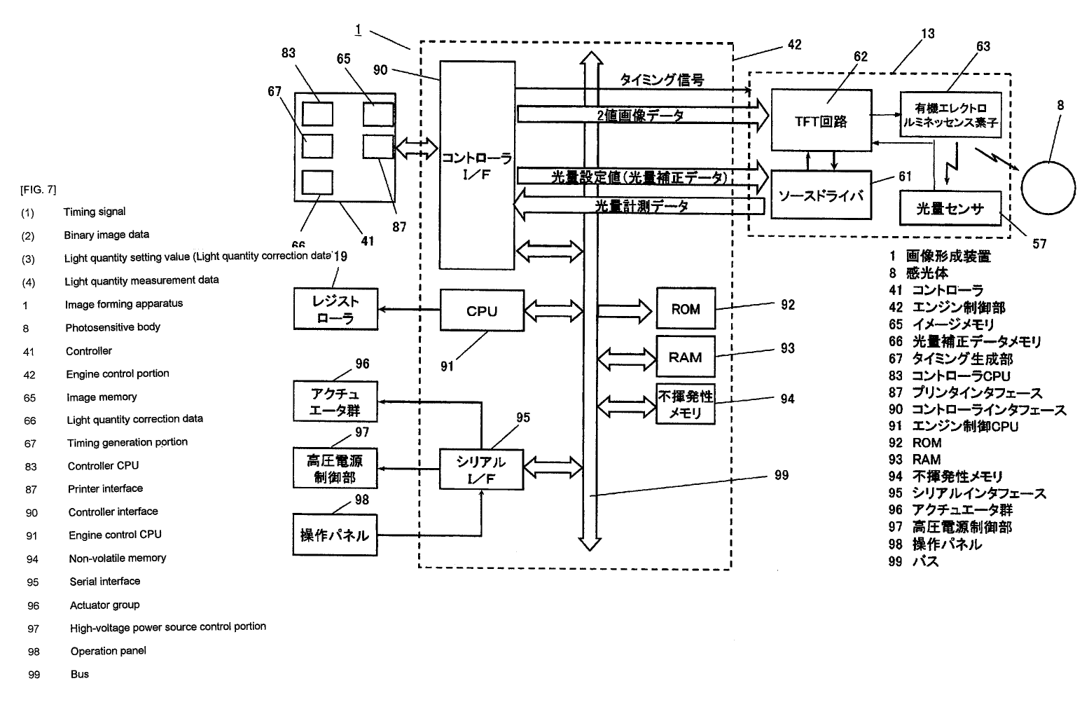

FIG. 8 is a circuit diagram of the exposure apparatus 13 in the image forming apparatus 1 according to Embodiment 1 of the present invention. Hereinafter, using FIG. 8, a further detailed description is given of lighting control by the TFT circuit 62 and the source driver 61.

The TFT circuit 62 is broadly divided into the pixel circuit 69 and the gate controller 68. The pixel circuit 69 is provided for the respective organic electroluminescent elements 63 one by one, wherein M pixels of the organic electroluminescent elements 63 are classified as a group and are provided by N groups on the glass substrate 50.

In Embodiment 1, one group consists of 8 pixels (that is, M=8), wherein the number of groups is 640. Therefore, all the pixels are made into 8×640=5120 pixels. The respective pixel circuits 69 have a driver portion 70 that supplies a current to the organic electroluminescent element 63 and drives the same, and a so-called current program portion 71 causing a capacitor included therein to store the current value (that is, a drive current value of the organic electroluminescent element 63) supplied by a driver when controlling the lighting of the organic electroluminescent element 63, wherein it is possible to drive the organic electroluminescent element 63 at a fixed current in response to the programmed drive current value at a predetermined timing.

The gate controller 68 includes a shift register that shifts the inputted binary image data one after another, a latching portion that is provided parallel to the shift register and collectively holds a predetermined number of pixels after they are inputted into the shift register, and a control portion for controlling the operation timing thereof (all thereof not illustrated). The binary image data (image information converted by the controller 41 when forming an image and dummy image information converted by the controller 41 when measuring the light quantity) are passed from the controller 41 to the gate controller 68, and the gate controller 68 outputs SCAN_A and SCAN_B signals based on the binary image data, that is, ON/OFF information, and thereby controls the period of turning on and turning off the organic electroluminescent element 63 connected to the pixel circuit 69 and the timing of the current program period by which the drive current is set.

On the other hand, the source driver 61 internally includes D/A converters of the quantity (640 converters in Embodiment 1) corresponding to the group number N of the organic electroluminescent elements 63. The source driver 61 sets the drive currents corresponding to the individual organic electroluminescent elements 63 based on the light quantity correction data of 8 bits supplied via the FPC 60.

FIG. 9 is an explanatory view showing a current program period and a lighting period of the organic electroluminescent elements 63 pertaining to the exposure apparatus 13 in the image forming apparatus 1 according to Embodiment 1 of the present invention. Hereinafter, a further detailed description is given of the lighting control of Embodiment 1, using FIG. 9 along with FIG. 8. Hereinafter, a description is given of one pixel group consisting of 8 pixels (for example, [pixel numbers in the main scanning direction] of FIG. 9=1 through 8).

In Embodiment 1, one line period (raster period) of the exposure apparatus 13 is set to 350 μs, and ⅛ (43.77 μs) of one line period is shared as a program period for setting a drive current value for a capacitor formed in the current program portion 71.

First, the gate controller 68 (Refer to FIG. 8) sets a program period with regard to the pixel of pixel number=1 by turning on the SCAN_A signal and turning off the SCAN_B signal. The light quantity correction data being supplied of 8 bits are supplied to the D/A converter 72 incorporated in the source driver 61 (Refer to FIG. 8) in the program period, and the capacitor of the current program portion 71 (Refer to FIG. 8) is charged by analog level signals digital-analog converted from the supplied digital data. The program period is continued regardless of ON/OFF of the binary image data inputted into the gate controller 68. An analog value based on the light quantity correction data of 8 bits is thereby written in the capacitor formed in the current program portion 71 once every line period. That is, accumulation charge of the capacitor formed in the current program portion 71 is always refreshed, and the drive current of the organic electroluminescent elements 63, which is determined based thereon, is always kept at a fixed level.

When the program period is completed, the gate controller 68 (Refer to FIG. 8) immediately turns off the SCAN_A signal and turns on the SCAN_B and sets a lighting period. As has already been described, binary image data are supplied to the gate controller 68 (Refer to FIG. 8) in response to the time of forming an image and the time of measuring the light quantity, wherein, when the image data are turned OFF even in the lighting period, the organic electroluminescent elements 63 are not lit. On the other hand, when the image data are turned on, the organic electroluminescent elements 63 continues lighting for the remaining period of 306.25 μs (350 μs−43.75 μs) (Actually, since exists a time for switchover of a control signal, the light-emitting time becomes slightly short). As has already been described, since, in Embodiment 1, a measurement period of 30 ms is assumed when measuring the light quantities of the organic electroluminescent elements 63, the dummy image information will be generated by the controller 41 so that the number of times of lighting becomes 100 (that is, 100 lines) when the light quantities are measured.

On the other hand, when the program period with regard to the pixel circuit having a pixel number=1 shown in FIG. 9 is terminated, the gate controller 68 (Refer to FIG. 8) immediately sets a current program period with regard to the pixel circuit 69 (Refer to FIG. 8) having a pixel number=8. Hereinafter, when the program period with regard to the pixel circuit 69 (Refer to FIG. 8) having a pixel number=8 is terminated as in the procedure for the pixel circuit having a pixel number=1, the process is shifted to the lighting period of the organic electroluminescent element 63 (Refer to FIG. 8) of the corresponding pixel number.

Thus, the gate controller 68 (Refer to FIG. 8) sets the program period and the lighting period in the order of pixel numbers of [1→8→2→7→3→6→4→5→1 . . . ] in the main scanning direction. If such a lighting sequence is employed, the lighting timings of the closest pixels between adjacent pixel groups approach each other in terms of time, it is possible to make errors between images inconspicuous when forming images for one line.

### [Operation for Correcting Light Quantity]

Next, in order to obtain light quantity measurement data, a detailed description is given of a configuration of the light quantity sensor 57 and its periphery member, and of an operation for acquiring light quantity measurement data.

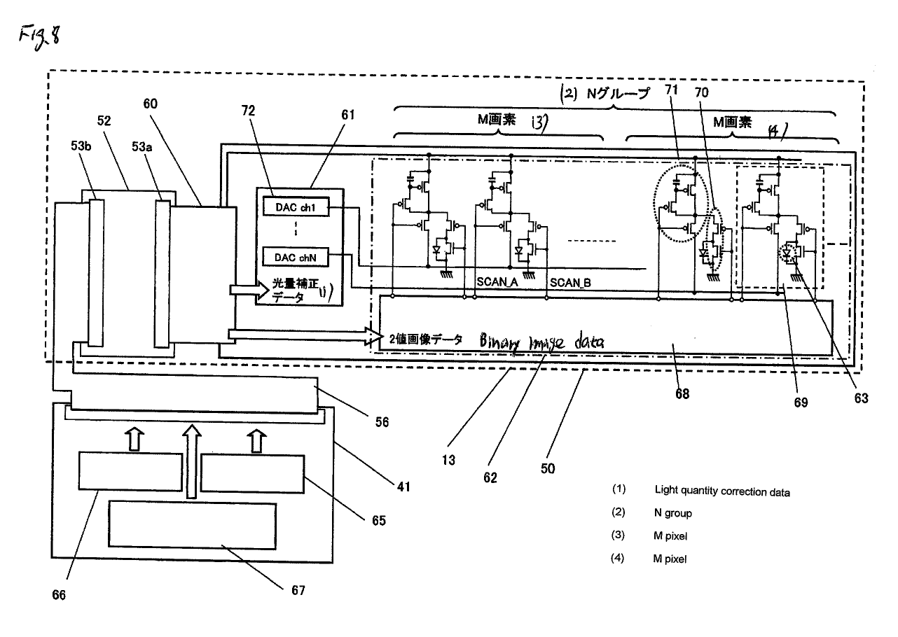

FIG. 10 is an explanatory view showing a drive circuit of an organic electroluminescent element and a light quantity sensor corresponding thereto in Embodiment 1 of the present invention.

FIG. 10 shows the organic electroluminescent element 63, the light quantity sensor 57 corresponding thereto and a selection signal generation circuit (switching circuit) 140 for carrying out a switching operation with regard to the light quantity sensor 57.

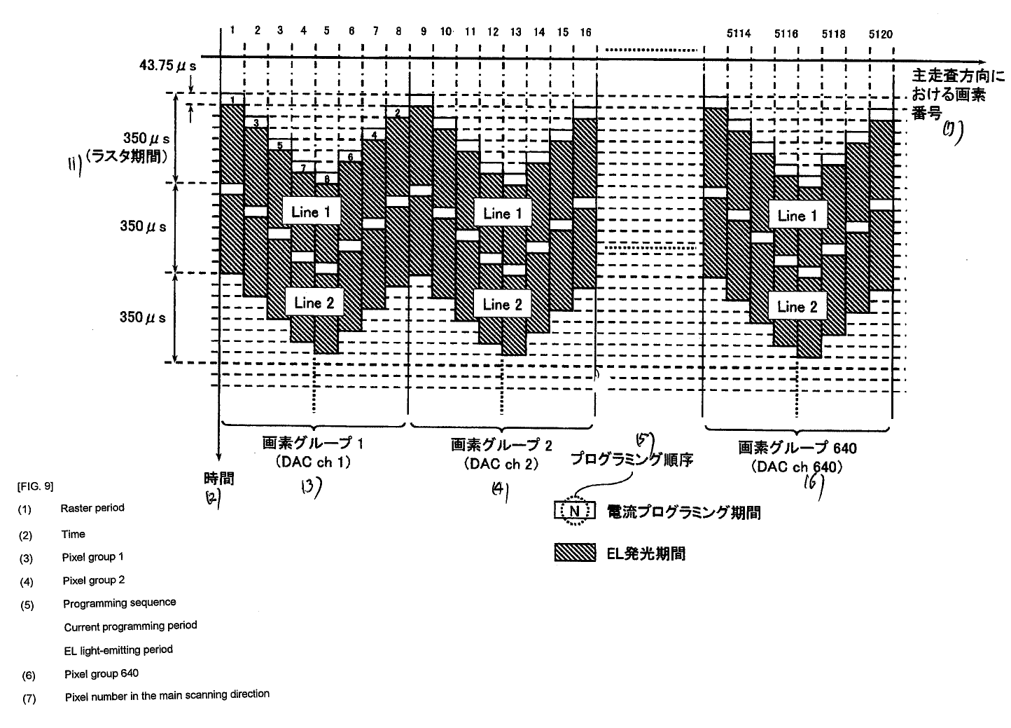

In Embodiment 1, as described above, the organic electroluminescent elements 63 are disposed by 5120 pieces in a row in the main scanning direction at a resolution of 600 dpi. And, 5120 light quantity sensors 57 that are of the same quantity as that of the corresponding organic electroluminescent elements are formed. The respective light quantity sensors 57 (Sensor pixel circuits 130 including a light quantity sensor: Refer to FIG. 11) are connected to the respective selection signal generation circuits 140 via a selection line SelX, and at the same time, are connected to the source driver 61 via a driver line RoX (Refer to FIG. 11). In addition, the selection line SelX and the driver line RoX are integrated and formed in the TFT circuit 62 along with the selection signal generation circuit 140.

The selection signal generation circuit 140 receives an instruction to drive the sensor from the controller 41 at predetermining timing, and outputs a sensor drive signal to a selection transistor 132 of the respective sensor pixel circuits 130. The selection signal generation circuit 140 outputs a sensor drive signal to the respective sensor pixel circuits 130 in response to time series. However, for example, the generation circuit 140 is generally composed by allotting an output circuit consisting of two series of shift registers (D type flip flop connection) and one three-input ΔND circuit to each of the sensor pixel circuits. Such a configuration is similar to a normal selection signal generation circuit.

And, in Embodiment 1, one sensor group 120 is composed of 16 light quantity sensors 57. As illustrated, the respective light quantity sensors 57 in the respective groups are given sensor element numbers 1 through 16 in the same group. Further, in Embodiment 1, the sensor group sets disposed in the main scanning direction are categorized by 16 sensor groups of groups 1a through group 1p in the main scanning direction. And, the groups to which the same alphabetic letters are given in the respective categories are connected to the same driver line RoX. For example, groups 1a, 2a, . . . 20a (20 groups in total) are connected to the driver line Ro1, and the groups 1p, 2p, . . . 20p are connected to the driver line Ro16.

The respective driver lines RoX are connected to charge amplifiers 150 secured in the source driver 61 as shown in FIG. 11. That is, the charge amplifiers 150 which are 16 in total are provided in the source driver 61, corresponding to each of all the driver lines RoX. On the other hand, the selection signal generation circuit 140 is formed in the TFT circuit 62 as well as the gate controller 68 shown in FIG. 8. The selection signal generation circuit 140 (and selection resistor 132: Refer to FIG. 11) functions as a switching circuit for inputting a sensor drive signal to drive the light quantity sensor at a predetermined timing described later into the sensor pixel circuit 130 via the selection line SelX. On the other hand, the charge amplifier 150 (and capacitor 131: Refer to FIG. 11) functions as a sensor drive circuit to actually drive the light quantity sensor.

Using the configuration shown in FIG. 10 and FIG. 11, the light quantity is corrected at a predetermined timing described later. At this time, the outputs from the light quantity sensor, the light quantity measurement data are finally read. At this time, the sequence is as follows. However, the reading sequence is not particularly limited.

(1) First, the light quantity measurement data from all the light quantity sensors connected to the driver line Ro1 are read. That is, the light quantity measurement data are read in the order of groups 1a, 2a, . . . and 20a. In terms of the selection lines, the sequence will be Sel1, Sel2, . . . . Sel6, Sel257, Sel258 . . . . Sel4864, Sel4865 . . . . Sel4879, Sel4880. Based on the sequence, the sensor drive signal from the selection signal generation circuit 140 is turned on.

(2) The above-described reading (1) is carried out in all the driver lines RoX at the same time. That is, the above-described reading is carried out in parallel at the same time via all the driver lines Ro1 through Ro16. The light quantity measurement data corresponding to all the sensor elements, that is, for all the organic electroluminescent elements 63 are thereby read.

FIG. 11 is an explanatory view showing a connection relationship between the sensor pixel circuit 130 and the charge amplifier 150 and the relationship in operation between the light quantity sensors 57 and the organic electroluminescent elements 63.

In FIG. 11, the periphery of the light quantity sensor 57 has been enlarged in the illustrated.

The respective selection line SelX is connected to the light quantity sensor 57, the capacitor 131 is connected to the corresponding light quantity sensor 57 in parallel and composing a capacitance element, and the sensor pixel circuit 130 composed of the selection transistor 132 for switching, is connected to the light quantity sensor 57 and the capacitor 131 in series. The selection transistor 132 composes a switching circuit of the light quantity sensor along with the selection signal generation circuit 140. The selection SelX is connected to the selection transistor 132, the sensor drive signals composed of ON and OFF signals outputted from the selection signal generation circuit 140 is inputted into the selection transistor 132, and the selection transistor 132 carries out ON and OFF operations in response to the corresponding drive signals.

And, 20 sensor groups of 120 in total (group number 1 through 20), in other words, 320 sensor pixel circuits in total (16×20) are connected to one driver line RoX, and the respective driver lines RoX are connected to a charge amplifier 150 provided in the source driver 61. The charge amplifier 150 is composed of an amplifier 151, a capacitor 152 to compose a capacitance element, and a charge/discharge selection transistor 153. Further, the amplifier 151 of the charge amplifier 150 is connected to an analog/digital converter (AC) 160 provided in the source driver 61. The charge amplifier 150 constitutes a sensor drive circuit in cooperation with the capacitor 131 of the sensor pixel circuit 130.

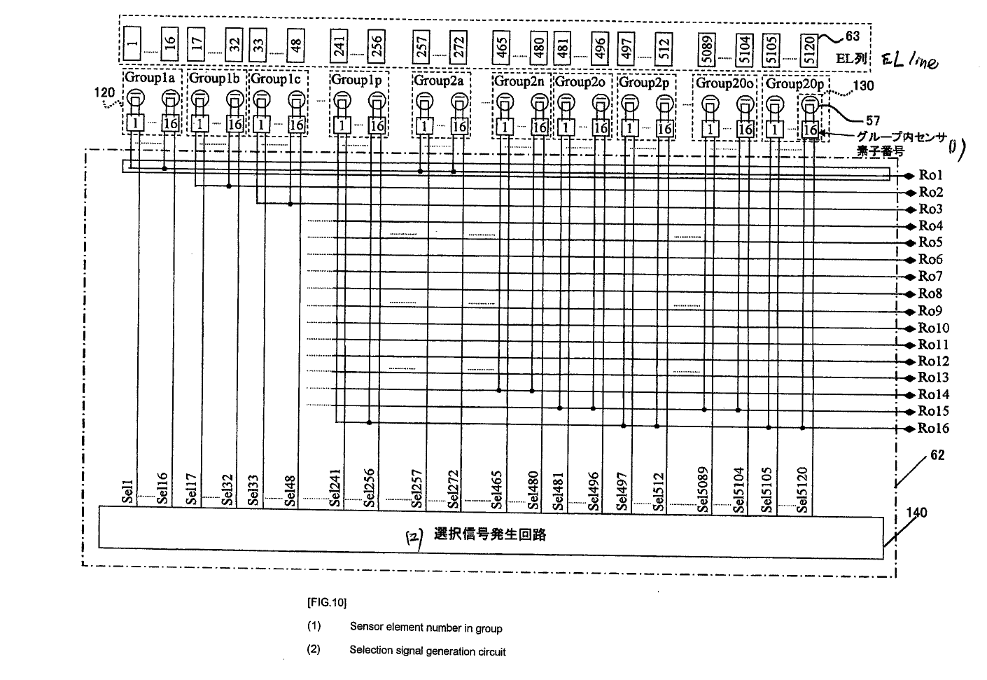

FIG. 12 is a timing chart showing operations of the sensor pixel circuit 130 and the charge amplifier 150, etc., in Embodiment 1 of the present invention.

FIG. 12 also shows operations of the respective portions shown in FIG. 11.

That is, in the above-described sequence (1), the timing chart corresponds to a timing chart of a reading operation of the light quantity measurement data carried out in each of the respective light quantity sensors 57. As described above, the light quantity output that will be the foundation of the light quantity measurement data is subjected to potential conversion by a charge accumulation method in the source driver 61, and furthermore, is generated by being analog-digitally converted after having been amplified at a predetermined amplification ratio. The following timing chart corresponds to the corresponding process.

With regard to the light quantity measurement data based on the outputs of the light quantity sensors 57, charge accumulated in the capacitor 131 in advance is extracted by irradiation of light of the organic electroluminescent elements 63 onto the light quantity sensors to the switching of the selection transistors 132 as shown in the timing chart of FIG. 12(a) through FIG. 12(g), and measurement is carried out based on the charge of the capacitor 152 used to compensate lost charge. Therefore, in Embodiment 1, the light quantity measurement data corresponds to the output of the light quantity sensors for which the charge lost by irradiation of light of the organic electroluminescent elements 63 will become the foundation.

Herein, FIG. 12(a) shows a charge state of the capacitor 152 in the charge amplifier 150, FIG. 12(b) shows operations of the selection transistor 132, FIG. 12(c) shows lighting timing of the organic electroluminescent elements 63, FIG. 12(d) shows differences (Vₛ) in potential between the front stage and the rear stage of the capacitor 131, FIG. 12(e) shows an output voltage (Vᵣₒ) of the amplifier 151, FIG. 12(f) shows an operation for reading the output voltage (Vᵣₒ) by the analog/digital converter (ADC) 160, and FIG. 12(g) shows a state where the light quantity measurement data are finally and effectively obtained.

First, by receiving an ON signal from the selection signal generation circuit 140 via the selection line SelX at a predetermined timing, the selection transistor 132 is turned on (Refer to FIG. 12(b)), wherein the capacitor 131 is charged as shown in FIG. 12(d), and a reference voltage V_{ref} is generated before and after the capacitor 131 (S1*Reset step).

And, when the selection transistor 132 is turned off (Refer to FIG. 12(b), the charge accumulated in the capacitor 131 is discharged and reduced by light current Is flowing in the light quantity sensor 57, and at the same time, as shown in FIG. 12(d), the reference voltage V_{ref} of the capacitor 131 gradually decreases (S2: Light irradiation discharge step).

And, after a preset time elapses in this state, the charge/discharge selection transistor 153 of the charge amplifier 150 is turned off (Refer to FIG. 12(a)), wherein the charge of the capacitor 152 is made movable, and the charge amplifier 150 is made into a state where the light quantities of the organic electroluminescent elements 63 can be measured. (S3: Measurement start step)

Further, with the turning-off of the charge/discharge selection transistor 153, the selection transistor 132 is turned on (Refer to FIG. 12(b)), charge is supplied from the capacitor 152 of the charge amplifier 150 to the capacitor 131 the charge of which is lost in Step S2. As a result, the reference voltage V_{ref} is again generated before and after the capacitor 131 (Refer to FIG. 12(d)), and at the same time, as shown in FIG. 12(e), the output voltage Vᵣₒ of the amplifier 151 of the charge amplifier 150 is raised (S4: Charge transmission step). Also, the flow Vᵣₒ of light current of the light quantity sensors 57 rises during this period.

After that, the selection transistor 132 is again turned off, where Vᵣₒ is confirmed. Since the confirmed voltage is read by the analog/digital converter (ADC) 160 in interlock with the reading signal (Refer to FIG. 12(f)), a reading operation of effective light quantity measurement data is completed as shown in FIG. 12(g) (S5: Read step).

Also, with respect to the time (accumulation time) in which the above steps S2 and S3 are added together, that is, setting of the timing for which the selection transistor 130 is turned on immediately after the charge/discharge selection transistor 153 of the charge amplifier 150 is turned off, it is preferable in view of shortening the standby time of the image printing apparatus that the time is made as short as possible. However, in view of securing a predetermined SN and voltage detection resolution, it is preferable that Vᵣₒ is made as large as possible. In this case, it is requested that as long an accumulation time as possible is secured. Therefore, the accumulation time is established in view of both of these points. The lighting time and number of times of lighting (Refer to FIG. 12(c)) of the organic electroluminescent elements 63 are determined by the number of the light quantity sensors and the number of the groups, which are described in the above-described sequence (1).

FIG. 13 is an explanatory view showing various examples of timings for which light quantity measurement is carried out for correction of the light quantities.

FIG. 13 shows an example for which the timing for which light quantity measurement is carried out as part of light quantity correction is established at three points of time, that is, in an initializing process, a continuous printing process and a standby status of the image forming apparatus, wherein (1) illustrated therein pertains to light quantity measurement in the initializing process, (3) and (4) pertains to light quantity measurement in the continuous printing process, (5) pertains to light quantity measurement in the standby status, and (2) pertains to light quantity measurement in the initializing process and in the continuous printing process.

The initializing process is a process for the image forming apparatus to prepare printing after the power source is turned on. In the initializing process, usually (e) the heating roller begins heating as soon as (a) the power source is turned on. After that, (f) electrification of the surface of the photosensitive body is started by the electrifier as soon as (d) the drive motor (not illustrated) of the photosensitive body is started. Further thereafter, (g) development bias potential V_{B} is applied to the development agent by the development station.

If the organic electroluminescent elements 63 emit light when the steps of (d), (f) and (g) are carried out (turned on), the surface of the photosensitive body exposed by the corresponding light emission will be set to the exposure potential VL, whereby the development agent will be made transmittable onto the photosensitive body. In order to prevent sheets from being contaminated due to the phenomenon, light quantity measurement of the organic electroluminescent elements is not carried out when executing the steps (d), (f) and (g). In the present example, (c) the organic electroluminescent elements 63 are caused to emit light before the steps (d) and (f), and (l) light quantity measurement is carried out. Light quantity measurement in (2) and (5) are executable based on similar reasons.

Light quantity measurement of (3) and (4) is executable during the continuous printing process. In particular, although the steps (d), (f) and (g) are carried out during the period, it is considered that since no recording sheet is fed, light quantity measurement is possible as a rule.

Herein, for example, if the interval between the timings for operations of light quantity measurement is lengthened, a case can be considered where the temperature characteristics at the peripheries of the organic electroluminescent elements 63 greatly differ before and after an operation for measuring light quantities. Since the brightness of the organic electroluminescent elements 63 differs based on the ambient temperature, the light quantities measured may change in response to such a change in the environment. Therefore, if changes in the temperature characteristics increase, changes in the light quantities of the organic electroluminescent elements 63 also increase. And, the amplitude of fluctuation in the light quantity correction value is increased, wherein a fluctuation in the image density is increased before and immediately after the light quantity correction.

Therefore, an image forming apparatus 1 according to Embodiment 1 of the present invention is provided with a control portion that determines exposure conditions based on the measurement results and the results measured before the measurement by means of a light quantity measurement portion, and controls the image density. Therefore, it is possible to prevent the image density from fluctuating immediately after the light quantities are corrected. Herein, in Embodiment 1, the pixel sensor circuit 130 and the charge amplifier 150 operate as one example of the light quantity measurement portion, and the controller CPU 83 operates as one example of the control portion, respectively. Hereinafter, a description is given of a detailed example of a method for controlling the image density, that is, a method for adjusting the light quantity correction value in Embodiment 1.

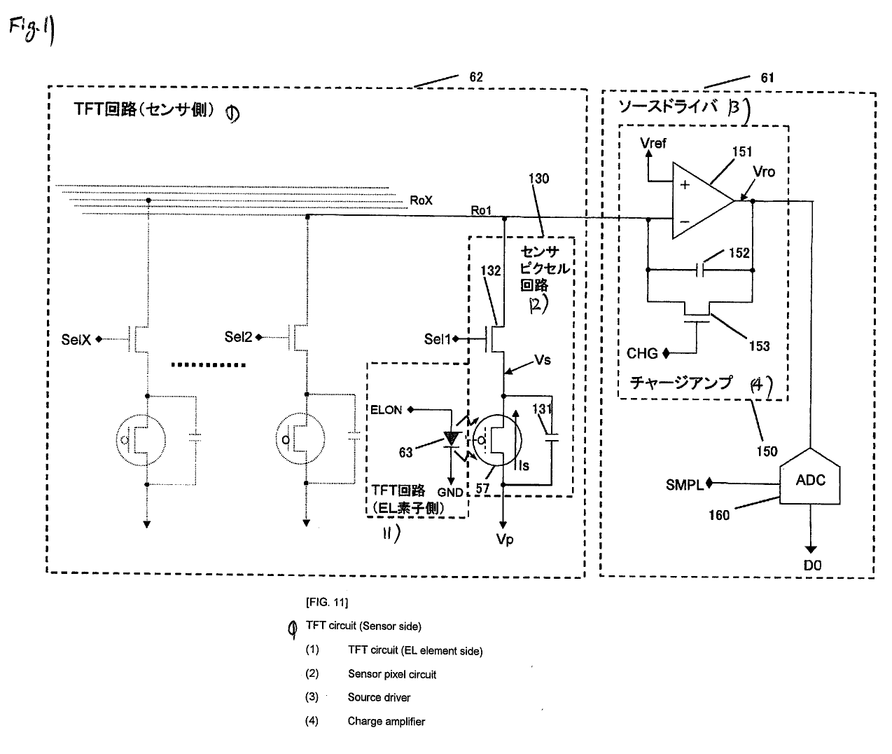

FIG. 14 is a timing chart showing the outline of the method for adjusting the light quantity correction value of an image forming apparatus according to Embodiment 1 of the present invention, wherein FIG. 14(a) shows the timing of a printing operation, FIG. 14(b) shows the timing of an operation of measuring light quantities, and FIG. 14(c) shows a change in the light quantity correction value ND.

As shown in FIG. 14, if light quantity measurement is carried out at a specified time t1 (FIG. 14(a)), the controller CPU 83 calculates the light quantity correction value ND as described using the above-described (Expression 1). Here, it is assumed that the light quantity correction data ND calculated previously, which is the light quantity correction value before the light quantity measurement at the time t1, is NDold (the second light quantity correction value), and the light quantity correction value ND calculated based on the light quantity measured at the time t1 is NDnew (the first light quantity correction value).

Herein, the controller CPU 83 controls the image density by determining the exposure conditions based on determination of the light quantity correction value ND, wherein setting the light quantity correction value ND to the light quantity correction value NDnew means setting to the exposure conditions in which the image density is brought into a predetermined range. However, if the light quantity correction value NDold is greatly deviated from the light quantity correction value NDnew (that is, in a state where the image density is greatly deviated from the predetermined range when the photosensitive body is exposed according to the conditions determined by the light quantity correction value NDold), the image densities before and after the time t1 greatly fluctuate, that is, the image density of the mth image greatly fluctuates from that of the (m+1)th image. Therefore, the controller CPU 83 stepwise varies, from the light quantity correction value NDold, the light quantity correction value ND (the third light quantity correction value) by a predetermined variation value α a plurality of times in the direction of approaching the light quantity correction value NDnew once every printing sheet after the light quantity correction value NDnew is calculated. That is, the controller CPU 83 stepwise varies in the direction, along which the image density approaches the predetermined range, a plurality of times, whereby the light quantity correction can be carried out in response to the light quantity measurement value while preventing the image density from fluctuating immediately after the light quantity is corrected.

In addition, it is, as a matter of course, possible that the predetermined variation value α is made into one step of the setting value of the source driver 61 (Refer to FIG. 7, etc.) already described, that is, the predetermined variation value α is made into the least unit of the setting resolution. In this case, the predetermined variation value α is not varied “stepwise” but is “linearly” varied. However, there is no change in that the variation is carried out a plurality of times.

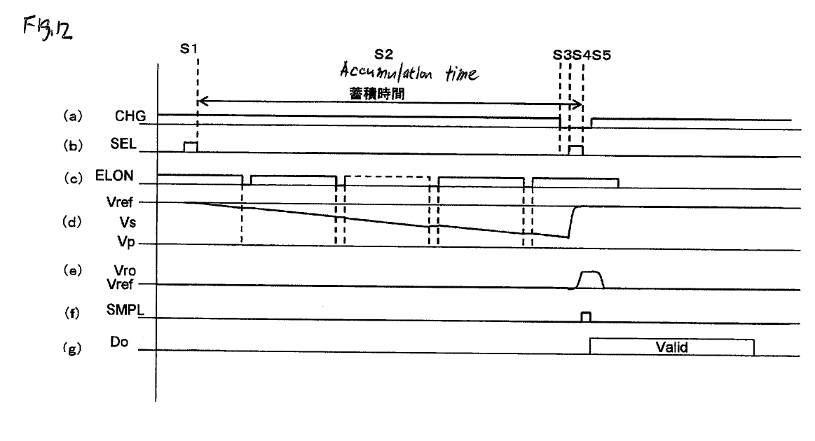

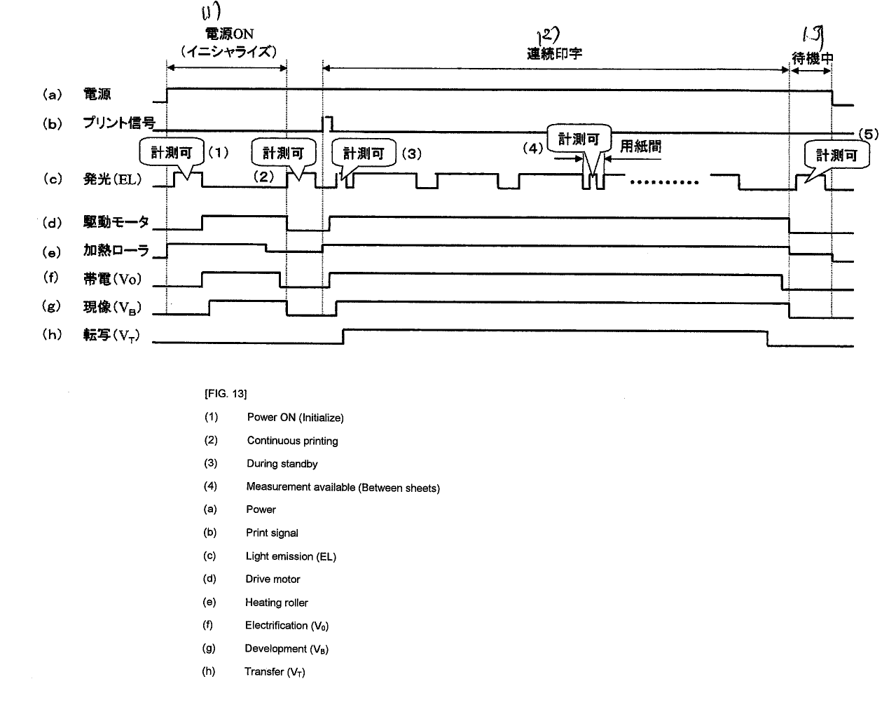

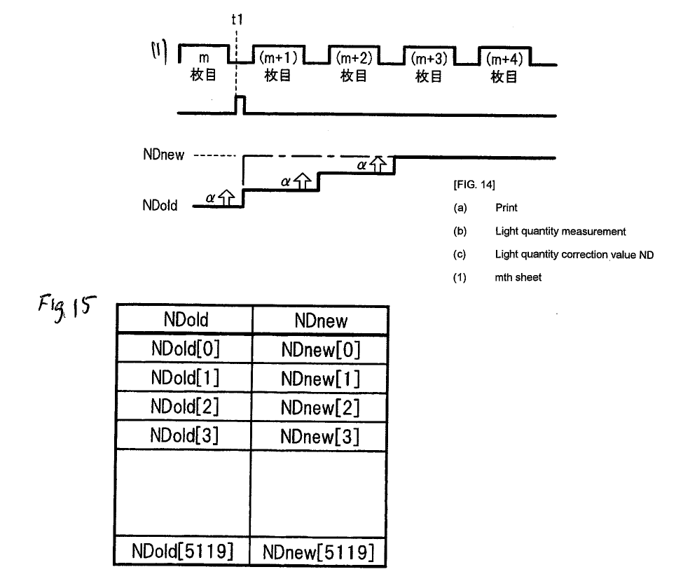

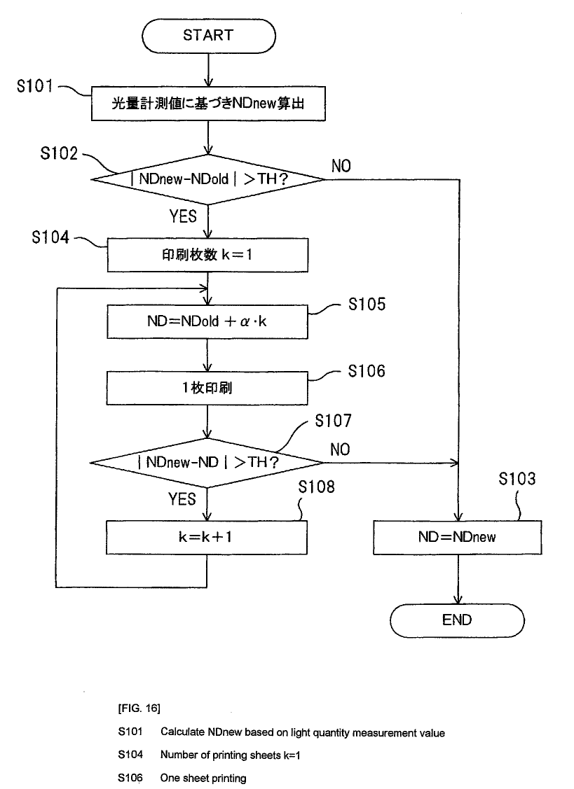

FIG. 15 is an explanatory view showing one example of the content of light quantity correction data memory of an image forming apparatus according to Embodiment 1 of the present invention, which corresponds to the light quantity correction data stored in the third area of the light quantity correction data memory 66 shown in FIG. 6.

As shown in FIG. 15, the light quantity correction value NDnew calculated based on the latest light quantity measurement value and the light quantity correction value NDold calculated previously are stored for each of a plurality of organic electroluminescent elements 63. The light quantity correction value NDnew is written by the controller CPU 83.

FIG. 16 is a flowchart describing a procedure of a method for adjusting a light quantity correction value of an image forming apparatus according to Embodiment 1 of the present invention. As shown in FIG. 16, if the light quantity measurement is carried out, the controller CPU 83 calculates the light quantity correction value NDnew based on the light quantity measurement value, and the light quantity correction value NDnew is written in the light quantity correction data memory 66 (Step S101).

And, the controller CPU 83 judges whether the absolute figure |NDnew−NDold| of a difference between the light quantity correction value NDnew and the light quantity correction value NDold is greater than a predetermined threshold value TH (Step S102). Herein, for example, the same value as the variation value α may be used as the threshold value TH.

The absolute figure |NDnew−NDold| is the threshold value TH or less (NO in Step S102), the controller CPU 83 sets the light quantity correction value ND for correcting the light quantities of the organic electroluminescent elements 63 to the light quantity correction value NDnew (Step S103). Therefore, where it is judged that the fluctuation in image density before and after correction of the light quantities is slight, the light quantity correction value ND is set to the light quantity correction value NDnew calculated based on the latest light quantity measurement value.

On the other hand, where the absolute figure |NDnew−NDold| is greater than the threshold value TH (YES in Step S102), the controller CPU 83 sets the counter of the number k of sheets to be printed after the light quantity correction is calculated, to 1 (Step S104), and the light quantity correction value ND is adjusted based on the following expression (Expression 2).

ND=NDold+α·k [Expression 2]

Also, constant α in (Expression 2) is a variation value (adjustment value) per sheet to be printed of the light correction value ND, and the absolute figure thereof is a predetermined value. Further, if NDnew>NDold, the variation value α is positive, and if NDnew<NDold, the variation value α is negative.

After that, when one sheet is printed (Step S106), the controller CPU 83 judges whether the absolute figure |NDnew−ND| of a difference between the light quantity correction value ND used for the printing and the light quantity correction value NDnew is greater than the threshold value TH (Step S107).

Where the absolute figure |NDnew−ND| is the threshold value TH or less (NO in Step S107), the controller CPU 83 causes the process to advance to Step S103, and sets the light quantity correction value ND to the light quantity correction value NDnew.

On the other hand, where the absolute figure |NDnew−ND| is greater than the threshold value TH (YES in Step S107), the controller CPU 83 adds one to the counter of the number k of sheets to be printed after the light quantity correction is calculated (Step S108). And, the process advances to Step S105, wherein the light quantity correction value ND is updated according to the above-described (Expression 2).

Thus, since the light quantity correction value ND is stepwise varied so as to approach the light quantity correction value NDnew obtained based on the light quantity measurement a plurality of times in response to advancement of a printing operation, it is possible to carry out light quantity correction in response to the light quantity measurement values while preventing the image density from fluctuating immediately after the light quantity is corrected. In addition, by carrying out the above-described variation once every printed sheet, the correction can be carried out little by little, wherein fluctuations in the image density due to variation of the light quantity correction values can be made inconspicuous.

Further, in the description of FIG. 14 through FIG. 16, a case was assumed where the timing of variation of the light quantity correction value ND is determined once every printing sheet. However, the light quantity correction value ND may be varied once every optional number of printing sheets. That is, the exposure conditions may be varied in the unit of plural pages more than 1 page, and also may be varied once every predetermined duration of time instead of by page unit. Originally, since the light quantity correction value ND can be varied in the unit of lines (raster) in image formation, the timing of variation may be based not on the page unit but on a raster unit. However, in this case, as previously described, the predetermined variation value α is made into the least setting unit (1 step) of the source driver 61. In particular, in a case where the same density regions of half tone are included in a printing sheet, it is preferable that the variation value α is determined so that the difference in the image density becomes an amount that cannot be recognized with regard to the properties in the sense of sight of a human being, for example, becomes the optical density <0.01. Thereby, it becomes possible to prevent a difference in density from appearing halfway of a printing page.

Still further, the absolute value of the variation value α (α in FIG. 14 through FIG. 16) of the light quantity correction value ND is not limited to a predetermined value but may be varied according to the conditions of printing operations, etc. For example, where continuous printing in which a plurality of pages are continuously printed is carried out, the controller CPU 83 sets the variation value α in response to the remaining number of pages to be printed, for example, so that the light quantity correction value NDnew is employed when printing the final page. It is possible to optionally set the duration of becoming a light quantity correction value responsive to the light quantity measurement value.

Still further, in FIG. 14 through FIG. 16, the light quantity correction value ND for correcting the light quantities of the organic electroluminescent elements 63 was calculated from the light quantity correction value NDold, the light quantity correction value NDnew and the variation value α by using the number k of printed sheets while counting the number k of printed sheets after start of light quantity correction. However, the calculation is not limited to this method. For example, the controller CPU 83 calculates the light quantity correction value ND by adding the variation value α to the light quantity correction value NDold in every variation of the light quantity correction value ND, and may update the light quantity correction value ND by overwriting the calculated light quantity correction value ND on the light quantity correction value NDold of the light quantity correction data memory 66. It is thereby possible to adjust the light quantity correction value ND without counting the number k of printed sheets.

Herein, even if the image densities are changed more or less where a plurality of pages are continuously printed based on different image data, it is hard for a user to recognize the change and to regard it as a problem. Also, even if the exposure conditions are changed more or less at the time of start of printing, it is also hard for a user to recognize the change in image density. That is, the time when a change in image density is most sensitively recognized is a case where there exists any object for comparison, and excepting a case where an original document exists as in duplication, the results of individual prints in a case where images based on the same image data are continuously printed correspond to such a case.

Therefore, as described with regard to FIG. 14 through FIG. 16, the controller CPU 83 stepwise (or linearly rather than stepwise in a case where a predetermined setting variation value α corresponds to one step of the setting value of the source driver 61 as described above) varies the light quantity correction value ND a plurality of times while it forms images based on the same image data over a plurality of pages. That is, the exposure conditions may be varied. Thereby, since the image density is stepwise varied toward a predetermined range a plurality of times where a fluctuation in image density is remarkable, that is, where an image based on the same image data is formed over a plurality of pages, it is possible to carry out light quantity correction without making the fluctuation in image density conspicuous.

Furthermore, the controller CPU 83 may set conditions by which the image density is brought into a predetermined range after formation of images based on the same image data is terminated. For example, when, during continuous printing, the printing is changed over from image formation based on the same image data to image formation based on different image data, and when the first page of a next job is printed after a job (that is, a series of printing operation) of forming an image based on the same image data is completed, the conditions by which the exposure conditions are brought into a predetermined range, that is, the light quantity correction value ND may be set to NDnew. Therefore, since the image density is set so as to be brought into a predetermined range when a fluctuation in image density is not conspicuous, for example, after formation of a image based on the same image data is completed, it is possible to quickly obtain a predetermined image density without making a fluctuation in image density conspicuous.

On the contrary, the controller CPU 83 may use the same exposure conditions while forming images based on the same image data over a plurality of pages. In other words, the exposure conditions will be varied page by page during continuously printing based different image data. Therefore, since variation in image density is reserved where a fluctuation in image density is conspicuous, for example, where an image based on the same image data is formed over a plurality of pages, it is possible to carry out image quantity correction without making the fluctuation in image density conspicuous.

Further, both during continuously printing based on the same image data and during continuously printing based on different image data, a variation amplitude in image density, that is, a variation value α of the light quantity correction value, which is different time by time according to a variation in the exposure conditions, may be used. For example, it is assumed that the variation value of the light quantity correction value during continuous printing based on the same image data is α1, and the variation value of the light quantity correction value during continuous printing based on different image data is α2, and α1 is smaller than α2 (that is, α1<α2). That is, the controller CPU 83 will employ, as the variation amplitude of the image density per time, a variation amplitude that is smaller where images based on the same image data are formed over a plurality of pages than where images based on different image data are formed over a plurality of pages. Therefore, since the image density is stepwise varied a plurality of times at a small variation amplitude where a fluctuation in image density is conspicuous, for example, where images based on the same image data are formed over a plurality of pages, it is possible to carry out image quantity correction without making the fluctuation in image density conspicuous.

In addition, since, when carrying out continuous printing, whether printing is based on the same image data is equivalent to whether the same page is printed, the controller CPU 83 that controls print jobs is able to easily judge the same.

However, it has been known that, in organic electroluminescent elements, the light emitting quantity is lowered due to deterioration of the light-emitting layer in line with elapse of the lighting time. It is difficult to consider that such deterioration advances to such a degree, by which the image density is varied, on the way of normal continuous printing operation (a job of printing a plurality of pages). On the other hand, it has also been known that, in the organic electroluminescent elements, the light emitting quantity changes by the environmental temperature thereof. Based thereon, where a change in the light emitting quantity of the organic electroluminescent elements 63 is measured by the sensor pixel circuit 130 and the charge amplifier 150, which are one example of the light quantity measurement portion, while an image forming apparatus is carrying out a printing job, it may be considered that the temperature of the spot where the organic electroluminescent elements 63 (or the exposure apparatus 13) are placed has changed. That is, it is possible that measurement of the light emitting quantity of the organic electroluminescent elements 63 as an exposure light source is almost equivalent to measurement of a change in the ambient temperature. Therefore, it can be considered that the controller CPU 83, which is as one example of the control portion in Embodiment 1, varies the exposure conditions at least page by page (or a plurality of times page by page) based on the results of temperature detection of the organic electroluminescent elements and the results detected before the detection (that is, a change in temperature), and controls the image density.

As has already been described, Embodiment 1 includes the following inventions.

An image forming apparatus disclosed in Embodiment 1 is an image forming apparatus having a plurality of light-emitting elements, which forms an image by exposing an image carrier, which includes: a light quantity measurement portion for measuring the light quantity of light emitted by the light-emitting elements; and a control portion for controlling the image density by determining the exposure conditions based on the measurement results and the results measured before the measurement by means of the light quantity measurement portion.

With the construction, since the exposure conditions are determined based on the measurement results of the measured light quantity and the results of the prior measurement when controlling the image density by carrying out light quantity measurement, it is possible to prevent the image density from fluctuating immediately after the light quantity is corrected.

In addition, an image forming apparatus disclosed in Embodiment 1 is an image forming apparatus having a plurality of light-emitting elements, which forms an image by exposing an image carrier, which includes: a light quantity measurement portion for measuring the light quantity of light emitted by the light-emitting elements; and a control portion for controlling the image density by varying the exposure conditions a plurality of times based on the measurement results by means of the light quantity measurement portion. Accordingly, it is possible to prevent the image density from fluctuating immediately after the light quantity is corrected.

Further, the control portion according to Embodiment 1 controls the image density by varying the exposure conditions page by page with regard to one or more pages based on the measurement results and the results of the prior measurement. With the construction, light quantity correction responsive to the results of light quantity measurement can be carried out while preventing the image density from fluctuating immediately after the light quantity is corrected.

Also, the control portion according to Embodiment 1 varies the exposure conditions stepwise in the direction along which the image density approaches a predetermined range. With the construction, light quantity correction can be carried out so that a desired image density can be obtained, while preventing the image density from fluctuating immediately after the light quantity is corrected.

Further, the control portion according to Embodiment 1 determines amplitude of fluctuation of the image density per time based on a change in the exposure conditions in response to the remaining number of pages to be printed. With the construction, it is possible to set amplitude of fluctuation so that a predetermined image density can be obtained after the remaining number of pages is printed, and to set the period until becoming a predetermined image density while preventing the image density from fluctuating immediately after the light quantity is corrected.

Still further, the control portion varies the exposure condition in the period for which images based on the same image data are formed over a plurality of pages. With the construction, since the image density is stepwise varied toward a predetermined range where a fluctuation in image density is remarkable, that is, where an image based on the same image data is formed over a plurality of pages, it is possible to carry out light quantity correction without making the fluctuation in image density conspicuous.

In addition, the control portion according to Embodiment 1 sets the exposure conditions, after formation of an image based on the same image data is completed, to conditions by which the image density is brought into the predetermined range. With the construction, since the image density is set so as to be brought into a predetermined range when a fluctuation in image density is not conspicuous, for example, after formation of a image based on the same image data is completed, it is possible to quickly obtain a predetermined image density without making a fluctuation in image density conspicuous.

Furthermore, the control portion according to Embodiment 1 uses, with respect to the amplitude of variation of the image density per time based on a variation in the exposure conditions, a smaller amplitude of variation in a case where images based on the same image data are formed over a plurality of pages than in a case where images based on different image data are formed over a plurality of pages. Therefore, since the image density is stepwise varied at a small amplitude of variation a plurality of times where a fluctuation in image density is remarkable, that is, where an image based on the same image data is formed over a plurality of pages, it is possible to carry out light quantity correction without making the fluctuation in image density conspicuous.

Also, the control portion uses the same exposure conditions while images based on the same image data are formed over a plurality of pages. Thereby, since variation in image density is reserved where a fluctuation in image density is conspicuous, for example, where an image based on the same image data is formed over a plurality of pages, it is possible to carry out image quantity correction without making the fluctuation in image density conspicuous.

Further, the control portion according to Embodiment 1 includes a light quantity correction portion for determining the exposure conditions by correcting the light quantity of light emitted by the light-emitting element with reference to the light quantity measurement value measured by the light quantity measurement portion, wherein the light quantity correction portion includes: a portion for calculating a light quantity correction value based on the light quantity measurement value; and a portion for adjusting the light quantity correction value, which outputs a third light quantity correction value to correct the light quantity of the light-emitting element, based on a first light quantity correction value calculated by the light quantity correction value calculation portion and a second light quantity correction value previously calculated. With the construction, since the light quantity correction values for correcting the light quantity of light-emitting elements are adjusted based on the light quantity correction value calculated based on the light quantity measurement value and the light quantity correction value calculated previously when carrying out light quantity correction, it becomes possible to prevent the image density from fluctuating immediately after the light quantities are corrected.

Still further, the light-emitting element is composed of an organic electroluminescent element. By using organic electroluminescent elements, both downsizing and a reduction in costs are enabled, and at the same time, an operation for correcting the light quantities, which becomes important where the organic electroluminescent elements are used as light-emitting elements, can be carried out while preventing the image density from fluctuating immediately after the light quantities are corrected.

Also, a method for controlling an image forming apparatus according to Embodiment 1 is a method having a plurality of light-emitting elements, which forms an image by exposing an image carrier, which includes the steps of: measuring the light quantity of light emitted by the light-emitting elements; and controlling the image density by determining exposure conditions based on the measurement results of the measured light quantity and the results of the prior measurement. According to this method, it is possible to prevent the image density from fluctuating immediately after the light quantities are corrected.

In addition, a method for controlling an image forming apparatus according to Embodiment 1 is a method having a plurality of light-emitting elements, which forms an image by exposing an image carrier. The method includes the steps of: measuring the light quantity of light emitted by the light-emitting elements; and controlling the image density by varying the exposure conditions a plurality of times based on the measurement results of the measured light quantity. According to this method, it is possible to prevent the image density from fluctuating immediately after the light quantities are corrected.

The methods for controlling an image forming apparatus described above can be proposed as control programs of the image forming apparatus, which execute respective steps. With the programs, since, when controlling the image density by carrying out light quantity measurement, the exposure conditions are determined based on the measurement results of the measured light quantity and the results of the prior measurement, it is possible to prevent the image density from fluctuating immediately after the light quantities are corrected.

### Embodiment 2

Hereinafter, a description is given of Embodiment 2 of the present invention, in particular, of the process of light quantity measurement.

In the following description, the constructions of the image forming apparatus, exposure apparatus, and the control portion for controlling image densities, and operations for correcting light quantities are common to those of Embodiment 1, and the description thereof is omitted.

As has already been described using FIG. 12, some accumulation time is required in order to carry out highly accurate light quantity measurement for one light-emitting element. In addition, it is necessary to cause the organic electroluminescent elements 63 to emit light for the accumulation time, wherein a printing operation cannot be simultaneously carried out. Therefore, the printing operation may be adversely influenced by timing for which a light quantity measurement operation is carried out, wherein a lowering in printing speed is brought about.

Therefore, when a print start instruction is inputted during light quantity measurement operation, the image forming apparatus 1 according to Embodiment 2 of the present invention carries out light quantity measurement, while preventing influence on the printing operation timing, by the control portion varying a procedure of an operation for measuring light quantities made by the light quantity measurement portion. Herein, in Embodiment 2, the sensor pixel circuit 130 and the charge amplifier 150 (both thereof are described in Embodiment 1, and refer to FIG. 11) operate as one example of the light quantity measurement portion, and the controller CPU 83 and the engine control CPU 91 operate as one example of the control portion, respectively.

FIG. 17 is a timing chart showing an operation of light quantity measurement of the image forming apparatus according to Embodiment 2 of the present invention, wherein FIG. 17(a) shows a power source operation, FIG. 17(b) shows an operation for inputting print signals, FIG. 17(c) shows a printing operation, and FIG. 17(d) shows timing of an operation for measuring light quantities. Also, in the example shown in FIG. 17, a description is given of an operation for measuring light quantities in the initialization process shown in (1) of FIG. 13. The description is the same for other timings.

As shown in FIG. 17, if power is inputted at time t10 (FIG. 17(a)), the engine control CPU 91 (Refer to FIG. 7) of the engine control portion 42 runs an operation for measuring light quantities at time t11 after predetermined time elapses. In detail, the engine control CPU 91 drives the sensor pixel circuit 130, the charge amplifier 150 and the organic electroluminescent elements 63 (Refer to FIG. 11), which are included in the exposure apparatus 13 (Refer to FIG. 7), and runs an operation for measuring light quantities. In addition, the period required to complete the operation for measuring light quantities is made into the period Ta necessary to complete the operation for measuring light quantities.

After that, if a print signal that is a print start instruction is inputted externally from time t11 to time t12 before elapse of the period Ta necessary to complete an operation for measuring light quantities, the engine control CPU 91 interrupts the operation for measuring light quantities (FIG. 17(d)). The engine control CPU 91 simultaneously starts rotation of the drive source 38 (Refer to FIG. 1), and starts a printing operation (FIG. 17(c)). In addition, the light quantities of the organic electroluminescent elements 63 during the printing operation are determined based on data saved before the interrupted operation for measuring light quantities, which are stored in the light quantity correction data memory 66 of the controller 41 (Refer to FIG. 5).

Herein, an external device such as a computer 80 (Refer to FIG. 5), and such a device, which is provided in the image forming apparatus 1, and into which an instruction is inputted from an instruction inputting portion for receiving an input operation of a print start instruction, such as the operation panel 98, may be listed as a mode into which a print start instruction is inputted. Herein, a so-called private print function, which is a security-intensive function, is available as one example of a case where a print start instruction is inputted by the operation panel 98. The private print function is such that, when image data are once (completely) transmitted from an external device such as the computer 80, etc., to the image forming apparatus 1 job by job, the engine control CPU 91 does not immediately run the engine of the image forming apparatus 1 even if the transmission of image data is completed, wherein the CPU 91 runs the engine of the image forming apparatus 1 by a print instruction being directly inputted by a user from the operation panel 89 of the image forming apparatus 1, thereby starting printing.

According to Embodiment 2 like this, since the operation for measuring light quantities is interrupted in response to a print start instruction, a printing operation can be immediately started when a print start instruction is inputted, wherein it is possible to measure the light quantities without influencing the timing of the printing operation.

FIG. 18 is a timing chart showing the operation for measuring light quantities of the image forming apparatus according to a modified version 1 of Embodiment 2 of the present invention, wherein FIG. 18(a) shows a power operation, FIG. 18(b) shows an operation for inputting a print signal, FIG. 18(c) shows a printing operation, FIG. 18(d) shows the timing of the operation for measuring light quantities. Also, in FIG. 18, components that overlap those in FIG. 17 are given the same reference numerals.

Also in the modified version 1 as in Embodiment 2, when power is inputted at time t10 (FIG. 18(a)), an operation for measuring light quantities is started at time t11 (FIG. 18(d)). If a print signal is inputted at time t12 (FIG. 18(d)), the operation for measuring light quantities is interrupted (FIG. 18(d)), and a printing operation is started (FIG. 18(c)).

After that, as shown in FIG. 18(c), when the printing operation is terminated, the engine control CPU 91 drives the exposure apparatus 13 at time t22, which is an option or a predetermined timing, and the operation for measuring light quantities is re-started from the interrupted part thereof. That is, the period obtained by adding the period from time t11 to time t12 to the period from time t22 to time t23 is equivalent to the period Ta necessary to complete light quantity measurement.

According to such a modified version 1 of Embodiment 2, since the operation for measuring light quantities is re-started from the interrupted part thereof after a printing operation is completed, the time required for light quantity measurement is not increased, and it is possible to carry out light quantity measurement without influencing the timing of the printing operation.

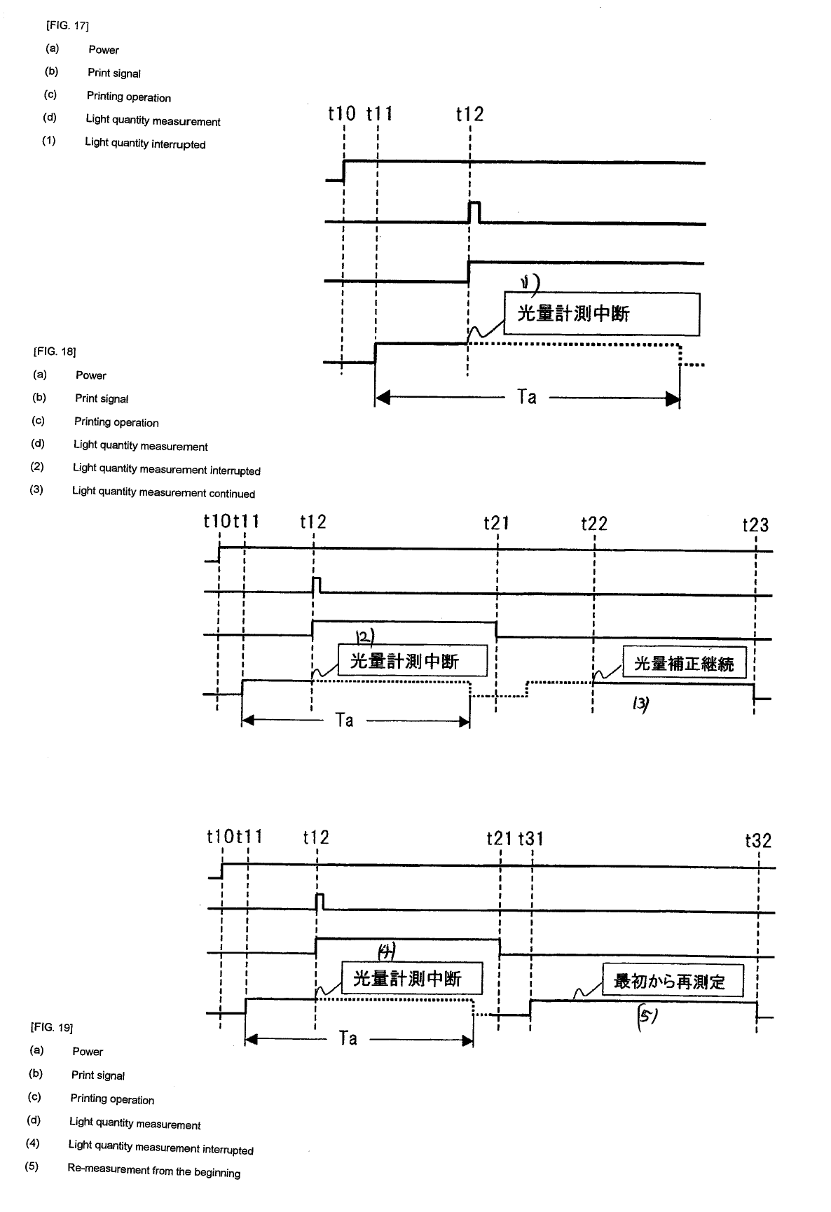

FIG. 19 is a timing chart showing an operation for measuring light quantities in the image forming apparatus according to the modified version 2 of Embodiment 2 of the present invention, wherein FIG. 19(a) shows a power operation, FIG. 19(b) shows an operation for inputting a print signal, FIG. 19(c) shows a printing operation, and FIG. 19(d) shows timing of an operation for measuring light quantities. In FIG. 19, components that overlap those of FIG. 17 and FIG. 18 are given the same reference numerals.

As in Embodiment 2 and in the modified version 2 of Embodiment 2, if the power is inputted at time t10 (FIG. 19(a)), an operation for measuring light quantities is started at time t11 (FIG. 19(d)). When a print signal is inputted at time t12 (FIG. 19(b)), the operation for measuring light quantities is interrupted (FIG. 19(d)), and a printing operation is started (FIG. 19(c)).

After that, as shown in FIG. 19(c), when the printing operation is terminated at time t21, the engine control CPU 91 drives the exposure apparatus 13 at time t31, which is an optional or a predetermined timing, and the operation for measuring light quantities is carried out from the beginning operation procedure. That is, the period from time t31 to t32 is equivalent to the period Ta necessary to complete light quantity measurement.

Where the period during which a printing operation of time t12 to time t21 is carried out is long, it is considered that a change in the environment such as a temperature occurs around the organic electroluminescent elements 63 before interruption of the operation for measuring light quantities and after re-starting thereof. Since the organic electroluminescent elements 63 will have different brightness in response to the ambient temperature, the light quantities measured in response to such a change in the environment are changed. Therefore, by executing the re-started operation for measuring light quantities from the beginning procedure, the accuracy of light quantity measurement can be improved.

According to such a modified version 2 of Embodiment 2, since the operation for measuring light quantities is started from the beginning procedure after the printing operation is completed, it is possible to accurately carry out light quantity measurement without influencing the printing operation timing.

FIG. 20 is a timing chart showing an operation for measuring light quantities in an image forming apparatus according to a modified version 3 of Embodiment 2 of the present invention, wherein FIG. 20(a) shows a power operation, FIG. 20(b) shows an operation for measuring light quantities where printing is interrupted, FIG. 20(c) shows an operation for inputting a print signal, FIG. 20(d) shows a printing operation, and FIG. 20(e) shows timing of an operation for measuring light quantities where print interruption is brought about. Also, in FIG. 20, components that overlap those of FIG. 17 are given the same reference numerals.

First, a description is given of a detailed example of the operation for measuring light quantities. A minute current (dark current) flows to the light quantity sensors 57 in the light quantity measurement portion when the organic electroluminescent elements 63 are turned off. Therefore, in order to accurately measure the light quantities, it is preferable that a lighting measurement procedure by which the light quantities are measured with the organic electroluminescent elements 63 turned on, and a light-out measurement procedure by which the light quantities are measured with the organic electroluminescent elements 63 turned off are carried out.

Further, although correction of the light quantities of the organic electroluminescent elements 63 is carried out based on the results of light quantity measurement, in view of accuracy in correction of the light quantities, it is preferable that the procedures of light quantity measurement and light quantity correction are carried out several times.

Therefore, in the examples shown in FIG. 20(a) and FIG. 20(b), a description is given of the example in which the operations for measuring and correcting the light quantities are a plurality of times (n times) when the power is inputted.

As shown in FIG. 20(a) and FIG. 20(b), if the power is inputted at time t40, the operation for measuring light quantities is started at time t41. And, after the first-time lighting measurement procedure MB(1) is carried out, the first-time light-out measurement procedure MD(1) is carried out. And, the controller CPU 83 (Refer to FIG. 4) prepares the light quantity correction data based on the results of light quantity measurement in the lighting measurement procedure MB(1) and the light-out measurement procedure MD(1).

Next, the engine control CPU 91 (Refer to FIG. 7) drives the exposure apparatus 13, and carries out the second-time lighting measurement procedure MB(2). In the second-time lighting measurement MB(2), the organic electroluminescent elements 63 is lit by the set drive current based on the light quantity correction data prepared by the results of the first-time light quantity measurement described above. Also, although it is preferable that the light-out measurement procedure MD is carried out whenever the lighting measurement procedure is carried out, as shown in FIG. 20(b), the second-time and subsequent light-out measurement procedure may be omitted. In this case, the controller CPU 83 prepares the light quantity correction data using the results of light quantities measured in the lighting measurement procedure MB and the results of light quantities measured in the first-time light-out measurement procedure MD(1).

Thus, by the nth-time lighting measurement procedure MB(n) being completed, the operation for measuring light quantities is completed at time t44. The period of time t41 through t44 corresponds to the period Ta necessary to complete light quantity measurement. The number n of times of correction may be a predetermined number of times or may be the number of times until a predetermined reference is satisfied (for example, until the light quantity measurement value of the organic electroluminescent elements 63 becomes within a predetermined value or the unevenness in the light quantity measurement value between the organic electroluminescent elements 63 becomes within a predetermined value). Also, the number of times of correction may be variable in response to the timing of light quantity measurement, for example, a plurality of times in the beginning operation shown in FIG. 13 or one time during continuous printing.

Next, with reference to FIG. 20(a), FIG. 20(c) through FIG. 20(e), a description is given of an operation where printing is interrupted during the operation for measuring light quantities described above.

If a print signal is inputted while the light-out measurement procedure MD(1) is being carried out at time t42, the engine control CPU 91 carries out an operation for measuring light quantities until the light-out measurement procedure MD(1) is completed, and interrupts the operation for measuring light quantities. That is, the engine control CPU 91 interrupts the operation for measuring light quantities after it continues the operation for measuring light quantities until time t42 without immediately interrupting the operation for measuring light quantities as shown by the arrow E in the drawing. It thereby becomes possible to correct the light quantities using the results of light quantity measurement until interruption.

In addition, the procedure of an operation for measuring light quantities, which is executed after a print signal is inputted, may be executed until the procedure carried out at the timing when a print signal is inputted is completed, or may be determined in advance. For example, it may be determined in advance that the operation for measuring light quantities is carried out without failure until the m(m<n)th time lighting measurement procedure MB or the light-out measurement procedure MD is completed.

Also, as shown by the arrow D in the drawing, the engine control CPU 91 does not start a printing operation at time t42 when a print signal is inputted, and causes a printing operation to stand by until time t43 when the operation for measuring light quantities is interrupted. Therefore, it is possible to prevent that the operation for measuring light quantities and the printing operation are actuated at an overlapping timing.

According to such a modified version 3 of Embodiment 2, since the operation for measuring light quantities is interrupted after it is executed to a predetermined procedure, it becomes possible to interrupt the operation for measuring light quantities at a desired timing, for example, in order to secure a desired number of times of light quantity correction. Accordingly, it is possible to appropriately carry out the light quantity measurement while preventing influence on the printing operation timing.

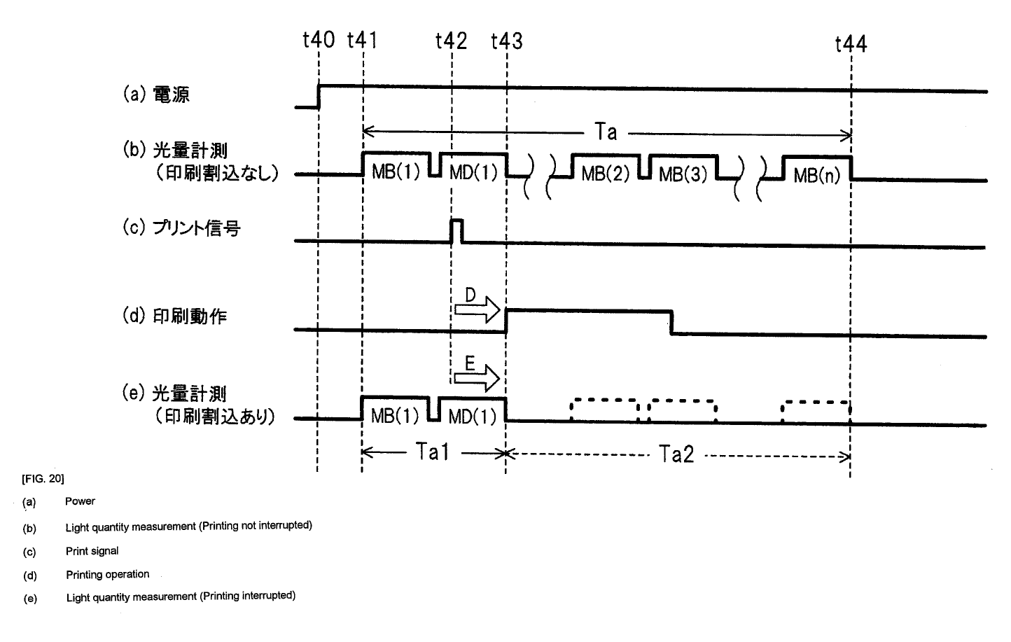

FIG. 21 is an explanatory view showing operations when the engine is run in the lighting measurement procedure in an image forming apparatus according to a modified version 4 of Embodiment 2 of the present invention. FIG. 22 is a timing chart showing the operation for measuring light quantities of an image forming apparatus according to modified version 4 of Embodiment 2. Further, FIG. 22(a) shows an operation for inputting a print signal. Also, FIG. 22(b) through FIG. 22(e) show a writing operation, an engine operation, operations of organic electroluminescent elements, and an operation for measuring light quantities when the engine is run in the lighting measurement procedure, respectively. Further, FIG. 22(f) through FIG. 22(i) show a writing operation, an engine operation, operations of organic electroluminescent elements, and an operation for measuring light quantities of an image forming apparatus according to the modified version 4 of Embodiment 2, respectively.

First, a description is given of operations when the engine is run in the lighting measurement procedure, with reference to FIG. 21 and FIG. 22(a) through FIG. 22(e).

As shown in FIG. 21, in the modified version 4 of Embodiment 2, the surface potential V_{O} (electrification potential) of the photosensitive body 8 is set to −650V, the development bias potential V_{B} for development (voltage generated between the photosensitive body 8 and the development station when an electrostatic latent image is made visible using the development agent: Potential of the development sleeve 10) is set to −250V, and the exposure potential V_{L} that is the potential of the portion of photosensitive body exposed by the exposure apparatus 13 is set to −50V. And, where light is emitted from the organic electroluminescent elements 63 in order to acquire light quantity measurement data as shown in FIG. 11, the exposure potential V_{L} is set to −50V. However, the light is only for light quantity correction, and is not the light to form images on the recording sheet 3.

However, since the exposure potential VL is set to −50V with the light, there is a possibility for an electrostatic latent image to be formed on the photosensitive body 8. In this case, a development agent is moved from the development station 2 (in further detail, the development sleeve 10 shown in FIG. 2) by a coulomb force, and it cannot be denied that the development agent (carrier and toner) is adhered onto the photosensitive body 8. Since no recording sheet 3 is supplied, the adhered development agent reaches the transfer roller 16, wherein the development agent is uselessly consumed, and at the same time, the corresponding transfer roller 16 is contaminated. The transfer roller 16 contaminated by the development agent becomes a cause of contamination of the recording sheet 3 (particularly the rear side thereof). In addition, the development agent once adhered to the rear side of the recording sheet 3 also contaminates the pressing roller 25 that constitutes the fixer 23 (Refer to FIG. 1). Therefore, it becomes a cause of trouble by which the recording sheet 3 is wound between the pressing roller 25 and the heating roller 24. Such a state becomes particularly remarkable where light quantity measurement is carried out during the continuous printing process described in FIG. 13.

This phenomenon is described below using FIG. 22. As shown in FIG. 22, if a print signal is inputted at time t50, a writing operation is started as shown in FIG. 22(b). In detail, in the controller 41 (Refer to FIG. 4), the image processing portion 86 prepares image data from the image information transmitted externally, and stores the prepared image data in the image memory 65. If the writing operation is terminated at time t51, the controller CPU 83 issues a start request to the engine control portion 42, and the engine control CPU 91 starts the engine operation by starting rotation of the drive source 38 (Refer to FIG. 1) (FIG. 22(c)). The engine operation corresponds to a printing operation.

On the other hand, as shown in FIG. 22(d), where the lighting measurement procedure MB of an operation for measuring light quantities is started at time t50, the lighting measurement procedure MB is continued until time t52 after the time Tb required for the lighting measurement procedure elapses. At this time, it is necessary that the organic electroluminescent elements 63 carry out a lighting operation ELM to carry out light quantity measurement between time t50 and time t52.

Therefore, where the period Tf of writing operation is shorter than the period Tb of lighting measurement, the lighting operation ELM is carried out during the period between time t51 and time 52 with the engine in operation as shown by diagonal lines in the drawing. That is, since the photosensitive body 8 exposed during the period from time t51 and time t52, a phenomenon occurs resulting from the exposure, by which toner is adhered onto the transfer roller as described above.

Accordingly, in the image forming apparatus according to the modified version 4 of Embodiment 2, as shown in FIG. 22(f) through FIG. 22(i), if a print signal is inputted, the engine control CPU 91 does not immediately start an engine operation at time t51 even where the period Tf of writing operation is shorter than the period Tb of lighting measurement, and causes the engine operation to stand by until time t56 after the lighting measurement procedure MB is terminated at least until the lighting measurement procedure MB is terminated (FIG. 22(g)). Therefore, since the engine stops during the lighting operation ELM to carry out light quantity measurement at the organic electroluminescent elements 63, it is possible to prevent toner from being adhered thereto.

Further, as shown in FIG. 22(c), FIG. 22(d), FIG. 22(g) and FIG. 22(h), in the image forming apparatus according to the modified version 4 of Embodiment 2, period Tr is required until the organic electroluminescent elements 63 carry out a lighting operation ELP to execute image formation since the engine operation is started. The period Tr is a period required for the recording sheet 3 to be picked up from the sheet feeding tray 4 and to be conveyed to the resist roller 19.

And, the period Tr usually becomes longer than the light-out measurement period Td required for the light-out measurement procedure MD. Therefore, as shown in FIG. 22(i), the engine control CPU 91 controls the exposure apparatus 13, and carries out the light-out measurement procedure MD until the lighting operation ELP of the organic electroluminescent elements 63 is started at the time t57 after the period Tr elapses since the engine is operated at time t56. Since the light-out measurement procedure MD is carried out with the organic electroluminescent elements 63 not lit, it is possible to carry out the light quantity measurement, effectively utilizing the period from start of the engine operation to start of the lighting operation ELP.

According to such a modified version 4 of Embodiment 2, since the engine control CPU 91 starts a printing operation after the lighting measurement procedure MB is terminated, the development agent can be prevented from being adhered to the transfer roller 16, etc. Also, since the light-out measurement procedure MD is carried out until the organic electroluminescent elements 63 are turned on in the printing operation after the printing operation is started, influence on the printing timing can be prevented from occurring, and at the same time, it is possible to carry out light quantity measurement, effectively utilizing the period until lighting of the light-emitting elements in a printing operation since the printing operation is started.

Furthermore, as have already been described using FIG. 2, the above description and subsequent description are based on the assumption that so-called two-constituent development is carried out. Even in a case of so-called one-constituent development in which the development agent is composed of only toner (in further detail, a charge controlling agent and a prescribed additive agent necessary to maintain fluidity), it is completely the same in that contamination due to toner occurs through light quantity measurement. Further, the modified version 4 of Embodiment 2 of the present invention is devised so that the development agent is prevented from being adhered to the transfer roller 16. Since, according to the modified version 4 of Embodiment 2, it becomes possible to prevent the development agent (toner) from being adhered to the photosensitive body 8 or the transfer roller 16 when carrying out light quantity measurement (that is, when not forming any image), it becomes possible to prevent the development from being uselessly consumed, the recording sheet from being contaminated, and also the recording sheet from being wound on the pressing roller 24.

Also, [light quantity measurement timing] constitutes a part of [light quantity correction timing], which is the timing for measuring the light quantities of the organic electroluminescent elements 63 before correcting the light quantities. Subsequent preparation of the light quantity correction data may be executable at an optional timing. In addition, in Embodiment 2 and its modified versions, the engine control CPU 91 of the engine control portion 42 (for both, refer to FIG. 7) controls the photosensitive body 8, electrifier 9, development station 2, and transfer roller 16, respectively, in response to the operations of respective modes of Embodiment 2 based on predetermined light quantity measurement timing shown in FIG. 13. Therefore, the engine control CPU 91 functions as a light quantity measurement control portion for controlling various types of hardware based on the light quantity measurement timing. Further, programs pertaining to various types of light quantity measurement timing as shown in FIG. 13 may be stored in the ROM 92 (Refer to FIG. 7).

As described above, Embodiment 2 includes the following inventions.

An image forming apparatus disclosed in Embodiment 2 is an image forming apparatus having a plurality of light-emitting elements, which forms an image by exposing an image carrier, which includes: a light quantity measurement portion for measuring the light quantity of light emitted by the light-emitting elements; and a control portion for controlling the image density by varying the exposure conditions a plurality of times based on the measurement results by means of the light quantity measurement portion. The control portion further controls a light quantity measurement operation for measuring the light quantity of light emitted by the light-emitting elements by means of the light quantity measurement portion, and simultaneously makes the light quantity measurement operation different after a print start instruction is inputted externally. With the construction, since a different light quantity measurement operation is employed in response to a print start instruction, it becomes possible to measure the light quantities while preventing influence on the printing operation timing.

An image forming apparatus disclosed in Embodiment 2 is an image forming apparatus having a plurality of light-emitting elements, which forms an image by exposing an image carrier, which includes: an instruction inputting portion for receiving an input operation of print start instruction; a light quantity measurement portion for measuring the light quantity of light emitted by the light-emitting elements; and a control portion for controlling the image density by varying the exposure conditions a plurality of times based on the measurement results by means of the light quantity measurement portion. The control portion further controls a light quantity measurement operation for measuring the light quantity of light emitted by the light-emitting elements by means of the light quantity measurement portion, and simultaneously makes the light quantity measurement operation different after a print start instruction is inputted from the instruction inputting portion. With the construction, since a different light quantity measurement operation is employed in response to a print start instruction inputted from the instruction inputting portion, it becomes possible to carry out light quantity measurement while preventing influence on the printing operation timing when executing private print, etc.

In addition, in Embodiment 2, it is not requisite that the control portion varies the exposure conditions a plurality of times. The exposure conditions may be varied with a one-time operation based on the light quantity measurement data obtained by the light quantity measurement operation.

Also, the image forming apparatus disclosed in Embodiment 2 is further provided with a light quantity correction portion for correcting the light quantities of light emitted from the light-emitting elements with reference to the light quantities of light measured by the light quantity measurement portion and emitted from the light-emitting elements. With the construction, it is possible to correct the light quantities of the light-emitting elements based on the results of light quantity measurement carried out while preventing influence on the printing operation timing.

Also, the control portion according to Embodiment 2 interrupts an operation for measuring light quantities when a print start instruction is inputted. With this construction, since the operation for measuring light quantities is interrupted in response to a print start instruction, a printing operation can be started immediately when the print start instruction is inputted, wherein it is possible to carry out light quantity measurement without influencing the timing of the printing operation.

In addition, the control portion according to Embodiment 2 re-starts the operation for measuring light quantities from the interrupted point after the printing operation is completed. With the construction, since the operation for measuring light quantities can be re-started from the interrupted point after the printing operation is completed, it is possible to carry out light quantity measurement without increasing the time required for light quantity measurement and influencing the timing of the printing operation.

Further, the control portion according to Embodiment 2 starts the operation for measuring light quantities from the beginning operation procedure after the printing operation is completed. With the construction, it is possible to accurately carry out light quantity measurement at all times without influencing the timing of the printing operation.

Still further, the control portion according to Embodiment 2 interrupts an operation for measuring light quantities after the procedure of the operation for measuring light quantities is executed to a predetermined level of the procedure. With the construction, since the operation for measuring light quantities can be interrupted at a predetermined timing, it is possible to appropriately carry out the light quantity measurement while preventing influence on the timing of the printing operation.

In addition, an image forming apparatus disclosed in Embodiment 2 is provided, as operation procedures for an operation for measuring light quantities, a lighting measurement procedure by which the light-emitting elements are lit and the light quantities thereof are measured, and a light-out measurement procedure by which the light-emitting elements are turned off and light quantities thereof are measured. With the construction, since the light quantities with the light-emitting elements lit and lit out are measured, further higher measurement of the light quantities can be carried out.

Also, the control portion according to Embodiment 2 interrupts the operation for measuring light quantities after the light measurement procedure is terminated. With the construction, since the light quantity measurement is carried out at least when the light-emitting elements are lit, it is possible to carry out light quantity measurement with the accuracy maintained to some degree.

Further, the control portion according to Embodiment 2 starts a printing operation after the lighting measurement procedure is terminated. With the construction, it is possible to prevent a development agent from being adhered to the transfer roller, etc., resulting from an image carrier being exposed during the lighting measurement procedure.

Still further, the control portion according to Embodiment 2 starts a light-out measurement procedure until the light-emitting elements are lit in the corresponding printing operation after the printing operation is started. With the construction, it is possible to prevent influence on the printing timing, and at the same time, to carry out light quantity measurements by effectively utilizing the period until the light-emitting elements are lit in a printing operation since start of the printing operation.

Also, the light-emitting elements according to Embodiment 2 are composed of organic electroluminescent elements. With the construction, the production costs are lowered, and it is possible to carry out an operation for correcting light quantity, which will become an important operation where the organic electroluminescent elements are used as the light-emitting elements, with influence given to the timing of the printing operation lowered.

A method for controlling the image forming apparatus according to Embodiment 2 is a method for controlling an image forming apparatus, for forming an image by exposing an image carrier, having a plurality of light-emitting elements, includes the steps of: measuring the light quantities of light emitted by the light-emitting elements; making different the action for measuring the light quantities of light emitted from the light-emitting elements after a print start instruction is inputted externally; and controlling the image density by varying the exposure conditions a plurality of times based on the measurement results of the measured light quantities. With this method, since different actions for measuring light quantities are employed in response to a print start instruction, light quantity measurement is enabled with influence on the timing of the printing operation prevented.

Also, in Embodiment 2, the step for varying the exposure conditions a plurality of times is not requisite, wherein the exposure conditions may be varied by a single operation based on the measurement data of light quantities obtained by the operation for measuring light quantities.

Also, the method for controlling an image forming apparatus described above may be provided as control programs for controlling the image forming apparatus, by which the respective steps are executed. With the programs, since different operations for measuring light quantities are employed in response to the print start instructions, it becomes possible to carry out light quantity measurement with the influence on the timing of the printing operation prevented.

### Embodiment 3

Hereinafter, a description is given of Embodiment 3 of the present invention, in particular of the processes of measuring light quantities.

In the following description, the structures of the image forming apparatus, exposure apparatus, and control portion for controlling the image density, and operations for correcting the light quantities are common to those in Embodiment 1. Therefore, the description thereof is omitted.

As has already been described using FIG. 12, it is necessary to provide an accumulation period to some degree in order to highly accurately carry out light quantity measurement for a single light-emitting element. In addition, in the accumulation period, it is necessary to cause the organic electroluminescent elements 63 to produce luminescence, wherein a normal printing operation cannot be simultaneously carried out. Therefore, the printing operation is influenced, depending on the timing for which light quantity measurement is carried out, wherein it results in a lowering in the printing rate.

Particularly, as shown at (4) in FIG. 13, where light quantity measurement is carried out in a non-printing period from termination of printing of a certain sheet to start of a next sheet in a continuous printing operation in which a plurality of sheets are continuously printed, if the time required for light quantity measurement exceeds the non-printing period, the continuous printing is interrupted, for example, by causing printing of a next sheet to stand by. This results in a lowering in productivity of printing output.

Accordingly, an image forming apparatus 1 according to Embodiment 3 is provide with a light quantity measuring portion for measuring the light quantities of light emitted by light-emitting elements, wherein the light quantity measurement portion measures the light quantity of a part of a plurality of light-emitting elements in a predetermined period such as, for example, a non-printing period. Herein, in Embodiment 3, the organic electroluminescent elements 63 operate as one example of the light-emitting elements, the sensor pixel circuit 130 and the charge amplifier 150 (both thereof were described in Embodiment 1, and refer to FIG. 11) operate as one example of the light quantity measurement portion, and the controller CPU 83 and the light quantity correction data memory 66 operate as one example of the control portion, respectively. Hereinafter, a description is given of a detailed example of the method for adjusting the light quantity correction value according to Embodiment 3.

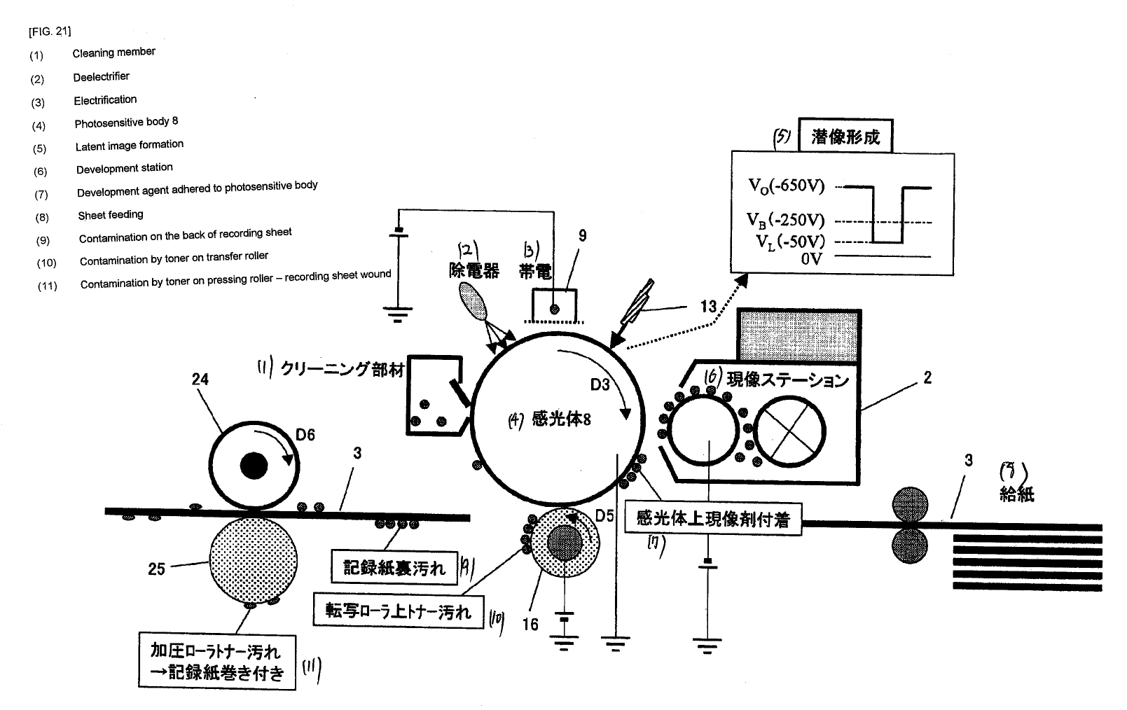

FIG. 23 is a timing chart showing the outline of a continuous printing operation of an image forming apparatus according to Embodiment 3 of the present invention, wherein FIG. 23(a) shows timing of an exposure operation (an object to be exposed, the image of which is formed) for printing by means of organic electroluminescent elements, and FIG. 23(b) shows timing of an exposure operation for measuring light quantities, respectively.

As shown in FIG. 23(a), in a continuous printing operation in which a plurality of sheets are continuously printed, printing period T1 in which a single recording sheet is printed, and non-printing period T2 from termination of printing of a certain sheet to start of a next sheet are repeated. In this example, the printing period T1 is a period (period for exposure to form an image) for exposure made by the organic electroluminescent elements 63 to form an image on the recording sheet 3. In other words, when the organic electroluminescent elements 63 emit light in the printing period T1, an image is formed on the recording sheet 3.

And, it is necessary that an exposure operation for measuring light quantities is carried out at timing different from the exposure operation for printing. That is, since it is necessary for the exposure operation for measuring light quantities to be carried out in the period excepting at least the printing period T1 (period for exposure to form an image), as shown in FIG. 23(b), the organic electroluminescent elements 63 are lit in the non-printing period T2. Also, the light quantity measurement is carried out sheet by sheet or may be carried out by a group consisting of a predetermined number of sheets.

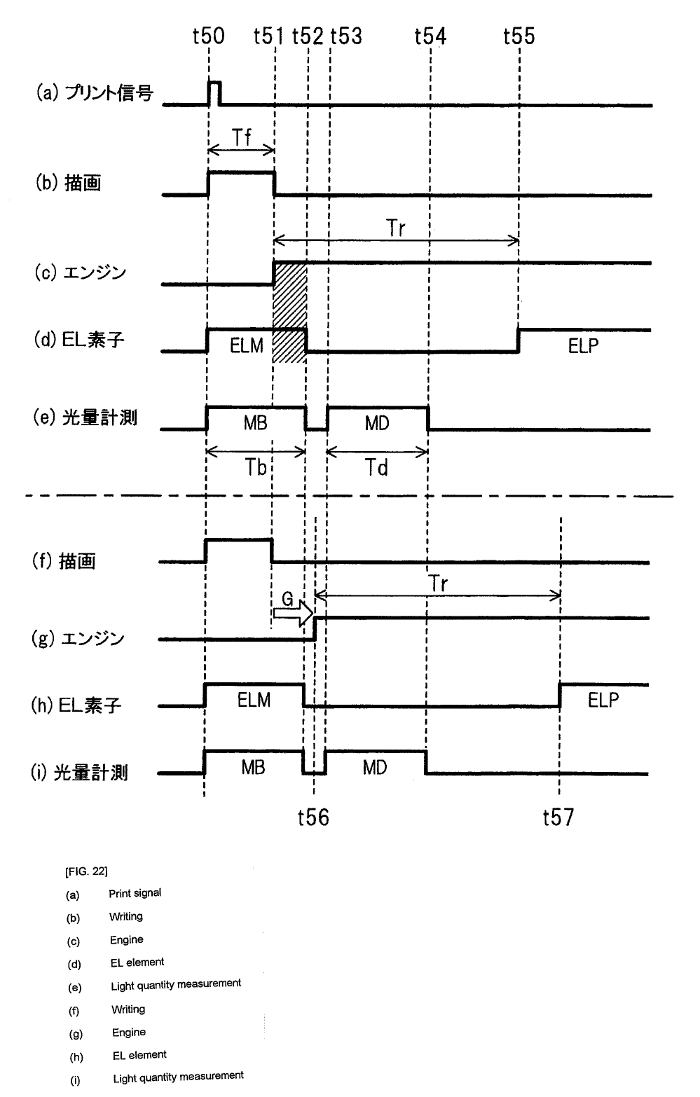

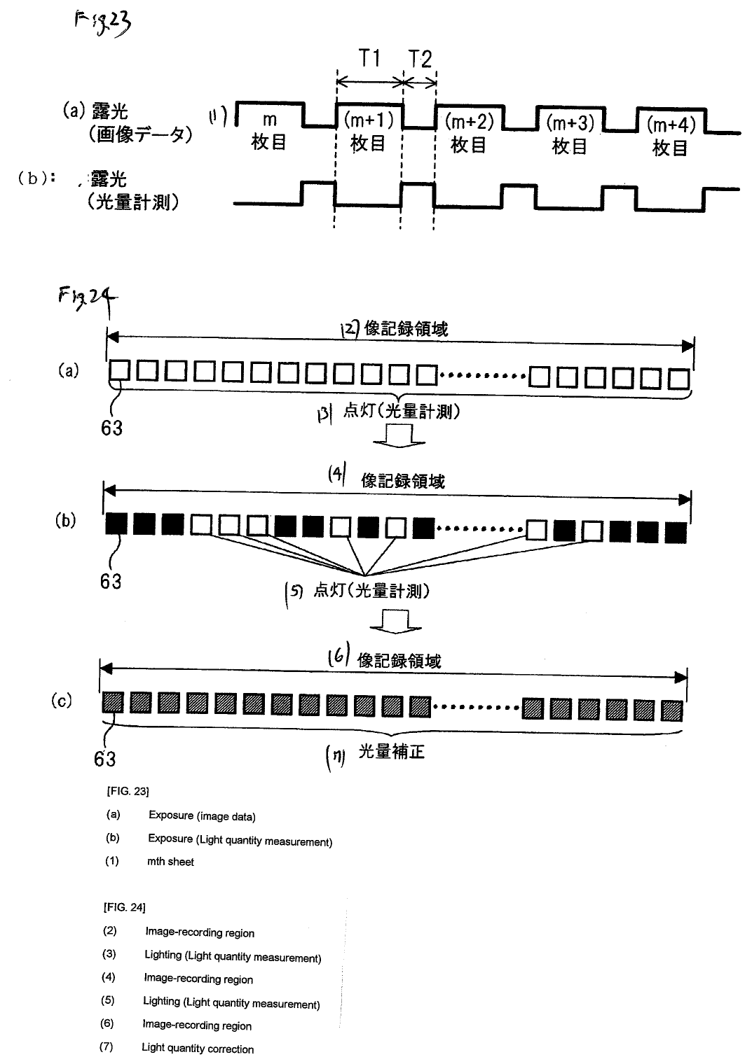

FIG. 24 is an explanatory view showing a method for correcting light quantities when the image forming apparatus according to Embodiment 3 of the present invention is in a continuous printing operation. First, as shown in FIG. 24(a), the engine control CPU 91 carries out light quantity measurement of the organic electroluminescent elements 63 disposed in an image recording region, that is, all the organic electroluminescent elements 63 pertaining to a recording operation. The controller CPU 83 calculates the light quantity correction value ND (First light quantity correction value) corresponding to the respective organic electroluminescent elements 63 as described using the above-described (Expression 1). The calculated light quantity correction value ND is stored in the third area of the light quantity correction data memory 66 as shown in FIG. 6. A description is given of the timing for which light quantity measurement is carried out for all the organic electroluminescent elements 63, with reference to FIG. 25.

FIG. 25 is a timing chart showing an example of timing for light quantity measurement with regard to all the elements of the image forming apparatus according to Embodiment 3 of the present invention, wherein FIG. 25(a) shows a print signal input timing, FIG. 25(b) shows timing of the printing operation, and FIG. 25(c) shows timing of operations for measuring light quantities of all the organic electroluminescent elements 63. As shown in FIG. 25(c), as the timing of operations for measuring light quantities of all the organic electroluminescent elements 63, timing (Period T11) of print start until printing is actually started since a print signal to instruct print start is inputted, a predetermined period (Period T12) after completion of the printing operation may be listed.

If a print signal is inputted in the period T 11 of print start, the controller 41 (Refer to FIG. 4) carries out a writing operation by which the image processing portion 86 prepares image data based on the image information transmitted externally and an operation of picking up the recording sheet 3 from the sheet feeding tray 4 and conveying the same to the resist roller 19.

Therefore, the image forming apparatus 1 carries out operations for measuring light quantities of all the organic electroluminescent elements 63, and can update the light quantity correction value ND used for correction of light quantities in continuous printing whenever printing is started, wherein it is possible to improve the accuracy of light quantity correction when continuous printing is carried out.

Further, depending on an operation continuously carried out after the printing is completed, it is possible to secure a sufficient period to carry out light quantity measurement of all the organic electroluminescent elements 63 with respect to the period T12 after completion of printing. Therefore, since the image forming apparatus 1 carries out operations for measuring light quantities of all the organic electroluminescent elements 63 by utilizing the period T12, it becomes possible to update the light quantity correction value ND used for light quantity correction in continuous printing whenever the printing operation is carried out, wherein it is possible to improve the accuracy in light quantity correction in continuous printing.

Also, other than the periods T11 and T12, the image forming apparatus 1 may measure the light quantities of all the organic electroluminescent elements 63 when an instruction for measuring light quantities is inputted by the computer 80 shown in FIG. 5 and externally such as the operation panel 98 shown in FIG. 7. Thereby, it becomes possible to update, at a predetermined timing, the light quantity correction value ND used for correction of light quantities in continuous printing, wherein it is possible to improve the accuracy in light quantity correction in continuous printing.

Now, returning to FIG. 24, the description is continued. When continuous printing operation is carried out, the engine control CPU 91 carries out light quantity measurement for a part of the organic electroluminescent elements 63 located in the image recording region in the non-printing period T2 shown in FIG. 23 as shown in FIG. 24(b). In addition, the [part of] the organic electroluminescent elements 63 may be designated in advance or may be varied in respective measurements of light quantities.

And, the controller CPU 83 calculates the light quantity correction value NDb (the second light quantity correction value) for the organic electroluminescent elements 63 for which light quantity measurement has been carried out in the period T12. After that, the controller CPU 83 calculates the light quantity correction value NDc of all the organic electroluminescent elements 63 located in the image recording region, as shown in FIG. 24(c), based on the light quantity correction value ND stored in the third area of the light quantity correction data memory 66 and the calculated light quantity correction value NDb. And, the quantities of light emitted by the respective organic electroluminescent elements 63 are corrected based on the light quantity correction value NDc.

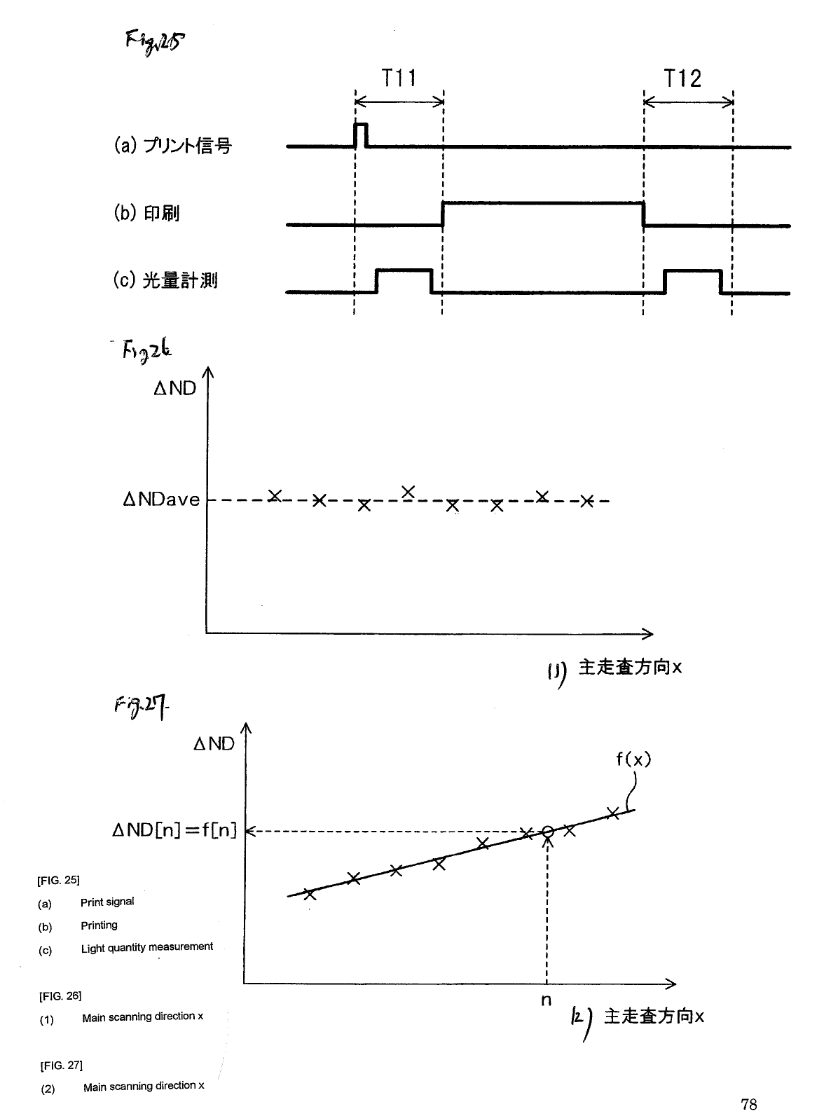

Next, a description is given of the method for calculating the light quantity correction value NDc with reference to FIG. 26 and FIG. 27.

FIG. 26 is an explanatory view showing the first example of the method for calculating the light quantity correction value when the image forming apparatus according to Embodiment 3 of the present invention is in continuous printing operation. First, the controller CPU 83 calculates a difference value ANDc between the calculated light quantity correction value NDb and the light quantity correction value ND stored in the light quantity correction data memory 66. In detail, where it is assumed that the element number of the organic electroluminescent element 63 for which light quantity measurement was carried out in the period T12 is M, difference value ΔND[M]=NDb[M]−ND[M] is calculated. Thereafter, the average value ΔNdave of all the difference values ΔND[M] is calculated.

And, the light quantity correction values NDc regarding the respective organic electroluminescent elements 63 can be calculated by NDc[n]=ND[n]+ΔNdave (n is an element number of the organic electroluminescent elements 63 in the main scanning direction). Thereby, it is possible to obtain the light quantity correction values NDc regarding all the organic electroluminescent elements 63 by an estimation based on the light quantity measurement value pertaining to a part of the organic electroluminescent elements 63.

FIG. 27 is an explanatory view showing the second example of the method for calculating a light quantity correction value when the image forming apparatus according to Embodiment 3 of the present invention is in continuous printing operation. In the image forming apparatus 1, there may be cases where the ambient temperature differs, depending on the positional relationship between the exposure apparatus 13, air suction port and air exhaust port, and depending upon the position of the organic electroluminescent elements 63 arrayed and provided in the main scanning direction.

Here, as described above, the light emission brightness of the organic electroluminescent elements 63 is dependent on temperature. Therefore, where the temperature in the image forming apparatus 1 rises (changes) as in continuous printing, there may be cases where the tendency responsive to the temperature distribution becomes remarkable with respect to the position in the arraying direction in the light quantity correction value ND that has a correlation with the brightness of the organic electroluminescent elements 63. In this second example, utilizing such a tendency, the controller CPU 83 calculates the light quantity correction values NDc for all the organic electroluminescent elements 63 based on the results of light quantity measurement of a part of the organic electroluminescent elements 63.

First, the controller CPU 83 calculates a difference value ΔNDc[M] described in FIG. 26. After that, an approximation expression f(x) showing the relationship between ΔNDc[M] and the position x of the organic electroluminescent elements 63 in the main scanning direction is obtained using a least square method based on all the ΔNDc[M]. Also, where the organic electroluminescent elements 63 are equidistantly disposed in the main scanning direction, it is possible that element number n of the organic electroluminescent elements 63 in the main scanning direction is used at the position x in the main scanning direction. In Embodiment 3, a description is given of a case where the element number n is used. That is, the difference value ΔND[n] regarding the element number n is calculated by ΔND[n]=f[n]. And, the light quantity correction value NDc regarding the respective organic electroluminescent elements 63 can be calculated by NDc[n]=ND[n]+ΔND[n]. Thereby, the light quantity correction value NDc regarding all the organic electroluminescent elements 63 can be estimated and obtained with the temperature characteristics taken into account, based on the light quantity measurement value for a part of the organic electroluminescent elements 63.

Also, in the above-described example, a description was given of the case where the operation for measuring light quantities of a part of the organic electroluminescent elements 63 is carried out in the non-printing period when the continuous printing operation is operated. However, this is not limited to only the continuous printing operation but may be carried out in a predetermined non-printing period and another predetermined period. In addition, the non-printing period is at least a period excepting the period during which an image is formed on the recording sheet 3 by luminescence of the organic electroluminescent elements 63. For example, the non-printing period is not sufficient to carry out an operation for measuring light quantities regarding all the organic electroluminescent elements 63, wherein a non-printing period for which light quantity correction is desired is designated.

Based on the above description, with the image forming apparatus according to Embodiment 3, since the light quantities of all the light-emitting elements to form an image are not measured in a predetermined period such as a period defined in advance, and the light quantities of a part thereof are measured, it becomes possible to measure the light quantities while preventing influence on the timing of the printing operation.

As described above, Embodiment 3 has the following inventions.

An image forming apparatus disclosed in Embodiment 3, which has a plurality of light-emitting elements, and forms an image by exposing an image carrier, includes: a light quantity measurement portion for measuring the light quantity of light emitted by the light-emitting elements; and a control portion for controlling the image density by varying the exposure conditions a plurality of times based on the measurement results by means of the light quantity measurement portion, wherein the light quantity measurement portion is devised so as to measure the light quantities of a part of light-emitting elements of a plurality of light-emitting elements in a predetermined period defined in advance. With the construction, since the light quantities of all the light-emitting elements to form an image are not measured in a predetermined period defined in advance, and the light quantities of only a part thereof are measured, it becomes possible to measure the light quantities while preventing influence on the timing of the printing operation.

In addition, in Embodiment 3, it is not requisite that the control portion varies the exposure conditions a plurality of times, wherein the exposure conditions may be varied by one time based on the light quantity measurement data obtained by an operation for measuring light quantities.

The light quantity measurement portion in Embodiment 3 has a plurality of light-detecting elements for detecting the light quantities of each of a plurality of light-emitting elements. With the construction, since the light quantity measurement portion measures the light quantities of a part of light-emitting elements in a predetermined period defined in advance when it has a plurality of light-detecting elements for detecting the light quantities corresponding to each of a plurality of light-emitting elements, it becomes possible to measure the light quantities while preventing influence on the timing of the printing operation.

Further, in the image forming apparatus according to Embodiment 3, the above-described predetermined period is made into a non-printing period in the image forming apparatus. With the construction, since the light quantities of a part of light-emitting element are measured in a predetermined non-printing period, it becomes possible to measure the light quantities while preventing influence on the timing of the printing operation.

Still further, in the image forming apparatus according to Embodiment 3, the above-described non-printing period is a period excluding at least the period required for exposure to form an image, and the period required for exposure to form an image is a period during which an image is formed on the recording sheet if the light-emitting elements produce luminescence in the corresponding period required for exposure to form an image. With the construction, since the light quantities of a part of light-emitting elements are measured in at least the period during which no image is formed on the recording sheet even if the light-emitting elements are caused to produce luminescence, it becomes possible to measure the light quantities while preventing influence on the timing of the printing operation.

Also, the light quantity measurement portion according to Embodiment 3 measures the light quantities of a part of light-emitting elements in a non-printing period from termination of printing of a certain sheet to start of printing of a next sheet in continuous printing operation in which a plurality of sheets are continuously printed. With the construction, since the light quantities of a part of light-emitting elements are measured in the continuous printing operation, there is no need to interrupt the continuous printing operation, wherein it is possible to prevent the productivity of printing output from being lowered.

In addition, the image forming apparatus according to Embodiment 3 is further provided with a light quantity correction portion for correcting the quantities of light that the light-emitting element emits, by referencing the light quantity measurement value measured by the light quantity measurement portion. With the construction, since the quantities of light that the light-emitting element emits are corrected by referencing the light quantity measurement value measured by the light quantity measurement portion, it becomes possible to measure the light quantities while preventing influence on the timing of the printing operation.

Also, the light quantity correction portion according to Embodiment 3 corrects the quantities of light emitted from all the light-emitting elements based on the light quantity measurement values of a part of light-emitting elements measured. With the construction, since the light quantities of all the light-emitting elements are corrected based on the light quantity measurement value of a part of light-emitting elements measured by the light quantity measurement portion, it becomes possible to correct the light quantities regarding all the light-emitting elements while preventing influence on the timing of the printing operation.

In addition, the light quantity correction portion according to Embodiment 3 calculates in advance the first light quantity correction value based on the light quantity measurement values measured for all the light-emitting elements and holds the same, calculates the second light quantity correction value for a part of the light-emitting elements when the light quantities of the corresponding part of the light-emitting elements are measured by the light quantity measurement portion, and corrects the quantities of light emitted by all the light-emitting elements based on the first light quantity correction value and the second light quantity correction value. With the construction, since the light quantities of all the light-emitting elements are corrected based on the light quantity correction value calculated on the quantities of light measured for a part of light-emitting elements and the light quantity correction value calculated in advance, it is sufficient that only a part of light-emitting elements is measured for the light quantities during a continuous printing operation, wherein it is possible to prevent the productivity in printing output from being lowered without interrupting the continuous printing operation.

In addition, the light quantity measurement portion is devised so as to measure the light quantities with respect to all the light-emitting elements when printing is completed. With the construction, since the light quantities are measured for all the light-emitting elements when printing is completed, it becomes possible to update the first light quantity correction value used for light quantity correction in a continuous printing operation in each of the printing operations, wherein it is possible to improve the accuracy of light quantity correction in the continuous printing operation.

Further, the light quantity measurement portion according to Embodiment 3 measures the light quantities of all the light-emitting elements when printing is started. With the construction, since the light quantity measurement is carried out for all the light-emitting elements when printing is started, it becomes possible to update the first light quantity correction value used for correction of the light quantities when continuous printing is executed, whenever printing is started, wherein it is possible to improve the accuracy of light quantity correction when continuous printing is carried out.

Still further, the light quantity measurement portion according to Embodiment 3 measures the light quantities of all the light-emitting elements when an instruction for light quantity measurement is inputted. With the construction, since the light quantities of all the light-emitting elements are measured when an instruction for light quantity measurement is inputted externally, it becomes possible to update the first light quantity correction value used for light quantity correction in continuous printing at a desired timing, and it is possible to improve the accuracy of light quantity correction when continuous printing is carried out.

In the image forming apparatus disclosed in Embodiment 3, the light-emitting elements are composed of organic electroluminescent elements. With the construction, the apparatus can be downsized and the production costs thereof can be lowered by employing the organic electroluminescent elements, and at the same time, an operation for correcting the light quantities that becomes an important operation where the organic electroluminescent elements are used as light-emitting element can be carried out while lowering the influence given to the timing of the printing operation.

The method for controlling the image forming apparatus according to Embodiment 3 is a method for controlling an image forming apparatus having a plurality of light-emitting elements, which forms an image by exposing an image carrier, which includes the steps of: measuring the light quantity of light emitted by the light-emitting elements; and controlling the image density by varying the exposure conditions a plurality of times based on the measurement results of the measured light quantity, wherein the light quantity measuring step is devised so as to measure the light quantities of a part of light-emitting elements of a plurality of light-emitting elements in a predetermined period defined in advance. With the method, since the light quantities of all the light-emitting elements to form an image are not measured in a predetermined period defined in advance, but only the light quantities of a part thereof are measured, light quantity measurement is enabled, in which influence on the timing of the printing operation is prevented.

Also, the step of varying the exposure conditions a plurality of times is not requisite in Embodiment 3. The exposure conditions may be varied by a single operation based on the light quantity measurement data obtained by an operation for measuring light quantities.

Further, the above-described method for controlling an image forming apparatus may be provided as programs for controlling the image forming apparatus, by which respective steps are carried out. With the programs, the light quantities are not measured for all the light-emitting elements to form an image in a predetermined period defined in advance, but only the light quantities of a part thereof are measured. Therefore, light quantity measurement is enabled, in which influence on the timing of the printing operation is prevented.

### Embodiment 4

Hereinafter, a description is given of Embodiment 4 of the present invention, in particular of the process for light quantity measurement.

In the following description, the structures of the image forming apparatus, exposure apparatus, and control portion for controlling the image density, and operations for correcting the light quantities are common to those in Embodiment 1. Therefore, the description thereof is omitted.

As has already been described using FIG. 12, it is necessary to provide an accumulation period to some degree in order to highly accurately carry out light quantity measurement for a single light-emitting element. In addition, in the accumulation period, it is necessary to cause the organic electroluminescent elements 63 to emit light, wherein a normal printing operation cannot be simultaneously carried out. Therefore, the printing operation is influenced, depending on the timing for which light quantity measurement is carried out, wherein it results in a lowering in the printing rate.

The image forming apparatus according to Embodiment 4 is provided with a toner image detection sensor 32 as shown in FIG. 1, and detects the image density of an image transferred onto the recording sheet 3 and the position where the image is formed. For example, the image forming apparatus 1 forms a toner image of a predetermined test pattern on the recording sheet 3. And, the controller 41 shown in FIG. 5 corrects parameters for image correction in the image processing portion 86 based on the results of detection by the toner image detection sensor 32. Thereby, by correcting the image forming operation based on the toner image transferred onto the recording sheet, it is possible to improve the quality of images.

Therefore, the image forming apparatus 1 according to Embodiment 4 carries out light quantity measurement utilizing the exposure period to print the test pattern page. That is, the image forming apparatus 1 according to Embodiment 4 is provided with a light quantity measurement portion for measuring the light quantities of light emitted by light-emitting elements, and a light quantity correction portion for correcting the light quantities of light emitted by the light-emitting elements with reference to the light quantity measurement value measured by the light quantity measurement portion, wherein the light quantity measurement portion measures the light quantities of the light-emitting elements in the exposure period for printing a test pattern page. Herein, in Embodiment 4, the organic electroluminescent elements 63 operate as one example of the light-emitting elements, the sensor pixel circuit 130 and the charge amplifier 150 (both thereof were described in Embodiment 1, and refer to FIG. 11) operate as one example of the light quantity measurement portion, and the controller. CPU 83 and the light quantity correction data memory 66 operate as one example of the control portion, respectively.

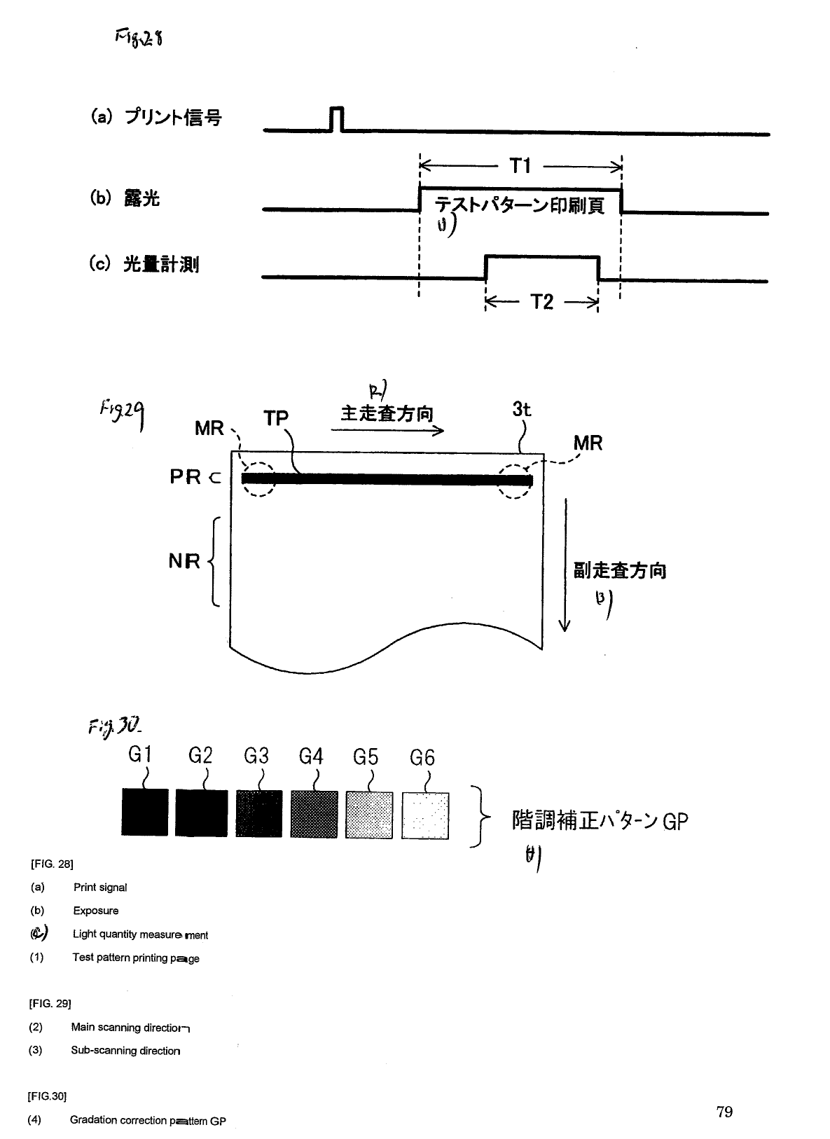

FIG. 28 is a timing chart showing one example of an operation for measuring light quantities in an image forming apparatus according to Embodiment 4 of the present invention, wherein FIG. 28(a) shows print signal inputting timing for printing a test pattern, FIG. 28(b) shows timing of a test pattern printing operation, and FIG. 28(c) shows timing of an operation for measuring light quantities of the organic electroluminescent elements 63, respectively.

When an instruction for printing a test pattern is inputted by the computer 80 shown in FIG. 5 and externally such as the operation panel 98 shown in FIG. 7, the controller CPU 83 of the controller 41 controls an operation to prepare image data for the test pattern. The image processing portion 86 prepares image data for the test pattern based on control made by the controller CPU 83 and stores the prepared image data in the image memory 65. After that, the procedure similar to those of a normal image forming operation is carried out, and as shown in FIG. 28(b), an exposure operation equivalent to one page, by which the test pattern is printed, is carried out in the period T1.

And, as shown in FIG. 28(c), the engine control CPU 91 carries out an operation for measuring light quantities in the period T2 included in the exposure period T1 equivalent to one page to print the test pattern. Thereby, since the light quantities of the light-emitting elements are measured in the period to print a test pattern page, it becomes possible to carry out light quantity measurement while preventing influence on the timing of a normal printing operation.

Herein, the light quantity measurement period T2 may be set in a part of the exposure period T1 in response to the types and conditions of a test pattern to be formed or may be set in the entirety of the exposure period T1.

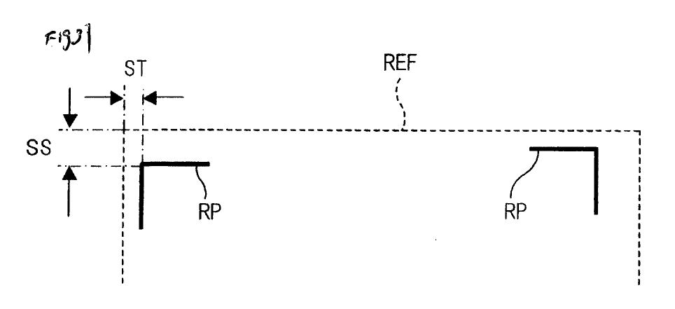

FIG. 29 is an explanatory view showing one example of test pattern printing page, which is printed by an image forming apparatus according to Embodiment 4 of the present invention. As shown in FIG. 29, a test pattern TP is formed on the recording sheet 3t. Also, regions MR located at both ends in the main scanning direction of the test pattern are regions to be detected by the toner image detection sensor 32.

A period to print on the region PR shown in FIG. 29 may be listed as one example of the above-described light quantity measurement period T2. The region PR is a region where the test pattern TP is printed on the recording sheet 3t. That is, as shown in FIG. 29, where a line-like test pattern TP is formed in the main scanning direction, it is possible to measure the light quantities of light emitted by the organic electroluminescent elements 63 when forming an image of the test pattern PT in the main scanning direction. This can be said in other words, that is, the test pattern TP is formed using exposure light when the light quantities of light emitted by the organic electroluminescent elements 63 are measured by the light quantity measurement portion (the sensor pixel circuit 130 and the charge amplifier 150). Thereby, it is possible to carry out light quantity measurement by effectively utilizing the time during which the organic electroluminescent elements 63 forms an image of the test pattern TP.

Also, a period to print on the region NR shown in FIG. 29 may be listed as another example of the light quantity measurement period T2. There are many cases where the test pattern TP is such that it is not printed on the entire surface of the recording sheet 3t. For example, the region NR shown in FIG. 29 is a region where nothing is printed, that is, a region (a region where at least the test pattern TP is not printed, hereinafter called a permitted region) where it is permitted that a toner image formed by an exposure operation for measuring light quantities is transferred. Thus, if a permitted region such as the region NR exists in a part of a page in which the test pattern TP is printed, it is possible to set the exposure timing, on which a toner image is transferred on the permitted region on the recording sheet 3, in the light quantity measurement period T2. And, the controller CPU 83 causes the organic electroluminescent elements 63 to be lit for light quantity measurement in the period T2, and the light quantity measurement is carried out.

That is, in the exposure period to print a page of the test pattern TP, the controller CPU 83 can carry out light quantity measurement by effectively utilizing the organic electroluminescent elements 63 that do not make any lighting operation to form an image for the test pattern TP, that is, the period of time during which the organic electroluminescent elements 63 suspend lighting to form an image by carrying out light quantity measurement when an image of the test pattern TP is not formed.

And, if the permitted region has a length covering the entirety of an image-forming region in the main scanning direction and a length of line equivalent to raster time, for which light quantity measurement is carried out, in the sub-scanning direction, light quantity measurement can be carried out with respect to all the organic electroluminescent elements 63.

As an example of the above-described test pattern, a gradation correction pattern to correct the gradation (grayscale), a density correction pattern to correct the density, and a resist correction pattern to correct positional errors may be listed.

First, a description is given of the gradation correction pattern.

FIG. 30 is an explanatory view showing a gradation correction pattern in an image forming apparatus according to Embodiment 4 of the present invention. As shown in FIG. 30, the gradation correction pattern GP is such that toner images G1 through G6 of a plurality of gradations different from each other are transferred onto the recording sheet 3. Thereby, the controller CPU 83 corrects the gradation based on the results of detection regarding the respective gradations, which are detected by the toner image detection sensor 32.

Next, a description is given of the density correction pattern. The density correction pattern is such that, for example, a toner image of the maximum density, which has a predetermined pattern, is transferred onto the recording sheet 3. Thereby, the controller CPU 83 corrects the density based on the results of detection regarding the maximum density pattern, which are detected by the toner image detection sensor 32.

Next, a description is given of the resist correction pattern.

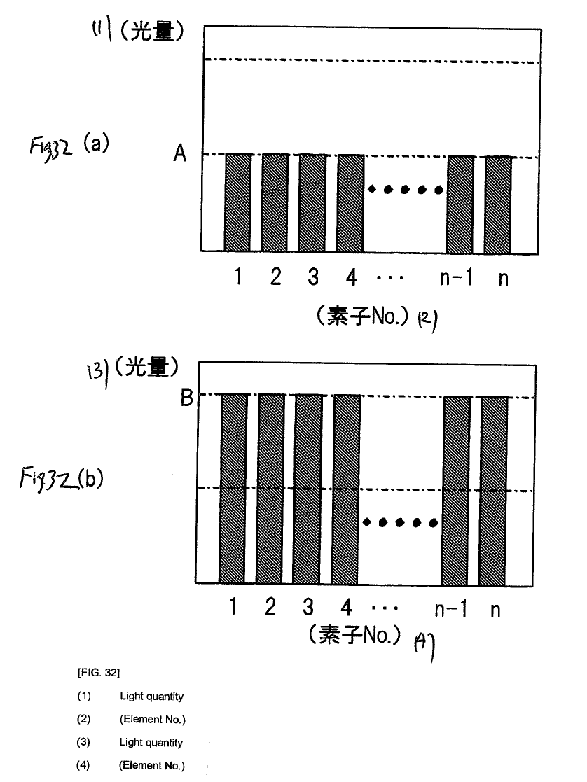

FIG. 31 is an explanatory view showing the resist correction pattern in an image forming apparatus according to Embodiment 4 of the present invention.

As shown in FIG. 31, the resist correction pattern RP is such that a toner image having a predetermined shape is transferred on the recording sheet 3 at predetermined positions in both the main scanning direction and the sub-scanning direction. Thereby, based on the resist correction pattern RP detected by the toner image detection sensor 32, the controller CPU 83 obtains a top error ST that is an error deviated from the reference position REF in the main scanning direction and a side error SS that is an error deviated therefrom in the sub-scanning direction, and corrects the positional errors.

Next, a description is given of a case where the light quantity correction is calculated. Where the light quantities for the organic electroluminescent elements 63 to be in an exposure operation for the above-described test pattern are measured, the light quantities are different from those obtained by a normal operation for measuring the light quantities.

However, since an operation for forming an image of a test pattern is an operation for forming an image of a predetermined pattern, the operation for lighting the organic electroluminescent elements 63 becomes a predetermined formation operation. For example, in the above-described gradation correction pattern, such a lighting operation is carried out as predetermined organic electroluminescent elements 63 are brought into a predetermined gradation. Therefore, the controller CPU 83 can calculate the light quantity correction value ND while taking into consideration how much the light quantities emitted by the respective organic electroluminescent elements 63 differ from the light quantities obtained by a normal operation for measuring light quantities.

Also, the test pattern is not necessarily carried out by using all the pixels in the main scanning direction. That is, since, with regard to an exposure operation for printing a test pattern, all the organic electroluminescent elements 63 are not necessarily lit, there are cases where it is not possible to obtain the results of light quantity measurement of all the organic electroluminescent elements 63 where the light quantities are measured when forming an image of a test pattern.

In the case, for example, with respect to the organic electroluminescent elements 63 for which light quantity measurement has been carried out, a difference value between the calculated light quantity correction value and the light quantity correction value stored in the light quantity correction data memory 66 (Refer to FIG. 6) is calculated. Based on the difference value, the light quantity correction value ND is calculated for all the organic electroluminescent elements 63.

Based on the above description, according to Embodiment 4, since the light quantities of light-emitting elements are measured when forming an image of a test pattern, it becomes possible to carry out light quantity measurement while preventing influence on the timing of a normal printing operation.

As described above, Embodiment 4 includes the following inventions.

An image forming apparatus according to Embodiment 4 is an image forming apparatus having a plurality of light-emitting elements, which forms an image by exposing an image carrier, and including: a light quantity measurement portion for measuring the light quantity of light emitted by the light-emitting elements in an exposure period to print a page of a test pattern; and a control portion for controlling the image density by varying the exposure conditions a plurality of times based on the measurement results by means of the light quantity measurement portion. With the construction, since the light quantities of the light-emitting elements are measured in the exposure period to print a page of a test pattern, it becomes possible to carry out light quantity measurement while preventing influence on the timing of a normal printing operation.

In addition, in Embodiment 4, it is not requisite that the control portion varies the exposure conditions a plurality of times, wherein the exposure conditions may be varied by a single operation based on the light quantity measurement data obtained by the operation for measuring light quantities.

Further, the light quantity measurement portion according to Embodiment 4 measures the light quantities of light-emitting elements when forming a pattern for correcting the gradation as an image of a test pattern. With the construction, since the light quantities of the light-emitting elements for a pattern for gradation correction to be formed are measured, it becomes possible to carry out light quantity measurement while preventing influence on the timing of a normal printing operation.

In addition, the light quantity measurement portion according to Embodiment 4 measures the light quantities of light-emitting elements when forming a pattern for correcting the maximum density as an image of a test pattern. With the construction, since the light quantities of the light-emitting elements for a pattern for the maximum density correction to be formed are measured, it becomes possible to carry out light quantity measurement while preventing influence on the timing of a normal printing operation.

Further, the light quantity measurement portion according to Embodiment 4 measures the light quantities of light-emitting elements when forming a pattern for correcting the positional errors as an image of a test pattern. With the construction, since the light quantities of the light-emitting elements for a pattern for positional error correction to be formed are measured, it becomes possible to carry out light quantity measurement while preventing influence on the timing of a normal printing operation.

Still further, when not forming the image of a test pattern, the light quantity measurement portion according to Embodiment 4 measures the light quantities. With the construction, by effectively utilizing the period of time during which the light-emitting elements suspend lighting to form the image of a test pattern, light quantity measurement can be carried out.

Also, when forming the image of a test pattern, the light quantity measurement portion according to Embodiment 4 measures the light quantities. With the construction, by effectively utilizing the period of time during which the light-emitting elements are forming the image of a test pattern, light quantity measurement can be carried out.

The light-emitting elements according to Embodiment 4 are composed of organic electroluminescent elements. With the construction, both downsizing and a reduction in costs are enabled, and at the same time, an operation for correcting the light quantities, which becomes an important operation where the organic electroluminescent elements are used as light-emitting elements, can be carried out while lowering influence given to the timing of the printing operation.

A method for controlling an image forming apparatus according to Embodiment 4 is a method for controlling an image forming apparatus having a plurality of light-emitting elements, which forms an image by exposing an image carrier, including the steps of: measuring the light quantities of light emitted by the light-emitting element in an exposure period during which a page of a test pattern is printed; and controlling the image density by varying the exposure conditions a plurality of times based on the measurement results of measured light quantities. With the method, since the light quantities of the light-emitting elements are measured when forming an image of a test pattern, it becomes possible to carry out light quantity measurement while preventing influence on the timing of a normal printing operation.

Further, in Embodiment 4, the step of varying the exposure conditions a plurality of times is not requisite, wherein the exposure conditions may be varied by a single operation based on the light quantity measurement data obtained by the operation for measuring light quantities.

The method for controlling an image forming apparatus described above may be provided as programs for controlling the image forming apparatus, by which the respective steps are carried out. With the programs, since the light quantities of the light-emitting elements are measured when forming the image of a test pattern, it becomes possible to carry out light quantity measurement while preventing influence on the timing of a normal printing operation.

### Embodiment 5

Hereinafter, a description is given of Embodiment 5 of the present invention, in particular, of the process of measuring light quantities.

In the following description, the structures of the image forming apparatus, exposure apparatus, and control portion for controlling the image density, and operations for correcting the light quantities are common to those in Embodiment 1. Therefore, the description thereof is omitted.

As has already been described using FIG. 12, it is necessary to provide an accumulation period to some degree in order to highly accurately carry out light quantity measurement for a single light-emitting element. In order to secure the accuracy of target brightness correction, it is necessary to secure predetermined accuracy (S/N) of light quantity measurement. On the other hand, the accuracy of light quantity measurement is proportionate to the time of light receiving amount of the light quantity sensor 57. For this reason, in order to increase the accuracy of light quantity correction of respective elements, it is necessary to elongate the time for light quantity of the respective elements. In addition, in the accumulation period, it is necessary for the organic electroluminescent elements 63 to produce luminescence, wherein a normal printing operation is not simultaneously carried out. Therefore, the normal printing operation is adversely influenced, depending on the timing on which an operation for measuring light quantities is carried out, and it results in a lowering in the printing rate.

Accordingly, the image forming apparatus 1 according to Embodiment 5 secures predetermined accuracy of light quantity measurement while shortening the light-emitting time of the organic electroluminescent elements 63 by increasing the light emitting quantities of the organic electroluminescent elements 63 when measuring the light quantities greater than the light emitting quantities when forming an image.

That is, the image forming apparatus 1 according to Embodiment 5 is an image forming apparatus having a plurality of light-emitting elements, which forms an image by exposing an image carrier, including: a portion for controlling a light emission operation of light-emitting elements; a portion for measuring the light quantities of light emitted by the light-emitting elements; and a portion for correcting the light quantities of light emitted by the light-emitting elements; wherein the light emission operation controlling portion sets the light quantities of light emitted by the light-emitting elements when the light quantity measurement portion measures the light quantities of the light-emitting elements, to greater light quantities than those when forming an image. Here, in Embodiment 5, the organic electroluminescent elements 63 operate as one example of the light-emitting elements, the controller CPU 83 and the source driver 61 operate as one example of the light emission operation controlling portion, the sensor pixel circuit 130 and the charge amplifier 150 (both thereof were described in Embodiment 1, and refer to FIG. 11) operate as one example of the light quantity measurement portion, and the controller CPU 83 and the light quantity correction data memory 66 operate as one example of the control portion (light quantity correction portion), respectively.

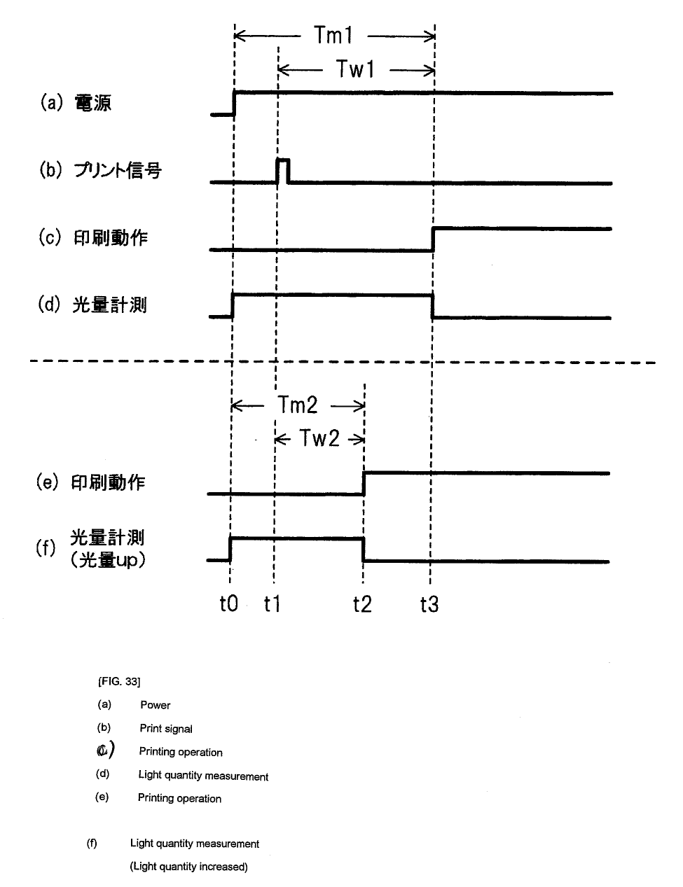

FIG. 32 is a graph describing light-emitting quantities of the organic electroluminescent elements in the image forming apparatus according to Embodiment 5 of the present invention, wherein FIG. 32(a) shows the light emitting quantities in normal image formation, and FIG. 32(b) shows the light-emitting quantities when measuring the light quantities.

As shown in FIG. 32(a) and FIG. 32(b), in the image forming apparatus according to Embodiment 5, the light-emitting quantities of the respective organic electroluminescent elements 63 are set to light quantity A when forming an image and are set to light quantity B, which is greater than the light quantity A, when measuring the light quantities. That is, the controller CPU 83 increases the light quantities of light emitted by the organic electroluminescent elements 63 when measuring the light quantities, greater than those when forming an image.

In detail, the controller CPU 83 multiplies the data DD[n] in image formation by a constant k which is greater than 1, and sends the same to the exposure apparatus 13 as the data DD[n] already described (Refer to FIG. 6) when measuring the light quantities, and the organic electroluminescent elements 63 are lit based thereon. For example, if k is 1.5, the data DD[n] obtained by multiplying this is programmed in the pixel circuit 69 via the source driver 61 as described above, whereby the organic electroluminescent elements 63 are caused to be lit at light quantities greater by 1.5 times in comparison with the light quantities when the data DD[n] is acquired when producing the exposure apparatus 13. Where such setting is performed, the light quantities of light emitted by the organic electroluminescent elements 63 become greater than when normally forming an image, excepting a case where the organic electroluminescent elements 63 greatly deteriorate. Such light quantity correction data ND[n] when measuring the light quantities may be generated based on (Expression 3) by extending (Expression 1) described in Embodiment 1.

ND[n]=DD[n]×(ID[n]×k)/PD[n] (where n is the number of individual organic electroluminescent elements in the main scanning direction, and k is a constant greater than 1). [Expression 3]

In addition, the controller CPU 83 may variably set the above-described constant k in response to the status of the organic electroluminescent elements 63. For example, the constant k is adjusted in response to deterioration states of the organic electroluminescent elements 63, and the light-emitting quantities of the organic electroluminescent elements 63 when measuring the light quantities may be made greater at all times in comparison with those when forming an image.

Since the light quantities of light emitted by the organic electroluminescent elements 63 are lowered as the deterioration of the organic electroluminescent elements 63 advances, the ND[n] gradually increases.

And, if the deterioration thereof greatly advances, there is a possibility that the value of a new light quantity correction data ND[n] obtained by light quantity measurement becomes greater than the value obtained by multiplying the value of DD[n] by the constant k.

Therefore, as shown in, for example, (Expression 4), the controller CPU 83 compensates the DD[n] equivalent to the degree of deterioration in the light quantities of the organic electroluminescent elements 63, and if the constant k[n] is defined by multiplying a constant m greater than 1, the light quantities of light emitted by the organic electroluminescent elements 63 when measuring the light quantities can be made greater at all times than those when forming an image.

k[n]=(ND[n]/DD[n])×m (where m is a constant greater than 1) [Expression 4]

However, as shown in (Expression 4), the constant k[n] becomes unique in each light-emitting element. In this case, the light quantity correction data ND[n] for each light-emitting element when measuring the light quantities may be made as in (Expression 5).

ND[n]=DD[n]×(ID[n]×k[n])/PD[n] (where n is the number of individual organic electroluminescent elements in the main scanning direction, and k is a constant greater than 1). [Expression 5]

Where the memory capacity of the light quantity correction data memory 66 (Refer to FIG. 5) has sufficient allowance, the processing may be carried out based on (Expression 4) and (Expression 5). However, where an image forming apparatus does not have a sufficient resource, the constant k may be obtained based on the average value of, for example, ND[n], DD[n], etc.

As a matter of course, the setting value in the source driver 61 is subjected to restriction because there is a maximum rating with regard to a lead-in current of the source driver 61. That is, the constant k cannot be unlimitedly increased. Therefore, it is necessary to pay sufficient attention to the restriction when designing.

FIG. 33 is a timing chart showing one example of an operation for measuring light quantities in an image forming apparatus according to Embodiment 5 of the present invention, wherein FIG. 33(a) shows a power operation, FIG. 33(b) shows a print signal inputting operation, FIG. 33(c) shows a printing operation where light quantity measurement is carried out with regard to the light quantities when forming an image, and FIG. 33 (d) shows timing of an operation for measuring light quantities with regard to the light quantities when forming an image. Also, FIG. 33(e) shows a printing operation when the operation for measuring light quantities is carried out with the light quantities increased, which is shown in FIG. 32(b), and FIG. 33(f) shows timing of an operation for measuring light quantities based on an increase in light quantities. Also, in the example shown in FIG. 33, a description is given of an operation for measuring light quantities in the initializing process shown at (1) in FIG. 13. However, the situation remains unchanged in other timing.

As shown in FIG. 33, when power of the image forming apparatus 1 is inputted at time t0 (FIG. 33(a)), the engine control CPU 91 of the engine control portion 42 (Refer to FIG. 7) runs an operation for measuring light quantities. In detail, the engine control CPU 91 drives the sensor pixel circuit 130, the charge amplifier 150 and the organic electroluminescent elements 63 (each thereof has been described in Embodiment 1, and refer to FIG. 11), and runs the operation for measuring light quantities. In addition, the period (time t0 through t3) of time required to complete the operation for measuring light quantities is regarded as the period Tm1 necessary to complete light quantity measurement.

After that, as shown in FIG. 33(b), where a print signal is inputted by a print start instruction from the computer 80 (Refer to FIG. 5), etc., at time t1 until the period Tm1 necessary to complete light quantity measurement elapses from start of light quantity measurement, no printing operation can be simultaneously carried out as described above. Therefore, the engine control CPU 91 causes the printing operation to stand by until the time t3 for which the operation for measuring light quantities is terminated, starts rotation of the drive source 38 (Refer to FIG. 1), and starts the printing operation (FIG. 33(d)). That is, the period Tw1 from time t1 to time t3 will be made into standby time. For example, when carrying out the initializing operation shown in FIG. 33, some influence such as delay in the first print and delay in warming-up is brought about.

However, since the sensor pixel circuit 130 shown in FIG. 11 has a configuration by which a light quantity irradiated onto the light quantity sensor 57 is reflected onto electric charge accumulated in the capacitor 131, the accuracy of light quantity measurement pertains to electric charge accumulated in the capacitor 131. That is, the accuracy is proportional to the cumulative light quantity irradiated onto the light quantity sensor 57. Accordingly, as the light quantity irradiated onto the light quantity sensor 57 is increased when measuring the light quantity, the electric charge accumulated in the capacitor 131 per unit is also increased, whereby even if the time for light quantity measurement is shortened, predetermined accuracy will be able to be secured.

Therefore, as shown in FIG. 33(f), where accuracy equivalent to the accuracy obtained in the operation for measuring light quantities made in FIG. 33(d) is acquired by the light quantities of light emitted by the organic electroluminescent elements 63 when measuring light quantities being greatly set (Refer to FIG. 32(b)), the period Tm2 necessary to complete light quantity measurement can be shortened in comparison with the period Tm1 necessary to complete light quantity measurement. Therefore, the engine control CPU 91 can start a printing operation at time t2 after the period Tm2 necessary to complete light quantity measurement is over. That is, it is possible to make the standby time Tw2 shorter than the standby time Tw1.

Further, the source driver 61 makes one unit of light-emitting time of the organic electroluminescent elements 63 when measuring light quantities as in image formation into one raster period equivalent to one unit of light-emitting time when forming an image, and drives the organic electroluminescent elements 63. Thereby, by the method for driving the organic electroluminescent elements 63 when measuring light quantities being made equivalent to that when normally forming an image, light quantity measurement is enabled while preventing influence on the timing of a normal printing operations, without carrying out cumbersome control by which a special drive method will be employed when measuring light quantities.

According to Embodiment 5 of the present invention, since the light quantity is increased, which is received by the light quantity sensor 57 when measuring light quantities, it becomes possible to shorten the time for light quantity measurement while keeping the accuracy of light quantity measurement. As a result, it becomes possible to carry out light quantity measurement while preventing influence on the timing of a normal printing operation.

As described above, Embodiment 5 includes the following inventions.

An image forming apparatus according to Embodiment 5 is an image forming apparatus having a plurality of light-emitting elements, which forms an image by exposing an image carrier, including: a portion for controlling the light emission operations of light-emitting elements; a portion for measuring the light quantities of light emitted by the light-emitting elements; a portion for correcting the light quantities of light emitted by the light-emitting elements with reference to the light quantity measurement value measured by the light quantity measurement portion; and a portion for controlling the image density by varying the exposure conditions a plurality of times based on the measurement results by means of the light quantity measurement portion; wherein the light emission operation controlling portion sets the light quantities of light emitted by the light-emitting elements, when the light quantity measurement portion measures the light quantities of light emitted by the light-emitting element, to greater light quantities than those when forming an image. With the construction, since the quantity of light is increased, which is received by the light quantity measurement portion when measuring the light quantities, it becomes possible to shorten the light quantity measurement time while keeping the accuracy of light quantity measurement. As a result, light quantity measurement is enabled while preventing influence on the timing of a normal printing operation.

Furthermore, it is not requisite that the control portion varies the exposure conditions a plurality of times, wherein the exposure conditions may be varied by a single operation based on the light quantity measurement data obtained by the operation for measuring light quantities.

The light emission operation controlling portion according to Embodiment 5 controls the light-emitting elements with one unit of light-emitting time in light quantity measurement made equivalent to one unit of light-emitting time in image formation. With the construction, the method for driving light-emitting elements when measuring light quantities is made similar to that when normally forming an image, wherein it becomes possible to carry out light quantity measurement while preventing influence on the timing of a normal printing operations without executing any complicated control in which a special driving method is employed when measuring light quantities.

In addition, the light quantity measurement portion according to Embodiment 5 includes: a charge amplifier described in detail in Embodiment 1; a light detection element connected in series to the charge amplifier, which generates a current in response to the irradiated light quantity; a capacitance element connected parallel to the light detection element; and a selector transistor connected between a parallel circuit having the light detection element and the capacitance element, and the charge amplifier, which opens and closes electrical connection between the parallel circuit and the charge amplifier. With the construction, since the light quantity measurement portion has a configuration that reflects the light quantity of the light irradiated onto the light quantity detection element onto electric charge accumulated in the capacitance element, the electric charge accumulated per unit time is increased by increasing the light quantity irradiated on the light quantity detection element, wherein it is possible to carry out light quantity measurement with predetermined accuracy secured in a short time.

The method for controlling the image forming apparatus disclosed in Embodiment 5 is a method for controlling an image forming apparatus having a plurality of light-emitting elements, which forms an image by exposing an image carrier, including the steps of controlling operations of light-emitting elements; measuring the light quantities of light emitted by the light-emitting elements; and controlling the image density by varying the exposure conditions a plurality of times based on the measurement results of measured light quantities; wherein when measuring the light quantities of the light-emitting elements, the light quantities of light emitted by the light-emitting elements are set to a greater quantities than those when forming an image. With this method, since the light quantities of light of receivable light by the light quantity measurement portion when measuring the light quantities are increased, it becomes possible to shorten the light quantity measurement time while keeping the accuracy of light quantity measurement, and resultantly, light quantity measurement is enabled while preventing influence on the timing of a normal printing operation.

Also, in Embodiment 5, the step of varying the exposure conditions a plurality of times is not requisite, wherein the exposure conditions may be varied by a single operation based on the light quantity measurement data obtained by the operation for measuring light quantities.

In addition, the method for controlling an image forming apparatus described above may be provided as programs for controlling the image forming apparatus, by which the respective steps are carried out. With the programs, since the quantities of light that can be received by the light quantity measurement portion when measuring the light quantities are increased, it becomes possible to shorten the light quantity measurement time while keeping the accuracy of light quantity measurement, and resultantly, light quantity measurement is enabled while preventing influence on the timing of a normal printing operation.

### Embodiment 6

Hereinafter, a description is given of Embodiment 6, in particular, of the process of measuring light quantities.

In the following description, the constructions of the image forming apparatus, exposure apparatus, and the control portion for controlling image densities, and operations for correcting light quantities are common to those of Embodiment 1, and the description thereof is omitted.

As has already been described using FIG. 12, it is necessary to provide an accumulation period to some degree in order to carry out light quantity measurement for a single light-emitting element at high accuracy. In addition, in the accumulation period, it is necessary to cause the organic electroluminescent elements 63 to produce luminescence, wherein a printing operation cannot be simultaneously carried out. Therefore, the printing operation is influenced, depending on the timing for which light quantity measurement is carried out, wherein it results in a lowering in the printing rate.

In particular, as shown at (4) of FIG. 13, in continuous printing in which a plurality of sheets are continuously printed, the temperature inside the image forming apparatus 1 rises (is varied) during the printing, and the organic electroluminescent elements 63 are subjected to a change in light quantity. Therefore, although during an operation in which it is difficult to secure sufficient time for light quantity measurement, for example, during continuous printing, it is preferable that light quantity correction is carried out.

A description is given of a change in the temperature inside the image forming apparatus 1, a change in light quantities of the organic electroluminescent elements 63, and a necessity of light quantity correction.

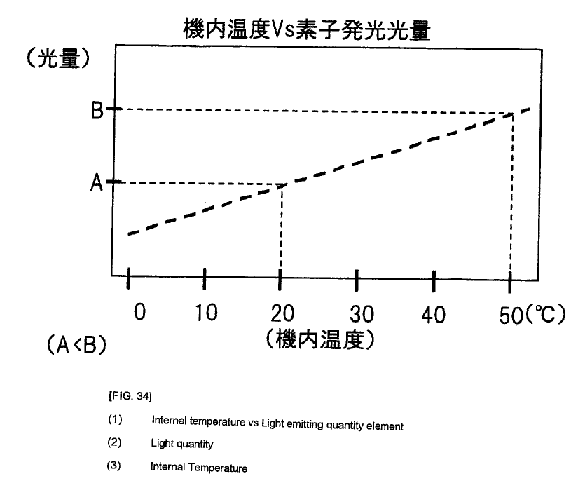

FIG. 34 is a view showing the temperature characteristics of light emitting quantities of the organic electroluminescent elements in the image forming apparatus according to Embodiment 6 of the present invention. As shown in FIG. 34, the organic electroluminescent elements 63 increase their emission light quantities in line with a rise in temperature. As described above, as regards the characteristics, there are positive characteristics and negative characteristics in response to the material of the organic electroluminescent elements 63.

Herein, in the image forming apparatus, the internal temperature is high in the vicinity of the exhaust port and low in the vicinity of the suction port. Therefore, there may be cases where the ambient temperature differs, depending on the positional relationship between the exposure apparatus 3, air suction port and air exhaust port, and depending upon the position of the organic electroluminescent elements 63 arrayed and provided in the main scanning direction.

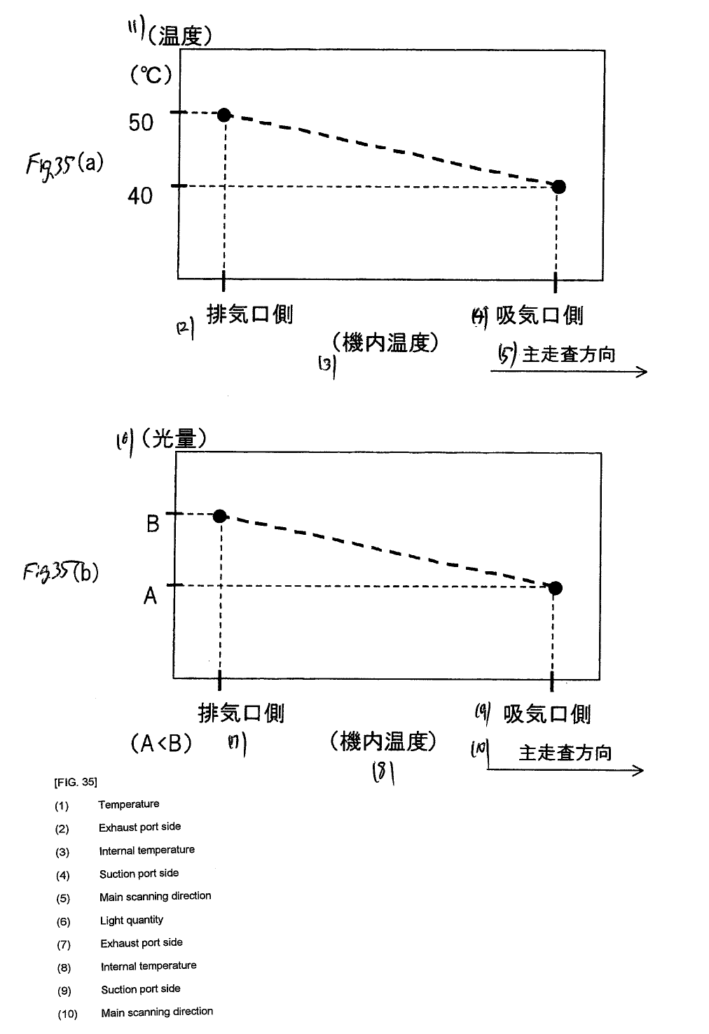

FIG. 35 is a view showing the characteristics with regard to the main scanning direction of the exposure apparatus in the image forming apparatus according to Embodiment 6 of the present invention, wherein FIG. 35(a) shows the relationship between the position in the main scanning direction and the internal temperature, and FIG. 35(b) shows the relationship between the position in the main scanning direction and the light quantities of the organic electroluminescent elements 63.

As shown in FIG. 35(a), where one end of the main scanning direction of the exposure apparatus 13 is near the exhaust port, and the other end thereof is near the suction port, the temperature depending on the position in the main scanning direction differs, for example, the temperature near one end of the main scanning direction of the exposure apparatus 13 is high, and that near the other end thereof is low. Resulting from such a temperature distribution, as shown in FIG. 35(b), the quantities of light emitted by the respective organic electroluminescent elements 63 secured in the exposure apparatus 13 differ from each other.

Thus, in order to keep the image quality during a continuous printing operation, it is necessary to carry out individual light quantity correction for each of the organic electroluminescent elements 63. However, if the printing operation is interrupted for light quantity measurement, the printing time will be increased.

Therefore, an image forming apparatus according to Embodiment 6 includes: a light quantity measurement portion for measuring the quantities of light emitted from light-emitting elements, provided at a region different from the image-forming region to form an image, of a plurality of light-emitting elements; and a light quantity correction portion for correcting the quantities of light, measured by the light quantity measurement portion, which are emitted by the light-emitting elements provided at the image-forming region, with reference to the value of measured light quantities of the light-emitting elements at a region differing from the image-forming region. Herein, in Embodiment 6, the organic electroluminescent elements 63 operate as one example of the light-emitting elements, the sensor pixel circuit 130 and the charge amplifier 150 (both thereof were described in Embodiment 1, and refer to FIG. 11) operate as one example of the light quantity measurement portion, and the controller CPU 83 and the light quantity correction data memory 66 operate as one example of the control portion (light quantity correction portion), respectively.

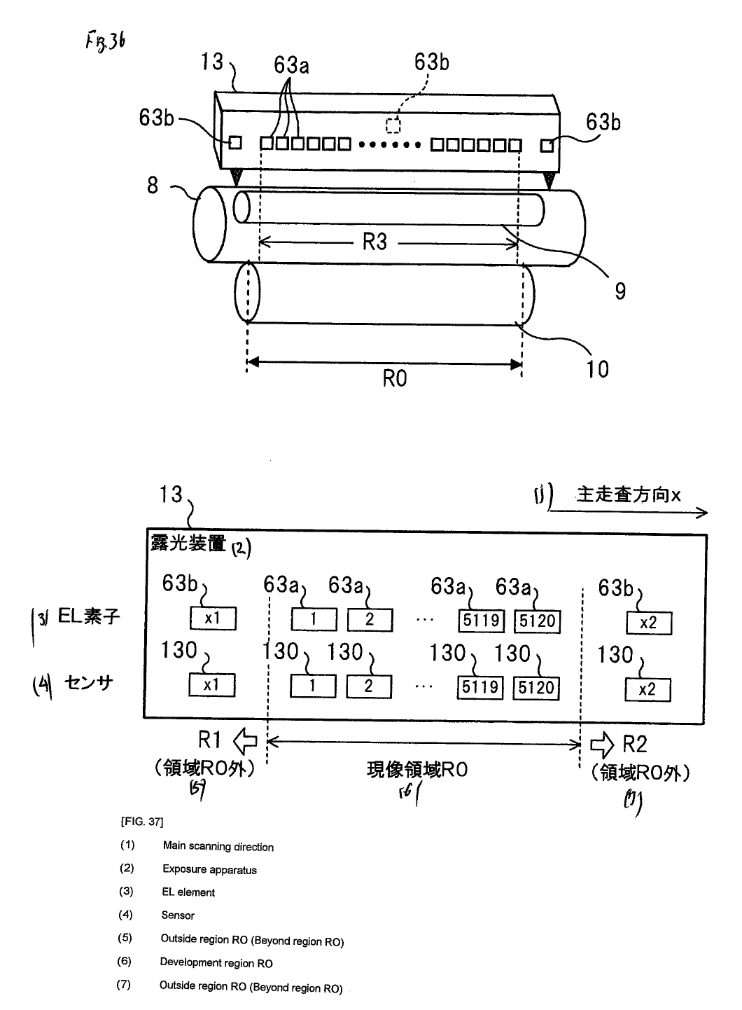

FIG. 36 is an explanatory view showing the concept with regard to the positional relationship between the exposure apparatus and its peripheries in the image forming apparatus according to Embodiment 6 of the present invention.

As shown in FIG. 36, in the exposure apparatus 13, light-emitting elements 63b for light quantity measurement, which are organic electroluminescent elements 63 to carry out light quantity measurement, are formed in addition to the light-emitting elements 63a for image formation, which are also organic electroluminescent elements 63 to expose the image-forming region in order to form an image on the photosensitive body 8, other than the light-emitting elements to expose the image-forming region.

Here, a development region R0 to which a development agent (toner) is supplied from the development sleeve 10 may be listed as an example of the image-forming region on the photosensitive body 8. In other words, even if regions other than the development region R0 of the photosensitive body 8 are exposed, no toner is supplied to the photosensitive body 8, and no image is formed on the regions to the end, wherein the regions are not made into the image-forming regions.

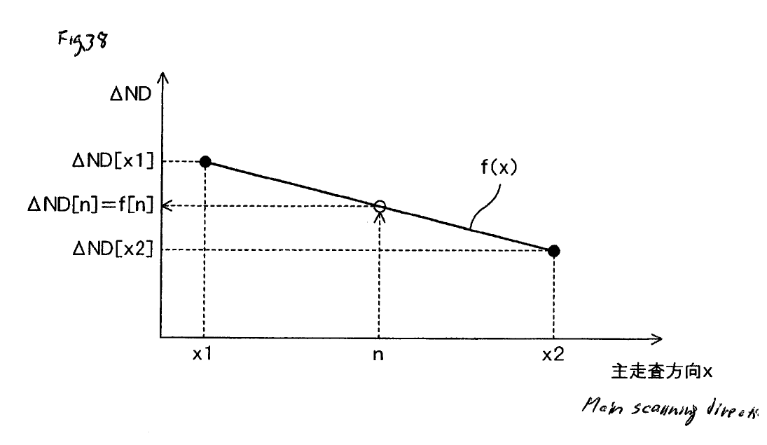

As shown in FIG. 37, the organic electroluminescent elements 63 are arrayed and provided in the main scanning direction. And, the light-emitting elements 63a for image formation are provided at positions to expose the development region R0. Also, for the purpose of preventing non-developed pixels from occurring, resulting from positional errors, as shown in FIG. 36, the light-emitting elements 63a for image formation are installed so that their exposure regions (latent image-forming regions) R3 can be positioned in the development region R0.

In addition, the light-emitting elements 63b for light quantity measurement are provided at the positions to expose the region R1 at one end of the main scanning direction of the exposure apparatus 13, which is beyond the development region, and at the positions to expose the region R2 at the other end thereof. In addition, the light-emitting elements 63b for light quantity measurement, which are provided at the positions to expose the region R1, are given element number x1, and the light-emitting elements 63b for light quantity measurement, which are provided at the positions to expose the region R2, are given element number x2. Furthermore, organic electroluminescent elements 63 having element numbers 1 through 5120 are provided at the positions to expose the development region R0.

Herein, in Embodiment 6, since a sensor pixel circuit 130 is provided for each of the organic electroluminescent elements 63, a sensor pixel circuit 130 is provided to correspond to the light-emitting elements 63b for light quantity measurement.

As described above, since the light-emitting elements 63b for light quantity measurement do not expose the image-forming region, there is no case where toner is transferred onto the recording sheet 3 and the transfer roller 16, etc., even if the light-emitting elements 63b for light quantity measurement are lit at any timing. Therefore, in the image forming apparatus 1 according to Embodiment 6, at the timing when it is difficult to carry out light quantity correction by lighting the image-forming light-emitting elements 63a for the sake of light quantity measurement, the light quantities of only the light-emitting elements 63b for light quantity measurement are measured, and the controller CPU 83 corrects the light quantities of the respective light-emitting elements 63a for image formation based on the light quantities measured for only the light-emitting elements 63b for light quantity measurement. Therefore, since the light quantities are corrected without causing the light-emitting elements 63a for image formation to emit light for light quantity measurement, it is possible to carry out light quantity correction at any optional timing.

Further, in the above example, a description was given of the case where the light-emitting elements 63b for light quantity measurement are provided other than the positions to expose the development region R0. However, even if the photosensitive body 8 exposed by the exposure apparatus 13 in a state where the surface of the photosensitive body 8 is not electrified, the surface potential of the photosensitive body 8 is hardly changed. If a development agent is supplied to a portion that is in such a potential state, toner is adhered to the photosensitive body 8 almost in a solid state. Therefore, normally, as shown in FIG. 36, the development region R0 is designed so that it is made narrower than the electrification region electrified by the electrifier 9. If it is so designed, no toner is adhered thereto even if portions other than the electrification region are exposed. Accordingly, the light-emitting elements 63b for light quantity measurement may be provided at positions that expose portions other than the electrification region.

Further, in FIG. 4, the light-emitting elements 63b for light quantity measurement is not specially clarified. However, for example, they may be provided in a mode isolated from the organic electroluminescent elements 63 supplied for exposure of the photosensitive body on the extension line of the element row constituted by the organic electroluminescent elements 63. Or the light-emitting elements 63b for light quantity measurement may not be provided in an isolated state. In this case, it is sufficient that a part of the element row at the end portion side is not used for exposure.

Also, in Embodiment 6, the size (the size of a light-emitting region) of the light-emitting element 63b for light quantity measurement may differ from that of the light-emitting element 63a for image formation. Since it is necessary for the light-emitting element 63a for image formation that a latent image of a predetermined size is formed on the photosensitive body, the size is required to be 35 μm or so, for example, where an image of 600 dpi is formed. However, the light-emitting elements 63b for light quantity measurement do not have such restriction. In particular, by forming the size of the light-emitting elements 63b for light quantity measurement greater than the size of the light-emitting elements 63a for image formation, it becomes possible that the light receiving surface of the light quantity sensor 57 formed therebelow is made large, or that the number of the light quantity sensors 57 disposed is increased. Accordingly, it becomes possible to improve the accuracy of light quantity measurement by the light-emitting elements 63b for light quantity measurement and to shorten the time required for light quantity measurement.

FIG. 38 is an explanatory view showing a method for calculating a light quantity correction value in the image forming apparatus according to Embodiment 6 of the present invention. With respect to the outline of the calculation method, since the organic electroluminescent elements 63 are arrayed and provided in the main scanning direction, the controller CPU 83 obtains the light quantity correction characteristics regarding the position of the main scanning direction based on the light quantity measurement value of the light-emitting elements 63b for light quantity measurement, wherein the light quantities are corrected based on the positions and the light quantity correction characteristics for each of the light-emitting elements 63a for image formation. Hereinafter, a description is given of the detail thereof.

First, the light quantity correction value ND of the respective organic electroluminescent elements 63 is stored in the third area of the light quantity correction data memory 66 shown in FIG. 6. Also, FIG. 6 shows the light quantity correction values ND regarding the organic electroluminescent elements 63 having element number 1 through 5120, that is, the light-emitting elements 63a for image formation. However, it is assumed that the light quantity correction values ND regarding the light-emitting elements 63b (element numbers x1 and x2) for light quantity measurement are also stored therein. These stored light quantity correction values ND are regarded as the first light quantity correction values.

And, if the light quantity measurement is carried out for only the light-emitting elements 63b for light quantity measurement by the engine control CPU 91 at a predetermined timing, for example, during a continuous printing operation, the controller CPU 83 calculates the second light quantity correction values NDb of the light-emitting elements 63b for light quantity measurement based on the light quantity measurement value in compliance with the above-described (Expression 1). And, the controller CPU 83 calculates a difference value ΔND between the calculated second light quantity correction value NDb regarding the light-emitting elements 63b for light quantity measurement and the first light quantity correction value ND stored in the light quantity correction data memory 66 by means of the following (Expression 6).

ΔND[M]=NDb[M]−ND[M] (Expression 6)

Further, M is an element number. In this example, since the element numbers x1 and x2, the difference values ΔND obtained are two, ΔND[x1] and ΔND[x2].

The difference values ΔND show how much the light quantity correction value has changed, based on the light quantity measurement of this time, from the light quantity correction value obtained in response to the light quantity measurement carried out previously, and corresponds to how much the brightness of the organic electroluminescent elements 63 has changed. The image forming apparatus 1 according to Embodiment 6 estimates how much the light-emitting elements 63a for image formation has changed in terms of the light quantities, by grasping how much the light-emitting elements 63b for light quantity measurement has been changed in terms of the light quantities.

As shown in FIG. 37, the light-emitting element 63b for light quantity measurement, which carries element number x1, and the light-emitting element 63a for image formation, which carries element number x2, are provided at both ends of the main scanning direction. Therefore, as shown in FIG. 35, where it is assumed that the light quantities linearly change based on the temperature distribution with regard to the main scanning direction, as shown in FIG. 35, a function f(x) of the difference value ΔND for the position x in the main scanning direction may be obtained by two coordinate points (x1, ΔND[x1]) and (x2, ΔND[x2]). In addition, the element number itself of the organic electroluminescent elements 63 corresponds to the position x of the main scanning direction.

It is possible to obtain the difference values estimated for each of the light-emitting elements 63a for image formation based on the difference value ΔND[n]=f[n] (n is element number) from the function f(x).

And, the controller CPU 83 calculates the light quantity correction values NDc estimated for each of the organic electroluminescent elements 63 by using NDc[n]=ND[n]+ΔND[n]. Thereby, it is possible to obtain the light quantity correction values regarding the light-emitting elements 63a for image formation based on the light quantity correction values of only the light-emitting elements 63b for light quantity measurement.

And, as described in detail in Embodiment 1, the light quantity correction values are varied a plurality of times, whereby the image density is controlled.

Thus, according to Embodiment 6 of the present invention, since the light quantities of the light-emitting elements 63a for image formation are corrected based on the light quantity measurement results of the light-emitting elements 63b for light quantity measurement other than the light-emitting elements 63a for image formation, light quantity measurement can be carried out during a printing operation, and it becomes possible to carry out light quantity measurement while preventing influence on the timing of the printing operation.

In addition, in the above example, the light-emitting elements 63b are provided exclusively for light quantity measurement. Thereby, since the positions of the light-emitting elements 63b for light quantity measurement are determined in advance, it is possible to correct the light quantities by utilizing the method for correcting light quantities, which is defined in advance (that is, in the above example, the method of calculating a parameter of function f(x) to obtain the difference value). However, the light-emitting elements 63b are not specially provided exclusively for light quantity measurement, wherein the light-emitting elements 63a for image formation may be used for light quantity measurement in cases not pertaining to image formation.

Furthermore, since it is not necessary that the light-emitting elements 63b for light quantity measurement expose the image-forming region, the light-emitting elements 63b may be provided in the development region R0 as shown in, for example, by dotted lines in FIG. 36 if such a structure is added by which light of the detection elements 63b for light quantity correction does not leak to the photosensitive body 8 (for example, an enclosure is installed around the detection elements 63b for light quantity correction and the sensor pixel circuit 130, etc.).

On the glass substrate 50 (Refer to FIG. 3) on which the light-emitting elements 63a for image formation are formed, it is sufficient that such construction is employed, in which black paint is coated to shield light at the positions, corresponding to the light-emitting elements 63b for light quantity measurement, of the side A and the side opposite thereto (so-called side for picking up light). And, black paint may be coated on a portion corresponding to a path of light emitted from the light-emitting elements 63 for light quantity measurement in the lens array 51 (Refer to FIG. 3), or a light-shielding member, for example, a non-transparent tape member, etc., may be adhered thereto.

As described above, Embodiment 6 has the following inventions.

The image forming apparatus according to Embodiment 6 is an image forming apparatus for forming an image by exposing an image carrier, which includes: a light quantity measurement portion for measuring the quantities of light emitted by light-emitting elements, other than the light-emitting elements for exposing an image-forming region to form an image in the image carrier, of a plurality of light-emitting elements; and a portion for controlling the image density by varying the exposure conditions a plurality of times based on the measurement results by means of the light quantity measurement portion. With the construction, since the light quantities of the light-emitting elements for exposing the image-forming region are corrected based on the results of light quantity measurement of light-emitting elements other than the light-emitting elements for exposing the image-forming region, light quantity measurement can be carried out during a printing operation, wherein the light quantity measurement can be carried out while preventing influence on the timing of the printing operation.

In addition, in Embodiment 6, it is not requisite that the control portion varies the exposure conditions a plurality of times, wherein the exposure conditions may be varied by a single operation based on the light quantity measurement data obtained by the operation for measuring light quantities.

Further, in the image forming apparatus disclosed in Embodiment 6, the image-forming region is made into a development region to which a development agent is supplied on an image carrier. With the construction, since, even if the image carrier is exposed by the light-emitting elements other than the light-emitting elements to expose the image-forming region, no development agent is supplied to the exposed portion, and no development agent is transferred onto the recording sheet and the transfer roller, etc., light quantity measurement can be carried out while preventing influence on the timing of the printing operation.

Still further, in the image forming apparatus disclosed in Embodiment 6, the light-emitting elements other than those to expose the image-forming region are light-emitting elements provided exclusively for light quantity measurement. With the construction, since the light quantity measurement portion measures the light quantities of the light-emitting elements provided exclusively for light quantity measurement, light quantity correction can be carried out by utilizing the method for correcting light quantities, which is defined in advance.

Still further, in the image forming apparatus disclosed in Embodiment 6, a plurality of light-emitting elements including light-emitting elements provided exclusively for light quantity measurement are arrayed and provided in the main scanning direction, and the light quantity correction portion obtains the light quantity correction characteristics regarding the positions in the main scanning direction based on the light quantity measurement value of the light-emitting elements provided exclusively for light quantity measurement, and corrects the light quantities based on the positions and the light quantity correction characteristics with respect to each of the light-emitting elements to expose the image-forming region. With the construction, it is possible to correct the light quantities of respective light-emitting elements to expose the image-forming region based on the light quantity correction characteristics regarding the positions of the main scanning direction.

In addition, in the image forming apparatus disclosed in Embodiment 6, the light-emitting region of light-emitting elements other than the light-emitting elements to exposed the image-forming region is formed to be greater than the light-emitting region of the light-emitting elements to expose the image-forming region. With the construction, since, in the light quantity measurement portion, the light-receiving surface of the sensor can be increased, and the number of sensors provided is increased, it becomes possible to improve the accuracy of light quantity measurement and to shorten the time required for light quantity measurement.

Also, in Embodiment 6, in the light quantity measurement portion, the light quantity measurement of light-emitting elements other than the light-emitting elements to expose the image-forming region is carried out during a continuous printing operation in which a plurality of sheets are continuously printed. Since the temperature inside the image forming apparatus rises during the continuous printing, and the light quantity characteristics of the light-emitting elements change, it is necessary to carry out light quantity correction during the continuous printing in order to keep the image quality. However, if the printing operation is interrupted for light quantity measurement, the printing time will be increased. Therefore, with the construction, since light quantity correction is enabled by carrying out light quantity measurement even during continuous printing, the image quality can be maintained.

Further, in Embodiment 6, the light-emitting elements are composed of organic electroluminescent elements. With the construction, by using the organic electroluminescent elements, both downsizing and a reduction in production costs can be achieved, and an operation of correcting light quantities, which becomes an important operation where the organic electroluminescent elements are used as the light-emitting elements, can be carried out while lowering influence on the timing of the printing operation.

A method for controlling an image forming apparatus, which is disclosed in Embodiment 6, is a method for controlling the image forming apparatus having a plurality of light-emitting elements and forming an image by exposing an image carrier, which includes the steps of: measuring the light quantities of light emitted by the light-emitting elements, other than the light-emitting elements to expose an image-forming region in order to form an image on an image carrier, of a plurality of light-emitting elements; and controlling the image density by varying the exposure conditions a plurality of times based on the results of measured light quantities. With this method, since the light quantities of the light-emitting elements to expose an image-forming region are corrected based on the results of measured light quantities of the light-emitting elements other than the light-emitting elements to expose the image-forming region, the light quantity measurement can be carried out during a printing operation. It is possible to carry out light quantity measurement while preventing influence on the timing of the printing operation.

Still further, in Embodiment 6, it is not requisite that the control portion varies the exposure conditions a plurality of times, wherein the exposure conditions may be varied by a single operation based on the light quantity measurement data obtained by the operation for measuring light quantities.

Also, the method for controlling an image forming apparatus described above may be provided as programs for controlling the image forming apparatus, by which the respective steps are executed. With the programs, since the light quantities of the light-emitting elements to expose the image-forming region are corrected based on the results of light quantity measurement of the light-emitting elements other than the light-emitting elements to expose the image-forming region, it becomes possible to carry out light quantity measurement during a printing operation, and light quantity measurement is enabled while preventing influence on the timing of the printing operation.

In the respective embodiments described above, the descriptions were based on the assumption that such a construction is employed in which the light quantities of the organic electroluminescent elements 63 are controlled by varying the current value in a state where the lighting time of the organic electroluminescent elements 63 to compose the exposure apparatus 13 remains unchanged (constant). However, the present invention can be easily applied to a so-called PWM system in which the light quantities of light-emitting elements are controlled by varying the lighting time thereof in a state where the drive currents of the light-emitting elements such as the organic electroluminescent elements 63 are fixed. In this case, it is sufficient that the content of the first area described using FIG. 6 is changed to read [the setting value of the drive time to make the latent image area equal].

In addition, such an exposure apparatus has been known, in which light-emitting element rows composed of organic electroluminescent elements are provided in a plurality, and a latent image is formed by carrying out exposure roughly at the same position with respect to the rotation direction of the photosensitive body a plurality of times. Even in such an exposure, by setting the light quantities and the PWM time so that the latent image formed by a plurality of times of exposure does not contribute to development, the technical thought of the present invention can be applied thereto. In such an exposure apparatus, since a latent image that contributes to development is not formed only by a single row of light-emitting elements, such a sequence can be considered, by which the light quantities are measured row by row, for example, between sheets.

Further, although, in the respective embodiments described above, the light quantities of the organic electroluminescent elements 63 are measured by the TFT circuit 62 and light quantity sensors composed as a monolithic device of poly-silicon, which is the same as the organic electroluminescent elements 63, the technical thought of the present invention is not limited thereto. For example, the invention may be applicable to a construction in which a plurality of film-shaped light quantity sensors are formed of amorphous silicon and are disposed along the end face (Refer to FIG. 4) of the glass substrate 50.

An image forming apparatus according to the present invention and a method for controlling the same bring about an effect of preventing a fluctuation in the image density immediately after the light quantities are corrected, and can be effectively utilized for a printer, a copier, a facsimile machine, a photograph printer, etc.

This application is based upon and claims the benefit of priority of Japanese Patent Application No 2006-108052 filed on Apr. 10, 2006, Japanese Patent Application No 2006-108053 filed on Apr. 10, 2006, Japanese Patent Application No 2006-109645 filed on Apr. 12, 2006, Japanese Patent Application No 2006-114624 filed on Apr. 18, 2006, Japanese Patent Application No 2006-115855 filed on Apr. 19, 2006, Japanese Patent Application No 2006-130298 filed on May 9, 2006, the contents of which are incorporated herein by reference in its entirety.

1. An image forming apparatus having a plurality of light-emitting elements, which forms an image by exposing an image carrier, comprising:
a light quantity measurement portion for measuring the light quantity of light emitted by the light-emitting elements; and
a control portion for controlling the image density by varying the exposure conditions a plurality of times based on the measurement results by means of the light quantity measurement portion.

2. An image forming apparatus having a plurality of light-emitting elements, which forms an image by exposing an image carrier, comprising:
a light quantity measurement portion for measuring the light quantity of light emitted by the light-emitting elements; and
a control portion for controlling the image density by determining the exposure conditions based on the measurement results and the results measured before the measurement by means of the light quantity measurement portion.

3. The image forming apparatus according to claim 1, wherein the control portion controls the image density by varying the exposure conditions page by page with regard to one or more pages based on the measurement results and the results of the prior measurement.

4. The image forming apparatus according to claim 3, wherein the control portion varies the exposure conditions stepwise in the direction along which the image density approaches a predetermined range.

5. The image forming apparatus according to claim 4, wherein the control portion determines an amplitude of variation of the image density per time based on a variation in the exposure conditions in response to the remaining number of pages to be printed.

6. The image forming apparatus according to claim 4, wherein the control portion varies the exposure condition in the period for which images based on the same image data are formed over a plurality of pages.

7. The image forming apparatus according to claim 6, wherein the control portion sets the exposure conditions, after formation of an image based on the same image data is completed, to conditions by which the image density is brought into the predetermined range.

8. The image forming apparatus according to claim 4, wherein the control portion uses, with respect to the amplitude of variation of the image density per time based on a variation in the exposure conditions, a smaller amplitude of variation in a case where images based on the same image data are formed over a plurality of pages than in a case where images based on different image data are formed over a plurality of pages.

9. The image forming apparatus according to claim 3, wherein the control portion uses the same exposure conditions while images based on the same image data are formed over a plurality of pages.

10. The image forming apparatus according to claim 1, wherein the control portion includes a light quantity correction portion for determining the exposure conditions by correcting the light quantity of light emitted by the light-emitting element with reference to the light quantity measurement value measured by the light quantity measurement portion; and
the light quantity correction portion includes:
a portion for calculating a light quantity correction value based on the light quantity measurement value; and a portion for adjusting the light quantity correction value, which outputs a third light quantity correction value to correct the light quantity of the light-emitting element, based on a first light quantity correction value calculated by the light quantity correction value calculation portion and a second light quantity correction value previously calculated.

11. The image forming apparatus according to claim 1, wherein the light-emitting element is composed of an organic electroluminescent element.

12. A method for controlling an image forming apparatus having a plurality of light-emitting elements, which forms an image by exposing an image carrier, comprising the steps of:
measuring the light quantity of light emitted by the light-emitting elements; and
controlling the image density by determining exposure conditions based on the measurement results of the measured light quantity and the results of the prior measurement.

13. A method for controlling an image forming apparatus having a plurality of light-emitting elements, which forms an image by exposing an image carrier, comprising the steps of:
measuring the light quantity of light emitted by the light-emitting elements; and
controlling the image density by varying the exposure conditions a plurality of times based on the measurement results of the measured light quantity.

14. The image forming apparatus according to claim 1, wherein the control portion further controls a light quantity measurement operation for measuring the light quantity of light emitted by the light-emitting elements by means of the light quantity measurement portion, and simultaneously makes the light quantity measurement operation different after a print start instruction is inputted externally.

15. The image forming apparatus according to claim 1, wherein the control portion further controls a light quantity measurement operation for measuring the light quantity of light emitted by the light-emitting elements by means of the light quantity measurement portion, and simultaneously makes the light quantity measurement operation different after a print start instruction is inputted from an instruction inputting portion.

16. The image forming apparatus according to claim 1, wherein the light quantity measurement portion measures the light quantity of a part of a plurality of the light-emitting elements in a predetermined period defined in advance.

17. The image forming apparatus according to claim 1, wherein the light quantity measurement portion measures the light quantity of light emitted by the light-emitting elements in the exposure period to print a page of test pattern.

18. The image forming apparatus according to claim 1, further including a light-emitting operation control portion for controlling operations of the light-emitting elements, wherein the light-emitting operation control portion sets the light quantity of light emitted by the light-emitting elements to a greater light quantity when the light quantity measurement portion measures the light quantity of the light-emitting elements than when forming an image.

19. The image forming apparatus according to claim 1, wherein the light quantity measurement portion measures the quantity of light emitted by light-emitting elements other than the light-emitting elements, which expose an image-forming region to form an image in the image carrier, among a plurality of the light-emitting elements.
